(19) United States
(12) Patent Application Publication
(10) Pub. No.: US 2024/0182747 A1
(43) Pub. Date: Jun. 6, 2024

(54) SYNTHESIS AND 3D PRINTING OF TRIBLOCK COPOLYMER THROUGH ALTERNATING RING-OPENING COPOLYMERIZATION OF EPOXIDES WITH SATURATED AND UNSATURATED CYCLIC ANHYDRIDE

(71) Applicant: Duke University, Durham, NC (US)

(72) Inventors: Matthew BECKER, Chapel Hill, NC (US); Yongjun SHIN

(21) Appl. No.: 18/279,747

(22) PCT Filed: Mar. 1, 2022
(86) PCT No.: PCT/US2022/018326

§ 371 Date: Aug. 31, 2023

Related U.S. Application Data
(60) Provisional application No. 63/155,035, filed on Mar. 1, 2021.

(30) Foreign Application Priority Data
Mar. 1, 2022 (WO) PCT/US2022/018326

(51) Int. Cl. C09D 167/06; B33Y 70/00; C08G 63/58; C08G 63/83; C08G 63/91; C09D 7/20

(52) U.S. Cl. CPC C09D 167/06; B33Y 70/00; C08G 63/58; C08G 63/83; C08G 63/918; C09D 7/20

(57) ABSTRACT

In various embodiments, the present invention relates to a series 3D printable, biodegradable, poly(propylene fumarate) derivative ABA type triblock copolymers having a flexible propylene succinate core unit synthesized through ring-opening copolymerization using a Mg(BHT)₂(THF)₂ catalyst followed by isomerization. 3D printing utilizing thiol-ene chemistry yield precise structure with improved build time. 3D printed products are fully degraded in hydrolytic conditions and the mechanical properties and degradation rate can be tailored by the polymer composition and resin formulation.

### CROSS REFERENCE TO RELATED APPLICATIONS

This application claims the benefit of U.S. provisional patent application Ser. No. 63/155,035 entitled “Synthesis and 3D Printing of Triblock Copolymer Through Alternating Ring-Opening Copolymerization of Epoxides with Saturated and Unsaturated Cyclic Anhydrides,” filed Mar. 1, 2021, and incorporated herein by reference in its entirety.

### FIELD OF THE INVENTION

One or more embodiments of the present invention relates to a polyester copolymers and resins for use in 3D printing applications. In certain embodiments, the present invention is directed to an ABA type block copolymer of poly(propylene fumarate) and polypropylene succinate), and resins made therefrom.

### BACKGROUND OF THE INVENTION

Since it is introduced in the 1980s, additive manufacturing (AM) has become a vital method in manufacturing due to its ability to construct precise geometries with high resolution in a relatively short time. Its distinctive layer-by-layer or dot-by-dot build-up process enables the manufacture of unique and complex architectures not normally achievable through traditional manufacturing techniques. Among AM technologies, the vat photochemical process has been heavily studied because it can produce a complex structure with good surface quality, great accuracy, and high resolution within a short time compared to other AM processes. Several innovative vat 3D printing fabrication methods, such as continuous digital light processing (cDLP), continuous liquid interface production (CLIP), and computed axial lithography (CAL), have been introduced which reduce the build time dramatically. Developed by DeSimone and coworkers, CLIP enables continuous stereolithographic processing by introducing an oxygen inhibition layer, the so-called ‘dead zone’, between the exposure window and curing part, which removed the need for layer delamination procedure and reduces the build time significantly.

Tissue engineering (TE) has utilized manufactured scaffolds for regenerative medicine. Combining the advanced computer-aided design (CAD) and imaging technology, AM is expected to open a new era to TE, due to its ability to produce complex structures that enables the patient-specific design. In TE, the fabrication of engineered scaffolds with controlled architecture, dimension, pore size, and porosity are crucial to ensure mechanical integrity, mass transportation, and proper biological functions. The vat photochemical process is the most promising for TE 3D printing since it meets most of those requirements. However, while AM techniques have rapidly advanced over the last several decades, the lack of spectrum of material is one of the biggest hurdles in translating AM to clinical relevancy.

The engineered scaffold is required to replicate the mechanical and biological properties of the targeted tissue. To meet the requirements, tissue engineering utilizes several materials such as metal, wood, ceramic, and natural and synthetic materials. Synthetic polymers have been drawn great attention due to their wide range of properties and tenability, low cost, and mass production capability. For soft tissue, which is the major constituent of smooth muscle, connective tissue, ligament, and cartilage, flexible or elastic materials are the best suited. The synthetic biomaterials heavily investigated for photochemical. 3D printing include polyethylene glycol (PEG), polycaprolactone (PCL), poly[(D,L-lactide)-co-(ε-caprolactone)], polyurethane, and poly(trimethylene carbonate) (PTMC) based oligomers with acrylate or methacrylate functionalized chain ends to impart photopolymerizability. However, those materials retain limitations in processibility, mechanical properties, degradation rate, or bioactivities. Therefore, the introduction of new materials with diverse properties to give more selection is demanding.

Poly(propylene fumarate) (PPF) is an aliphatic polyester possessing an alkene bond in the backbone which enables photochemical crosslinking. Hydrolytic degradation. of PPF produces fumaric acid (FmA) and propylene glycol which are easily removed from the body or resorbed in vivo. The biocompatible, bioresorbable, sterilizable, and osteoconductive properties of crosslinked PPF has led to its investigation in a wide range of applications such as bone cement, drug delivery vehicle, nerve grafts, vascular graft, cartilage, and bone tissue engineering. The lack of control over molecular weight and low yield of traditional PPF synthesis through step-growth polymerization has been overcome by the introducing of ring-opening copolymerization (ROCOP) of maleic anhydride (MA) and propylene oxide (PO) followed by isomerization to yield well-defined PPF with narrow molecular mass distributions (Ð_{M}). The controlled nature of ROCOP has enabled the diversification of the mechanical properties of PPF. For example, recent studies using flexible PEG as an initiator or incorporating a saturated bond in the PPF backbone widened the mechanical properties of PPF. However, the elastic moduli of these materials are either too soft (10 kPa for PEG initiated PPF) or too brittle (100 MPa for PPF with saturated bond) to utilize in broad soft TE applications. Therefore, more effort is desired to diversify the mechanical properties of PPF derivatives and to expand the applications of PPF to a wider range of TE.

Typically, PPF is 3D printed through photochemical stereolithography (SLA) with a reactive diluent, such as diethyl fumarate (DEE), to reduce the viscosity and enhance the 3D printability. However, PPF resin suffers from the long build time (minutes per layer) compared to the acrylate resins (ca. ten seconds per layer) that are commonly used materials for SLA, which impede the broader application of PPF. Roppolo et al. reported 3D printing utilizing thiol-yne chemistry with bis(propargyl fumarate) as an alkyne monomer. See, Roppolo, I.; Frascella, F.; Gastaldi, M.; Castellino, M.; Ciubini, B.; Barolo, C.; Scaltrito, L; Nicosia, C.; Zanetti, M.; Chiappone, A., “Thiol—yne chemistry for 31) printing: exploiting an off-stoichiometric route for selective functionalization of 3D objects.” Polym Chem-Uk 2019, 10 (44), 5950-5958, the disclosure of which is incorporated herein by reference in its entirety. In that report, even with monomeric additives, the build time was comparable to acrylates and the possibility of post-printing functionalization makes this process attractive for TE. Furthermore, 3D printing through thiol-ene reaction has been widely investigated to build hydrogel constructs with natural or synthetic biomaterials and shows good biocompatibility. Therefore, 3D printing of PPF with thiol utilizing thiol-ene chemistry is a promising method to fabricate TE adducts.

What is needed in the art is a 3D printable, biodegradable, series of poly(propylene fumarate) derivative ABA type triblock copolymers of with flexible core unit that is cross-linkable by thiol-ene chemistry to make 3D printed structures useful for tissue engineering.

### SUMMARY OF THE INVENTION

In one or more embodiments, the present invention provides a series 3D printable, biodegradable, polypropylene fumarate) derivative ABA type triblock copolymers having a flexible propylene succinate core unit synthesized through ring-opening copolymerization using a Mg(BHT)₂(THF)₂ catalyst followed by isomerization 3D printing utilizing thiol-ene chemistry yield precise structure with improved build time. 3D printed products are fully degraded in hydrolytic condition and mechanical properties and degradation rate are tailored by polymer composition and resin formulation.

In a first aspect, the present invention is directed to an ABA triblock co-polymer comprising: a first and second A polymer block comprising poly(propylene fumarate); and a B polymer block comprising a copolymer of a cyclic anhydride and propylene oxide, wherein the first and second A polymer blocks are each bonded covalently to an end of the B polymer block to form an ABA block copolymer. In one or more of these embodiments, the cyclic anhydride is selected from the group consisting of succinic anhydride, glutaric anhydride, (pentandioic anhydride), adipic anhydride, pimelic anhydride, citraconic anhydride, itaconic anhydride, methyl itaconic anhydride, phenyl itaconic anhydride, phthalic anhydride, cyclohexane anhydride, cyclopropane anhydride, cyclopentane anhydride, cyclohexane anhydride, diglycolic anhydride, and combinations thereof. In some of these embodiments, the B polymer block comprises poly(propylene succinate). In one or more embodiments, the ABA triblock co-polymer of the present invention includes any one or more of the above referenced embodiments of the first aspect of the present invention wherein the B polymer block further comprises the residue of an initiator having at least two reactive hydroxyl, thiol or carboxylic acid groups.

In one or more embodiments, the ABA triblock co-polymer of the present invention includes any one or more of the above referenced embodiments of the first aspect of the present invention having the formula:

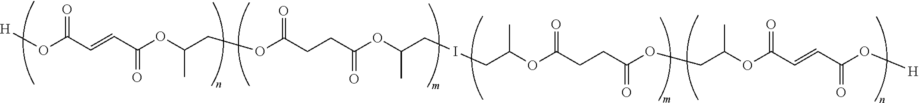

where each n is an integer from about 1 to about 20, each m is an integer from about 2 to about 70, and I is the residue of an initiator having at least two reactive hydroxyl, thiol or carboxylic acid groups.

In one or more embodiments, the ABA triblock co-polymer of the present invention includes any one or more of the above referenced embodiments of the first aspect of the present invention wherein the initiator is selected from the group consisting of fumaric acid (FmA), 1,4-cyclohexanedicarboxylic acid (CHDA), cyclohexane dimethanol (CHDM), benzene dimethanol (BDM), cis-butane-2-diol (cBD), butyn-2-diol (BYD), 1,4-butanediol, 1,5-pentanediol, 1,6-hexanediol (HDO), 1,8-octanediol, 1,10-decanediol (DD), 1,12-dodecandiol, or combinations thereof. In one or more embodiments, the ABA triblock co-polymer of the present invention includes any one or more of the above referenced embodiments of the first aspect of the present invention wherein the ratio of the degree of polymerization of the first A polymer block to the B polymer block to the second A polymer block is from 1:1.00:1 to 1:2:1. In one or more embodiments, the ABA triblock co-polymer of the present invention includes any one or more of the above referenced embodiments of the first aspect of the present invention wherein the ratio of the degree of polymerization of the first A polymer block to the B polymer block to the second A polymer block is 1:5:1. In one or more embodiments, the ABA triblock co-polymer of the present invention includes any one or more of the above referenced embodiments of the first aspect of the present invention having from about 5 mol % to about 50 mol % fumarate units.

In a second aspect, the present invention is directed to a poly (propylene fumarate-b-propylene succinate-b-propylene fumarate) ABA triblock copolymer prepared using the method according to the fifth aspect of the present invention described below.

In a third aspect, the present invention is directed to a 3D printable polymer resin comprising an ABA triblock copolymer having two crosslinkable poly(propylene fumarate) A blocks as described above and a multi-thiol crosslinker having at least two reactive thiol groups. In some embodiments, the 3D printable polymer resin comprises a poly(propylene fumarate-b-propylene succinate-b-propylene fumarate) ABA triblock copolymer and a multi-thiol crosslinker having at least two reactive thiol groups, In one or more of these embodiments, the 3D printable polymer resin of the present invention includes any one or more of the above referenced embodiments of the third aspect of the present invention wherein the multi-thiol crosslinker has from 2 to 5 reactive thiol groups.

In one or more embodiments, the 3D printable polymer resin of the present invention includes any one or more of the above referenced embodiments of the third aspect of the present invention further comprising: an organic solvent such as ethyl acetate, THF, acetone, DMSO, chloroform, methanol, ethanol, of diethyl fumarate and a photoinitiator. In various embodiments, the 3D printable polymer resin of the present invention includes any one or more of the above referenced embodiments of the third aspect of the present invention wherein the multi-thiol crosslinker is selected from the group consisting of ethylene glycol bis-mercaptoacetate, 3,6-dioxa-1,8-octanedithiol, pentaerythritol tetrakis(3-mercaptopropionate), trimethylolpropane tris(3-mercaptopropionate), 2,2′-thiodiethanethiol, ethylene glycol dithiol, tetra(ethylene glycol) dithiol, hexa(ethylene glycol) dithiol, poly(ethylene glycol) dithiol, 1,6-hexanedithiol, 1,8-oxtanedithiol, 1,9-nonanedithiol, 1,11-undecanedithol, 1,16-hexandecanedithiol, and combinations thereof. In one or more embodiments, the 3D printable polymer resin of the present invention includes any one or more of the above referenced embodiments of the third aspect of the present invention wherein the ratio of fumarate groups in the poly(propylene fumarate-b-propylene succinate-b-propylene fumarate) ABA triblock copolymer to reactive thiol groups on the multi-thiol crosslinker is from about 50 to about 0.2.

In a fourth aspect, the present invention is directed to a 3D printed polymer structure comprising the 3D printable polymer resin described above. In some of these embodiments, these 3D printed polymer structures comprises the ABA triblock co-polymer described above, crosslinked with a multi-thiol crosslinker having at least two reactive thiol groups. In one or more of these embodiments, the multi-thiol crosslinker has from 2 to 5 reactive thiol groups.

In a fifth aspect, the present invention is directed to a method for making an ABA triblock copolymers described above comprising: reacting a cyclic anhydride, a first quantity of propylene oxide, an initiator having at least two reactive hydroxyl, thiol or carboxylic acid groups, and a catalyst to form a B block polymer having a first and second end; reacting the B block polymer with maleic anhydride, a second quantity of propylene oxide, and a catalyst to form a first poly(propylene maleate) polymer block covalently bonded to the first end of the B block polymer and a second poly(propylene maleate) polymer block covalently bonded to the second end of the B block polymer to form an ABA triblock copolymer intermediate having two poly(propylene maleate) A blocks; and isomerizing the ABA triblock copolymer intermediate having two poly(propylene maleate) A blocks to form an ABA triblock copolymer having two crosslinkable poly(propylene fumarate) A blocks. In various embodiments, the cyclic anhydride may be succinic anhydride, glutaric anhydride (pentandioic anhydride), adipic anhydride, pimelic anhydride, citraconic anhydride, itaconic anhydride, methyl itaconic anhydride, phenyl itaconic anhydride, phthalic anhydride, cyclohexane anhydride, cyclopropane anhydride, cyclopentane anhydride, cyclohexane anhydride, diglycolic anhydride, or a combination thereof. In some of these embodiments, the cyclic anhydride is succinic anhydride.

In some of these embodiments, the ABA triblock copolymer intermediate having two poly(propylene maleate) A blocks is a poly(propylene maleate-b-propylene succinate-b-propylene maleate) ABA block copolymer has the formula:

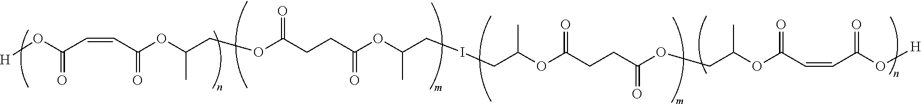

where each n is an integer from about 1 to about 20, each m is an integer from about 2 to about 70, and I is the residue of an initiator having at least two reactive hydroxyl, thiol or carboxylic acid groups. In some embodiments, the ABA triblock copolymer having two crosslinkable poly(propylene fumarate) A blocks will be a poly(propylene fumarate-b-propylene succinate-b-propylene fumarate) ABA triblock copolymer having the formula:

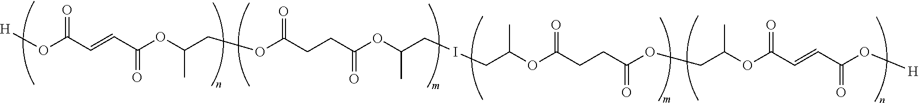

where each n is an integer from about 1 to about 20, each m is an integer from about 2 to about 70, and I is the residue of an initiator having at least two reactive hydroxyl, thiol or carboxylic acid groups.

In one or more of these of these embodiments, the method for making an ABA triblock copolymer comprises: reacting succinic anhydride, a first quantity of propylene oxide, an initiator having at least two reactive hydroxyl, thiol or carboxylic acid groups and a catalyst to form a poly(propylene succinate) polymer block having a first and second end; reacting the poly(propylene succinate) polymer block with maleic anhydride, a second quantity of propylene oxide, and a catalyst to form a first poly(propylene maleate) polymer block covalently bonded to the first end of the poly(propylene succinate) polymer block and a second poly(propylene maleate) polymer block covalently bonded to the second end of the poly(propylene succinate) polymer block to form a poly(propylene maleate-b-propylene succinate-b-propylene maleate) ABA triblock copolymer; and isomerizing the poly(propylene maleate-b-propylene succinate-b-propylene maleate) ABA block copolymer to form a poly(propylene fumarate-b-propylene succinate-b-propylene fumarate) ABA triblock copolymer.

In one or more embodiments, the method for making an ABA triblock copolymer of the present invention includes any one or more of the above referenced embodiments of the fifth aspect of the present invention wherein the mole ratio of maleic anhydride to succinic anhydride is from about 0.025 to about 15. In some embodiments, the method for making an ABA triblock copolymer of the present invention includes any one or more of the above referenced embodiments of the fifth aspect of the present invention wherein the initiator is selected from the group consisting of fumaric acid (FmA), cyclohexane dicarboxylic acid (CHDA), cyclohexane dimethanol (CHDM), benzene dimethanol (BDM), cis-butane-2-diol (cis-BD), butyn-2-diol (2BD), 1,4-butanediol, 1,5-pentanediol, 1,6-hexanediol (HD), 1,8-octanediol, 1,10-decanediol, 1,12-dodecandiol (DD), or combinations thereof. In one or more embodiments, the method for making an ABA triblock copolymer of the present invention includes any one or more of the above referenced embodiments of the fifth aspect of the present invention wherein the catalyst is Mg(BHT)₂(THF)₂.

In a sixth aspect, the present invention is directed to a method for making the 3D printable polymer resin described above comprising: dissolving the ABA triblock co-polymer described above in a suitable solvent until the resulting solution has a complex viscosity of from about 0.01 to about 10 as measured by solution rheology and then adding a multi-thiol crosslinker having at least two reactive thiol groups. In some of these embodiments, the ABA triblock co-polymer is a poly(propylene maleate-b-propylene succinate-b-propylene maleate) ABA triblock copolymer has the formula:

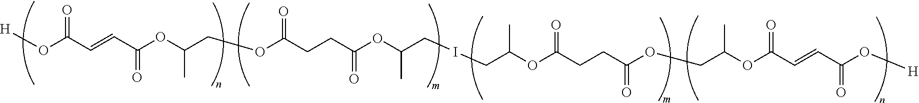

where each n is an integer from about 1 to about 20, each m is an integer from about 2 to about 70, and I is the residue of an initiator having at least two reactive hydroxyl, thiol or carboxylic acid groups. In one or more of these embodiments, the multi-thiol crosslinker has from two to five reactive thiol groups.

### BRIEF DESCRIPTION OF THE DRAWINGS

For a more complete understanding of the features and advantages of the present invention, reference is now made to the detailed description of the invention along with the accompanying figures in which:

FIGS. 1A-C are a ¹H NMR spectrum (500 MHz, 303 K, CDCl₃) (FIG. 1A), SEC (FIG. 1B), and ¹³C NMR spectrum (500 MHz, 303 K, CDCl₃) (FIG. 1C) of PPSu₂₀ (PPSu), PPM₅b-PPSu₂₀-b-PPM₅ (PPMPS-5-20-5), and PPE₅-b-PPSu₂₀-b-PPF, (PPFPS-5-20-5) polymers initiated with fumaric acid;

FIG. 2 is a ¹HNMR spectra of PPSu of DP10 initiated with FmA. (500 MHz, CDCl₃, 303 K);

FIG. 3 is a ¹HNMR spectra of PPSu of DP20 initiated with FmA. (500 MHz, CDCl₃, 303 K);

FIG. 4 is a ¹HNMR spectra of PPSu of DP40 initiated with FmA. (500 MHz, CDCl3, 303 K);

FIG. 5 is a ¹HNMR spectra of PPMPS-5-10-5 initiated with FmA (500 MHz, CDCl₃, 303 K);

FIG. 6 is a ¹HNMR spectra of PPMPS-5-20-5 initiated with FmA. (500 MHz, CDCl₃, 303 K);

FIG. 7 is a ¹HNMR spectra of PPMPS-5-40-5 initiated with FmA. (500 MHz, CDCl₃, 303 K);

FIG. 8 is a ¹HNMR spectra of PPFPS-5-10-5 initiated with FmA. (Table 1) (500 MHz, CDCl₃, 303 K);

FIG. 9 is a ¹HNMR spectra of PPFPS-5-20-5 initiated with FmA. (Table 1) (500 MHz, CDCl₃, 303 K);

FIG. 10 is a ¹ HNMR spectra of PPFPS-5-40-5 initiated with FmA. (Table 1) (500 MHz, CDCl₃, 303 K);

FIG. 11 is a ¹HNMR spectra of PPSu of DP20 initiated with CHDA. (500 MHz, CDCl₃, 303 K);

FIG. 12 is a ¹HNMR spectra of PPSu of DP20 initiated with CHDM. (500 MHz, CDCl₃, 303 K);

FIG. 13 is a ¹HNMR spectra of PPSu of DP20 initiated with BDM. (500 MHz, CDCl₃, 303 K);

FIG. 14 is a ¹HNMR spectra of PPSu of DP20 initiated with cBD. (500 MHz, CDCl₃, 303 K);

FIG. 15 is a ¹HNMR spectra of PPSu of DP20 initiated with BYD. (500 MHz, CDCl₃, 303 K);

FIG. 16 is a ¹HNMR spectra of PPSu of DP20 initiated with HDO. (500 MHz, CDCl₃, 303 K);

FIG. 17 is a ¹HNMR spectra of PPSu of DP20 initiated with DD. (500 MHz, CDCl₃, 303 K);

FIG. 18 ¹HNMR spectra of PPMPS-5-20-5 initiated with CHDA. (500 MHz, CDCl₃, 303 K);

FIG. 19 is a ¹HNMR spectra of PPMPS-5-20-5 initiated with CHDM. (500 MHz, CDCl₃, 303 K);

FIG. 20 is a ¹NMR spectra of PIMPS-5-20-5 initiated with BDM. (500 MHz, CDCl₃, 303 K);

FIG. 21 is a ¹NMR spectra of PPMPS-5-20-5 initiated with cBD. (500 MHz, CDCl₃, 303 K);

FIG. 22 is a ¹HNMR spectra of PPMPS-5-20-5 initiated with BYD. (500 MHz, CDCl₃, 303 K);

FIG. 23 is a ¹HNMR spectra of PPMPS-5-20-5 initiated with HDO. (500 MHz, CDCl₃, 303 K);

FIG. 24 is a ¹HNMR spectra of PPMPS-5-20-5 initiated with DD. (500 MHz, CDCl3, 303 K);

FIG. 25 is a ¹HNMR spectra of PPFPS-5-20-5 initiated with CHDA. (Table 1) (500 MHz, CDCl₃, 303 K);

FIG. 26 is a ¹HNMR spectra of PPFPS-5-20-5 initiated with CHDM. (Table 1) (500 MHz, CDCl₃, 303 K);

FIG. 27 is a ¹HNMR spectra of PPFPS-5-20-5 initiated with BDM. (Table 1) (500 MHz, CDCl3, 303 K);

FIG. 28 is a ¹HNMR spectra of PPFPS-5-20-5 initiated with cBD. (Table 1) (500 MHz, CDCl₃, 303 K);

FIG. 29 is a ¹HNMR spectra of PPFPS-5-20-5 initiated with BYD. (Table 1) (500 MHz, CDCl₃, 303 K);

FIG. 30 is a ¹HNMR spectra of PPFPS-5-20-5 initiated with HDO. (Table. 1) (500 MHz, CDCl₃, 303 K);

FIG. 31 is a ¹HNMR spectra of PPFPS-5-20-5 initiated with DD. (Table 1) (500 MHz, CDCl₃, 303 K);

FIG. 32 shows DSC thermograms (second heating curve, between −60 and 80° C.) for a PPFPS-5-10-5 initiated with FmA;

FIG. 33 shows DSC thermograms (second heating curve, between −60 and 80° C.) for PPFPS-5-20-5 initiated with FmA;

FIG. 34 shows DSC thermograms (second heating curve, between −60 and 80° C.) for PPFPS-5-40-5 initiated with FmA;

FIG. 35 shows DSC thermograms (second heating curve, between −60 and 80° C.) for PPFPS-5-20-5 initiated with CHDA;

FIG. 36 shows DSC thermograms (second heating curve, between −60 and 80° C.) for PPFPS-5-20-5 initiated with CHDM;

FIG. 37 shows DSC thermograms (second heating curve, between −60 and 80° C.) for PPFPS-5-20-5 initiated with BDM;

FIG. 38 shows DSC thermograms (second heating curve, between −60 and 80° C.) for PPFPS-5-20-5 initiated with cBD.

FIG. 39 shows DSC thermograms (second heating curve, between −60 and 80° C.) for PPFPS-5-20-5 initiated with BYD;

FIG. 40 shows DSC thermograms (second heating curve, between −60 and 80° C.) for PPFPS-5-20-5 initiated with HDO;

FIG. 41 shows DSC thermograms (second heating curve, between −60 and 80° C.) for PPFPS-5-20-5 initiated with DD;

FIG. 42 is a ¹³CNMR spectra of PPSu of DP10 initiated with FmA. (125 MHz, CDCl3, 303 K);

FIG. 43 is a ¹³CNMR spectra of PPSu of DP20 initiated with FmA. (125 MHz, CDCl3, 303 K);

FIG. 44 is a ¹³CNMR spectra of PPSu of DP41-0 initiated with FmA. (125 MHz, CDCl3, 303 K);

FIG. 45 is a ¹³CNMR spectra of PPMPS-5-10-5 initiated with FmA. (125 MHz, CDCl3, 303 K);

FIG. 46 ¹³CNMR spectra of PPMPS-5-20-5 initiated with FmA. (125 MHz, CDCl3, 303 K);

FIG. 47 is a ¹³CNMR spectra of PPMPS-5-40-5 initiated with FmA. (125 MHz, CDCl₃, 303 K);

FIG. 48 is a ¹³CNMR spectra of PPI PS-5-10-5 initiated with mA. (Table 1) (1.25 MHz, CDCl₃, 303 K);

FIG. 49 is a ¹³CNMR spectra of PPFPS-5-20-5 initiated with FmA. (Table 1) (125 MHz, CDCl3, 303 K);

FIG. 50 is a ¹³CNMR spectra of PPI PS-5-40-5 initiated with mA. (Table 1) (1.25 MHz, CDCl₃, 303 K);

FIG. 51 is a ¹³CNMR spectra of PPFPS-5-20-5 initiated with CHDA. (Table 1) (125 MHz, CDCl3, 303 K);

FIG. 52 is a ¹³CNMR spectra of PPFPS-5-20-5 initiated with CHDM. (Table 1) (125 MHz, CDCl₃, 303 K);

FIG. 53 is a ¹³CNMR spectra of PPFPS-5-20-5 initiated with BDM. (Table 1) (125 MHz, CDCl₃, 303 K);

FIG. 54 is a ¹³CNMR spectra of PPFPS-5-20-5 initiated with cBD. (Table 1) (125 MHz, CDCl3, 303 K);

FIG. 55 is a ¹³CNMR spectra of PHPS-5-20-5 initiated with BYD. (Table 1) (125 MHz, CDCl₃, 303 K);

FIG. 56 is a ¹³CNMR spectra of PPFPS-5-20-5 initiated with HDO. (Table 1) (125 MHz, CDCl₃, 303 K);

FIG. 57 is a ¹³CNMR spectra of PPFPS-5-20-5 initiated with DD. (Table 1) (125 MHz, CDCl₃, 303 K);

FIGS. 58A-B are MALDI-ToF MS plots of fumaric acid initiated PPSu of DP 10 indicating propylene succinate (M.W 158 Da) is a repeating unit FIG. 58A) and MALDI-ToF MS plot of fumaric acid initiated PPM₃-b-PPSu₁₀-b-PPM₃ (PPMPS-3-10-3) indicating propylene maleate (M.W 156 Da) is a repeating unit (FIG. 58B);

FIG. 59 is a graph comparing the complex viscosity of triblock copolymer resins with ethyl acetate solvent in various formulations;

FIG. 60 is an image taken of 3D printed products (tensile bars, solid discs, and solid bars) formed from PPFPS-5-20-5 at 2:1 PPF to thiol ratio;

FIG. 61 is a graph showing the ratio of diameter and height of 3D printed discs of PPFPS-5-20-5 in several PPF to thiol ratios after vacuum drying at 40° C. for 2 days to dry;

FIG. 62 is stress-strain curves of three PPFPS-3-10-3 (FmA initiator) samples 3D printed at a 2:1 PPF to thiol ratio;

FIGS. 63A-D are stress-strain curves of three PPFPS-5-10-5 (FmA initiator) samples 3D printed at PPF to thiol ratios of 1:1 (FIG. 63A), 2:1 (FIG. 63B), 5:1 (FIG. 63C) and 10:1 (FIG. 63D);

FIGS. 64A-D are stress-strain curves of three PPFPS-5-20-5 (FmA initiator) samples 3D printed at PPF to thiol ratios of 1:1 (FIG. 64A), 2:1 (FIG. 64B), 5:1 (FIG. 64C) and 10:1 (FIG. 64D);

FIG. 65 shows stress-strain curves of three PPFPS-5-40-5 (FmA initiator) 3D printed at a 2:1 PPF to thiol ratio;

FIGS. 66A-C are graphs showing uniaxial elongation tensile test results of 3D printed tensile bars in various resin formulations including stress-strain curves for triblock copolymer in various PPF to PPSu ratios (FIG. 66A); stress-strain curves for 5-10-5 triblock copolymer in various PPF to thiol mole ratios (FIG. 66B) and the stress-strain curves for 5-20-5 triblock copolymer in various PPF to thiol mole ratios (FIG. 66B);

FIGS. 67A-B are graphs showing cyclic tensile data of the 3D printed tensile bar of 5-40-5 copolymer with 2:1 PPF vs thiol ratio on 10 mm/min strain rate at ambient temperature (FIG. 67A) and cyclic tensile data of the 3D printed tensile bar of 5-40-5 copolymer with 2:1 PPF vs thiol ratio on 10 mm/min strain rate at 37° C. (FIG. 67B);

FIGS. 68A-D show cyclic tensile tests of three 3D printed tensile bars formed with FmA initiated PPFPS-5-20-5 in various PPF to thiol ratios (1:1 (FIG. 68A), 2:1 (FIG. 68B), 5:1 (FIG. 68C), and 10:1 (FIG. 68D)) at ambient temperature;

FIGS. 69A-B are graphs showing swelling ratios and sol fractions of 3D printed discs with various PPF vs PPSu ratios (FIG. 69A) in polymer compositions with 2:1 of PPF vs thiol ratio and (PPF vs thiol ratios in resin formulations of 5-10-5 block composition FIG. 69B); and

FIG. 70A-B is a graph showing accelerated degradation test results of 3D printed disc in 0.25 N KOH(aq.) solution at 37° C.

### DETAILED DESCRIPTION OF THE ILLUSTRATIVE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure.

In one or more embodiments, the present invention is directed to a series 3D printable, biodegradable, polypropylene fumarate) derivative ABA type triblock copolymers having a flexible propylene succinate core unit synthesized through ring-opening copolymerization using a Mg(BHT)₂(THF), catalyst followed by isomerization. 3D printing utilizing thiol-ene chemistry yield precise structure with improved build time. 3D printed products are fully degraded in hydrolytic condition and mechanical properties and degradation rate are tailored by polymer composition and resin formulation.

The following terms may have meanings ascribed to them below, unless specified otherwise. As used herein, the terms “comprising” “to comprise” and the like do not exclude the presence of further elements or steps in addition to those listed in a claim. Similarly, the terms “a,” “an” or “the” before an element or feature does not exclude the presence of a plurality of these elements or features, unless the context clearly dictates otherwise.

Unless specifically stated or obvious from context, as used herein, the term “about” is understood as within a range of normal tolerance in the art, for example within. 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term “about.”

It should be also understood that the ranges provided herein are a shorthand for all the values within the range and, further, that the individual range values presented herein can be combined to form additional non-disclosed ranges. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

Further, as used herein, the term “isomerization” refers broadly to the conversion of the cis-isomer (PPM) to its trans-isomer (PPF) form or, in the context of a chemical reaction or process (an “isomerization reaction”), to a reaction or process that converts the cis-isomer (PPM) to its trans-isomer (PPF) form.

As used herein, the term “residue(s)” is used to refer generally to the part of a monomer or other chemical unit that has been incorporated into a polymer or large molecule. By extension, the term “residue of the maleic anhydride” the refer to the parts of the maleic anhydride monomer, respectively, that have been incorporated into the PPM and PPF portions the ABA triblock copolymers. Similarly, the terms “residue of the cyclic anhydride” and “residue of the succinic anhydride” the refer to the parts of the cyclic anhydride monomer and succinic anhydride monomer, respectively that have been incorporated into the B block portion of the ABA triblock copolymers. Also, the terms “residue of the initiator” or “initiator alcohol residue” and the like, refer to the parts of the initiator that remain bound within the B block polymer chain of the ABA triblock copolymers after it initiates polymerization.

All publications, patent applications, patents, and other references mentioned herein are expressly incorporated by reference in their entirety, which means that they should be read and considered by the reader as part of this text. That the document, reference, patent application, or patent cited in this text is not repeated in this text is merely for reasons of conciseness. In the case of conflict, the present disclosure, including definitions, will control. All technical and scientific terms used herein have the same meaning.

Further, any compositions or methods provided herein can be combined with one or more of any of the other compositions and methods provided herein. The fact that given features, elements or components are cited in different dependent claims does not exclude that at least some of these features, elements or components maybe used in combination together.

In a first aspect, the present invention is directed to an ABA triblock co-polymer for use in making resins for 3D printing applications. In various embodiments, these ABA triblock co-polymers have two crosslinkable poly(propylene fumarate) (PPF) A blocks covalently bonded to the ends of a flexible B block polymer. In one or more embodiments, these ABA tribiock co-polymers comprise a polymerized reaction product of at least two different cyclic anhydrides and propylene oxide, wherein the B polymer block is formed around an initiator having at least two reactive hydroxyl, thiol or carboxylic acid groups by the ring opening copolymerization of one or more cyclic anhydride and propylene oxide and the two A polymer blocks are formed from the ends of the B polymer block by the subsequent ring opening copolymerization (ROCOP) of maleic anhydride and propylene oxide. As will be appreciated by those of skill in the art, the initial A polymer blocks will comprise poly(propylene maleate) and must be isomerized to form the crosslinkable PPF A blocks. The ABA triblock copolymers will also include the residue of the initiator (I), generally located in the approximate center of the B block of the copolymer. As will also be apparent to those of skill in the art, the fumarate units of the PPF A blocks of the ABA triblock co-polymer contain an unsaturated alkene bond that are available for cross linking, as will be discussed in more detail below.

As will be appreciated, the first and second poly(propylene fumarate) (PPF) A blocks will be substantially the same and will have the same or essentially the same DP. In various embodiments, the degree of polymerization (DP) of each A block of the ABA triblock co-polymer will be from about 1 to about 20, preferably from about 1 to about 10, and more preferably from about 1 to about 5. In some embodiments, the degree of polymerization (DP) of each A block of the ABA triblock co-polymer will be from about 1 to about 18, in other embodiments, from about 1 to about 12, in other embodiments, from about 3 to about 20, in other embodiments, from about 5 to about 20, in other embodiments, from about 8 to about 20, in other embodiments, from about 12 to about, in other embodiments, from about 20 to about, and in other embodiments, from about 15 to about 20. As set forth above and would be expected by those of skill in the art, the A blocks of the ABA triblock co-polymer are covalently bonded to the ends of the more flexible B block of the polymer.

As set forth above, the PPF residues forming the two A blocks of the ABA triblock co-polymers contain unsaturated alkene functional groups that are crosslinkable. As used herein, the term “crosslinkable” as applied to the properties of a polymer material refers to the ability of the polymer material to form links between different polymer chains either directly or by means of a multifunctional crosslinking material (a “crosslinker”) which forms bonds with different polymer chains, thereby linking them. As follows, the term “crosslink” is used to refer to a link formed between two polymer chains. Similarly, the term “crosslinked” as applied to a polymer or polymer composition refers to a polymer or polymer composition wherein crosslinks have been formed between the polymer chains comprising the polymer or polymer composition. As noted above, the PPF residues forming the A blocks of the ABA triblock co-polymer of the present invention are crosslinkable at their unsaturated fumarate bonds using multi-thiol crosslinkers having at least two reactive thiol groups, as will be discussed in more detail below with regard to ABA triblock resins and 3d printed structures made with the ABA triblock co-polymer of the present invention.

As set forth above, the B blocks of the ABA triblock co-polymer of the present invention are made from the ring-opening polymerization of one or more cyclic anhydride (other than maleic anhydride) and propylene oxide. Suitable cyclic anhydrides may include, without limitation, succinic anhydride, glutaric anhydride (pentandioic anhydride), adipic anhydride, pimelic anhydride, citraconic anhydride, itaconic anhydride, methyl itaconic anhydride, phenyl itaconic anhydride, phthalic anhydride, cyclohexane anhydride, cyclopropane anhydride, cyclopentane anhydride, cyclohexane anhydride, diglycolic anhydride and combinations thereof. In one or more embodiments, the cyclic anhydride is succinic anhydride.

In various embodiments, the degree of polymerization (DP) of the B block of the ABA triblock co-polymer will be from about 1 to about 70, preferably between 10 and 50, and more preferably between 10 and 30. In some embodiments, the degree of polymerization (DP) of each B block of the ABA triblock co-polymer will be from about 1 to about 65, in other embodiments, from about 1 to about 50, in other embodiments, from about 1 to about 40, in other embodiments, from about 1 to about 30, in other embodiments, from about 1 to about 20, in other embodiments, from about 5 to about 70, in other embodiments, from about 15 to about 70, in other embodiments, from about 25 to about 70, in other embodiments, from about 35 to about 70, and in other embodiments, from about 50 to about 70, In some embodiments, the degree of polymerization (DP) of each B block of the ABA triblock co-polymer will be between 10 and 40. In some embodiments, the degree of polymerization (DP) of the B block of the ABA triblock co-polymer will be between 10 and 25. In some embodiments, the degree of polymerization (DP) of the B block of the ABA triblock co-polymer will be between 10 and 20.

As set forth above, the B block will also contain the residue of a bifunctional, tri functional or tetra functional initiator used to initiate the ring opening polymerization from which it was formed. In one or more embodiments, the B block will contain residue of an initiator having at least two reactive hydroxyl, thiol or carboxylic acid groups. In various embodiments, the B block may contain, without limitation, a residue of fumaric acid (FmA), succinic acid, 1,4-cyclohexanedicarboxylic acid (CHDA), cyclohexane dimethanol (CHDM), benzene dimethanol (BDM), cis-butane-2-diol (cBD), Butyn-2-diol (BYD), 1,4-butanediol, 1,5-pentanediol, 1,6-hexanediol (HDO), 1,8-octanediol, 1,10-decanediol (DD), 1,12-dodecandiol, or a combination thereof. Because polymerization is initiated from at least two reactive hydroxyl, thiol or carboxylic acid groups, the residue of the initiator will end tip in the center of the B block assuming that the reaction is substantially uniform throughout the reaction vessel. As will be apparent, if the initiator is tri functional or tetra functional, the resulting polymer may be linear and may have more than two BA arms extending from the residue of the initiator.

In one or more embodiments, the ABA triblock co-polymer of the present invention has the formula:

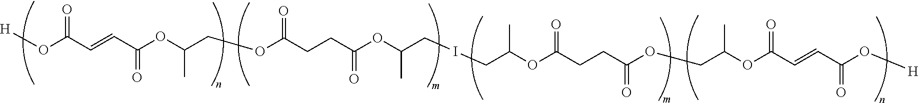

where each n is an integer from about 1 to about 20, each m is an integer from about 2 to about 70, and 1 is the residue of an initiator having at least two reactive hydroxyl, thiol or carboxylic acid groups. In some embodiments, each n is an integer from about 1 to about 18, preferably an integer from about 1 to about 10, and more preferably an integer from about 1 to about 5 In some embodiments, each n is an integer from about 1 to about 15, in other embodiments, from about 3 to about 20, in other embodiments, from about 5 to about 20, in other embodiments, from about 8 to about 20, in other embodiments, from about 10 to about 20, in other embodiments, from about 12 to about 20, in other embodiments, from about 15 to about 20, and in other embodiments, from about 18 to about 20. In some embodiments, each n is 3. In some embodiments, each n is 5.

In various embodiments, each m is an integer from about 1 to about 70, preferably between 10 and 50, and more preferably between 10 and 30. In some embodiments, each m is an integer from about 1 to about 65, in other embodiments, from about 1 to about 50, in other embodiments, from about 1 to about 40, in other embodiments, from about 1. to about 30, in other embodiments, from about 1 to about 20 in other embodiments, from about 5 to about 70, in other embodiments, from about 15 to about 70, in other embodiments, from about 25 to about 70, in other embodiments, from about 35 to about 70, and in other embodiments, from about 50 to about 70. In some embodiments, each m is an integer from between 10 and 40. In some embodiments, each m is an integer from 10 and 25. In some embodiments, each in is an integer from 10 and 20.

In some of these embodiments, I is one or more C₂ to C₂₀ diol, C₂ to C₂₀ dithiol, C₂ to C₂₀ dicarboxylic acid, or a combination thereof. In some other embodiments, I will comprise a C₂ to C₂₀ alkyl or aryl group having one or more terminal hydroxyl group and one or more terminal carboxyl groups or thiol groups. In some other embodiments, I will comprise a C₂ to C₂₀ alkyl or aryl group having one or more terminal carboxyl group and one or more terminal thiol groups. In some embodiments, I is the residue of an initiator selected from fumaric acid (FmA), succinic acid, 1,4-cyclohexanedicarboxylic acid. (CHDA), cyclohexane dimethanol (CHDM), benzene dimethanol (BDM), cis-butane-2-diol (cis-BD), butyn-2-diol (2BD), 1,4-butanediol, 1,5-pentanediol, 1,6-hexanediol (HD), 1,8-octanediol, 1,10-decanediol, 1,12-dodecandiol (DD), or a combination thereof. In some embodiments, I is the residue of fumaric acid (FmA). In some other embodiments, I is the residue of 1,4-cyclohexanedicarboxylic acid (CHDA). In some other embodiments, I is the residue of cyclohexane dimethanol (CHDM). In some other embodiments, I is the residue of benzene dimethanol (BDM) In some other embodiments, I is the residue of cis-butane-2-diol (cis-BD). In some other embodiments, I is the residue of butyn-2-diol (2D). In some other embodiments, I is the residue of hexanediol (HD). In some other embodiments, I is the residue of 1,12-dodecandiol (DD).

In various embodiments, the ratio of the degree of polymerization of the first A polymer block to the B polymer block to the second A polymer block is from 1:100:1 to 1:2:1, preferably from about 1:50:1 to about 1:2:1, and more preferably from about 1:10:1 to about 1:2:1. In some embodiments, the ratio of the degree of polymerization of the first A polymer block to the B polymer block to the second A polymer block is from about 1:30:1 to about 1:2:1. In some embodiments, the ratio of the degree of polymerization of the first A polymer block to the B polymer block to the second A polymer block is from about 1:20:1 to about 1:2:1.In some embodiments, the ratio of the degree of polymerization of the first A polymer block to the B polymer block to the second A polymer block is 1:5:1.

In various embodiments, the ABA triblock co--polymer will contain from about 5 mol % to about 50 mol % fumarate units, in other embodiments from about 5 mol % to about 40 mol % fumarate units, in other embodiments, from about 5 mol % to about 30 mol % fumarate units, in other embodiments, from about 5 mol % to about 20 mol % fumarate units, in other embodiments, from about 10 mol % to about 50 mol % fumarate units, in other embodiments, from about 10 mol % to about 40 mol % fumarate units, in other embodiments, from about 10 mol % to about 30 mol % fumarate units, in other embodiments, from about 20 mol % to about 50 mol % fumarate units, in other embodiments, from about 30 mol % to about 50 %, fumarate units, and in other embodiments, from about 40 mol % to about 50 mol % fumarate units.

In one or more embodiments, the ABA triblock co-polymers of the present invention will have a glass transition temperature (T_{g}) of from about −50° C. to about 10° C. (below 10° C.), preferably from about −40° C. to about 5° C. (below 5° C.), and more preferably from about −35° C. to about 0° C. (below 0° C.).

In one or more embodiments, the ABA triblock co-polymers of the present invention will have a degradation temperature (T_{d}) of from about 100° C. to about 500° C. (above 100° C.), preferably from about 150° C. to about 450° C. (above 150° C.), and more preferably from about 200° C. to about 400° C. (above 200° C.).

In one or more embodiments, the ABA triblock co-polymers of the present invention will have a number average molecular mass (Mₙ) of from about 500 Da to about 30000 Da, preferably from about 800 Da to about 25,000 Da, and more preferably from about 1000 Da to about 20000 Da.

In various embodiments, the ABA triblock co-polymers of the present invention will have a molecular mass distribution (Ðₘ) of from about 1.01 to about 5.00, preferably from about 1.02 to about 4.50, and more preferably from about 1.03 to about 4.00.

Because the polymer making up the B block is generally saturated and does not provide an alkene unit for crosslinking, it is and will remain less stiff and more flexible than the PPF A blocks. As a result, the ABA triblock co-polymers of the present invention will have a lower viscosity than a PPF polymer of comparable size. In various embodiments, the ABA triblock co-polymers of the present invention will have a complex viscosity of from about 0.001 Pa·s to 20 Pa·s, preferably from about 0.01 Pa·s to about 10 Pa·s, and more preferably from about 0.05 Pa·s to about 5 Pa·s.

In a second aspect, the present invention is directed to a method for making the ABA triblock copolymer described above. In one or more embodiments, the ABA triblock copolymer of the present invention may be made as shown in Scheme 1 below.

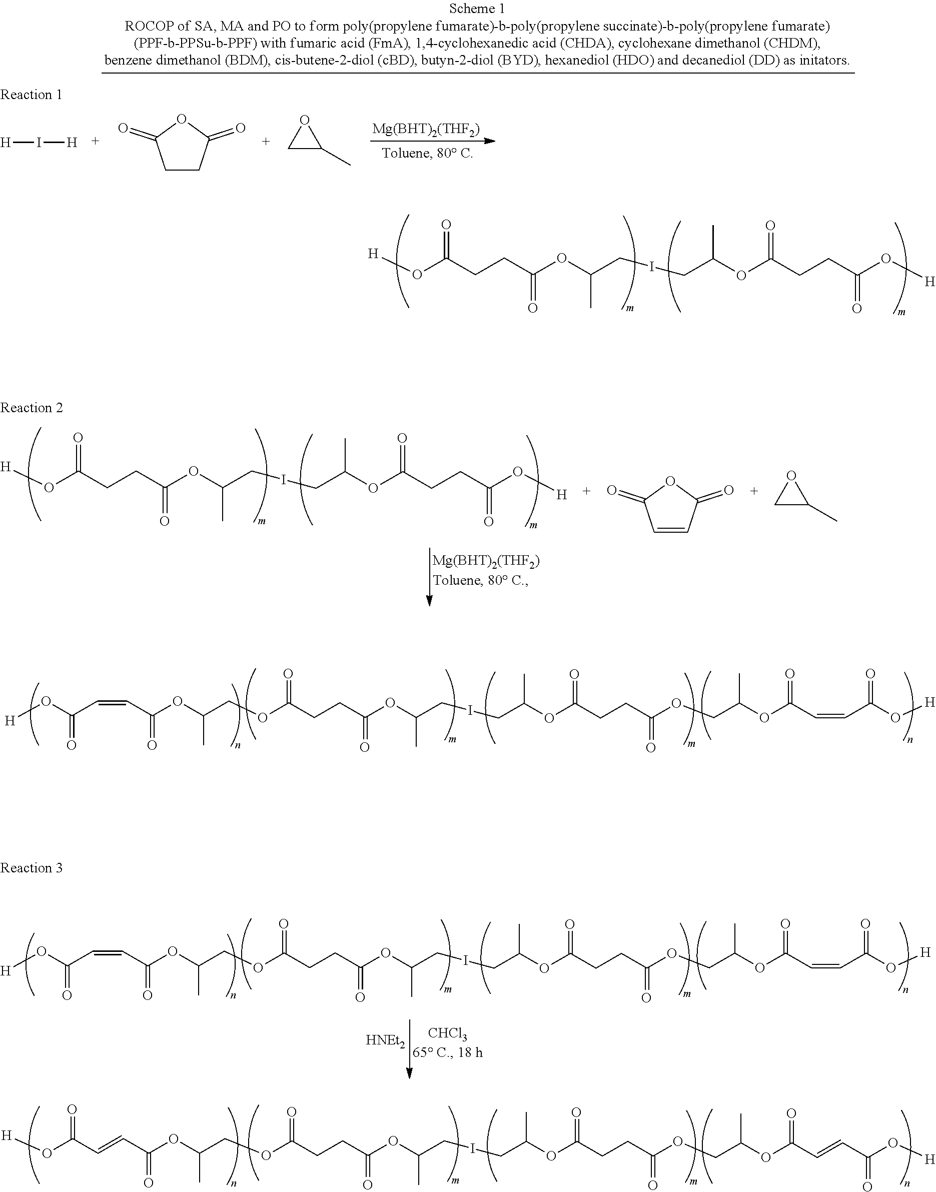

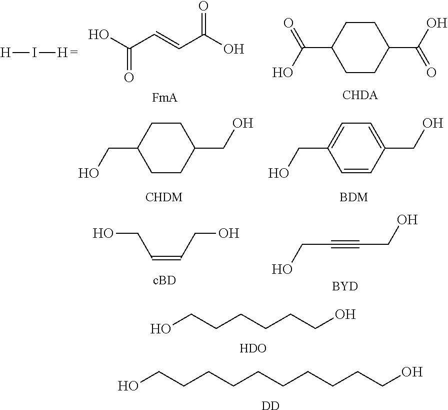

In a first reaction, the selected cyclic anhydride is reacted with propylene oxide by ring opening polymerization in the presence of an initiator and a catalyst to form the B polymer block. In these embodiments, a selected cyclic anhydride, a first quantity of propylene oxide, an initiator having at least two reactive hydroxyl, thiol or carboxylic acid groups, a catalyst and a suitable reaction solvent are added to a suitable reaction vessel under an inert atmosphere. While the first reaction may occur at ambient temperature, the vessel is preferably heated to a temperature of from about 40° C. to about 150° C., preferably from about 50° C. to about 140° C., and more preferably from about 60° C. to about 130° C. to facilitate the reaction. As will be apparent, the reaction vessel should not be heated to a temperature at or above the degradation temperature (T_{d}) of the polymer being formed or any of the reagents. In some of these embodiments, the reaction vessel is heated to a temperature of about 80° C. to facilitate the reaction.

The one or more cyclic anhydrides selected to form the B block of the polymer is not particularly limited provided that it will polymerize with propylene oxide by ring opening polymerization and does not contain a cross-linkable alkene group. Suitable cyclic anhydrides may include, without limitation, succinic anhydride, glutaric anhydride (pentandioic anhydride), adipic anhydride, pimelic anhydride, citraconic anhydride, itaconic anhydride, methyl itaconic anhydride, phenyl itaconic anhydride, phthalic anhydride, cyclohexane anhydride, cyclopropane anhydride, cyclopentane anhydride, cyclohexane anhydride, diglycolic anhydride and combinations thereof. As will be apparent, the selected cyclic anhydride should not be maleic anhydride, as that anhydride will be used to form the A blocks and, as set forth above, contains a cross-linkable alkene group. In one or more embodiments, the cyclic anhydride is succinic anhydride.

The initiator chosen is not particularly limited provided that it has at least two reactive hydroxyl, thiol or carboxylic acid groups and does not otherwise interfere with. the reaction. In one or more embodiments, the initiator may be one or more C₂ to C₂₀ diol, C₂ to C₂₀ dithiol, or C₂ to C₂₀ dicarboxylic acid. Suitable initiators may include, without limitation, fumaric acid (FmA), succinic acid, 1,4-cyclohexnadicarboxylic acid (CHDA), cyclohexane dimethanol (CHDM), benzene dimethanol (BDM), cis-butane-2-diol (cis-BD), butyn-2-diol (BYD), 1,4-butanediol, 1,5-pentanediol, 1,6-hexanediol (HD), 1,8-octanediol, 1,10-decanediol, 1,12-dodecandiol (DD), or a combination thereof. In one or more embodiments, the one or more initiator may have one or more of the following formulas:

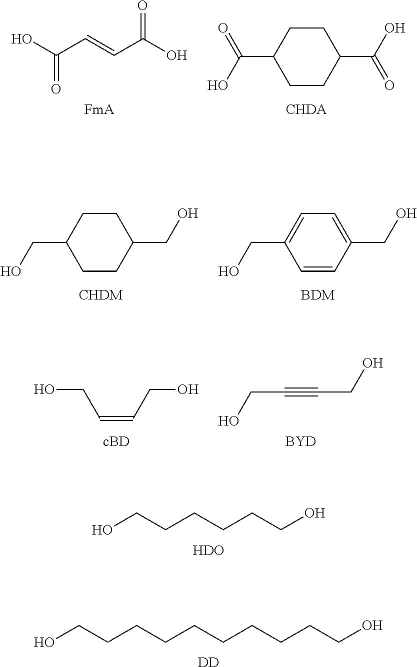

The versatility of the various potential initiators is an important advantage of the present invention. In some embodiments, the relatively higher portion of initiator residue compared to low molecular weight copolymer means that the initiator can significantly impact polymer properties, and, in turn, the 3D printed product. In some embodiments, orthogonal reactions, such as azide-alkyne click reaction in the case of butynediol, may be utilized to enable the post-polymerization modification of the ABA triblock copolymer to endow additional functionality before or after 3D printing.

In some amendments, a single type of initiator will be used to initiate the first reaction, the invention is not to be so limited. In one or more other embodiments, two or more different types of initiators may be used to initiate the first reaction, but this is not preferred.

The reaction solvent chosen should be a solvent for all the reagents in the first reaction at the selected operating conditions, but the reaction solvent used is not otherwise limited, provided that the solvent chosen does not react with any of the reagents or inhibit the ring-opening polymerization reaction or denature the catalyst. In one or more embodiments, the reaction solvent will be an organic solvent. Suitable solvents may include, without limitation, toluene, hexane, heptane CH₂Cl₂, CCl₃, CCl₄, and combinations thereof. In one or more embodiments, the reaction solvent for the first reaction is toluene.

The catalyst for the first reaction is not particularly limited provided that it will. catalyze the ring opening polymerization of cyclic anhydrides and propylene oxide. Suitable catalysts include magnesium catalysts, including MgEt₂ and Mg(BHT)₂(THF)₂, but Mg(BHT)₂(THF)₂ is preferred. In most embodiments, the quantity of catalyst added is sufficient to catalyze both the first and the second reaction. (See Scheme 1, above).

The first reaction is allowed to proceed until substantially all (approximately 99%) of the selected cyclic anhydride has reacted and then allowed to cool to ambient temperature. The reaction should not, however, be allowed to consume 100% of the available cyclic anhydride and run to completion, as it may become difficult to restart the reaction to add the A blocks as described below. As would be apparent to those of skill in the art, the amount of time required for substantially all the selected cyclic anhydride to react will depend, upon, among other things, the cyclic anhydride selected, the quantity of reactants, the reaction temperature, the reactivity of the initiator, the type and quantity of catalyst used and the reaction conversion.

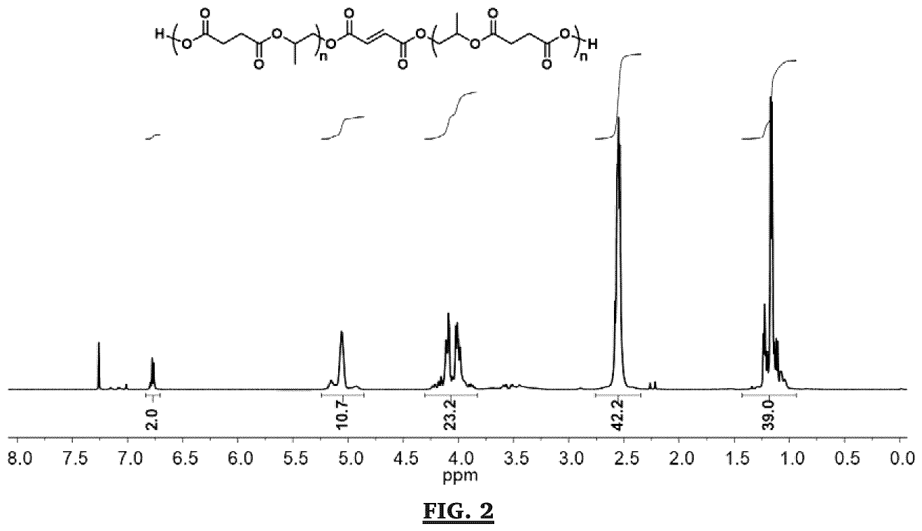

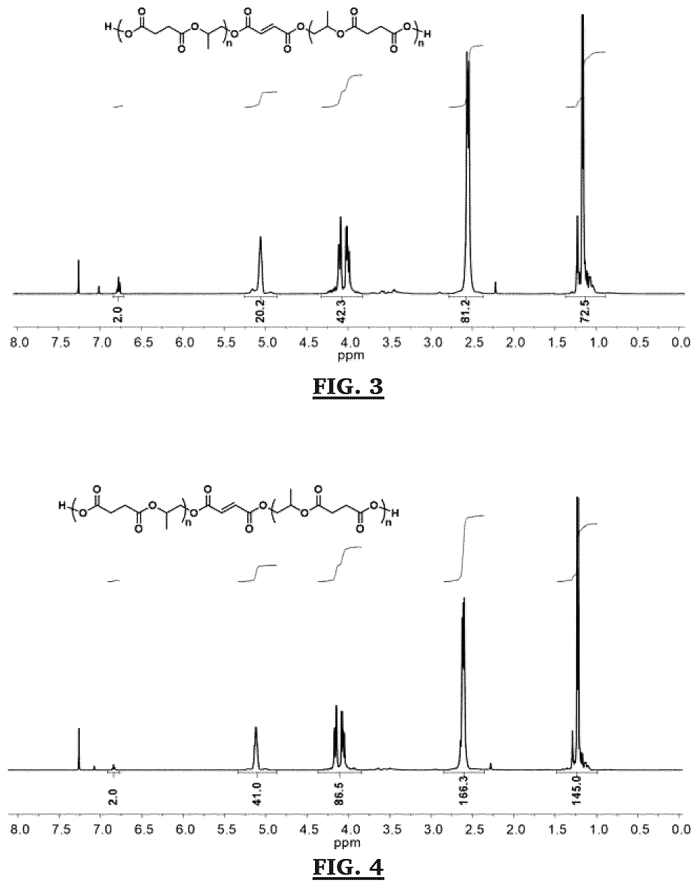

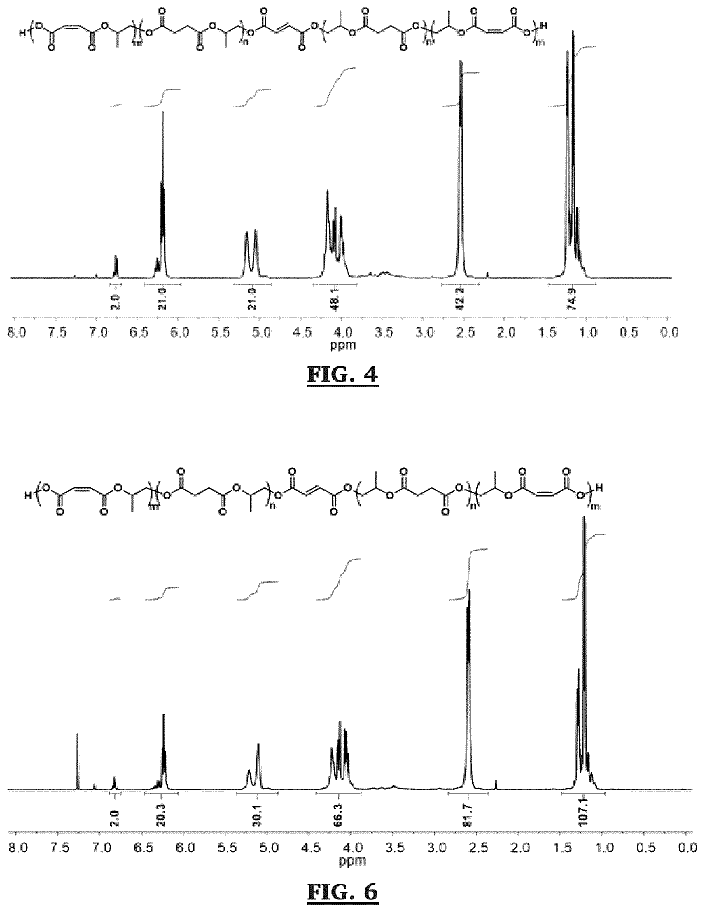

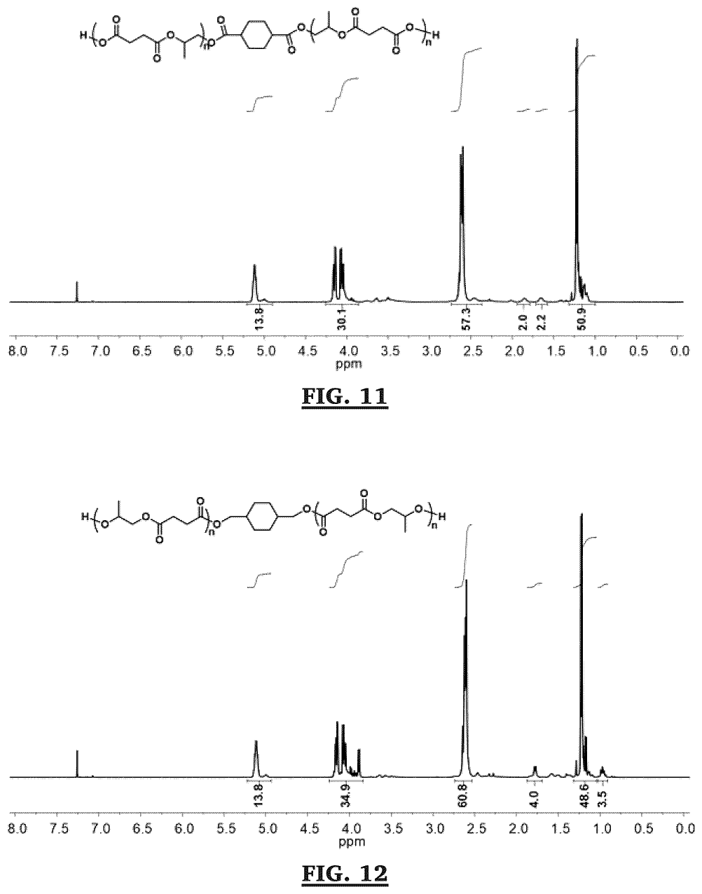

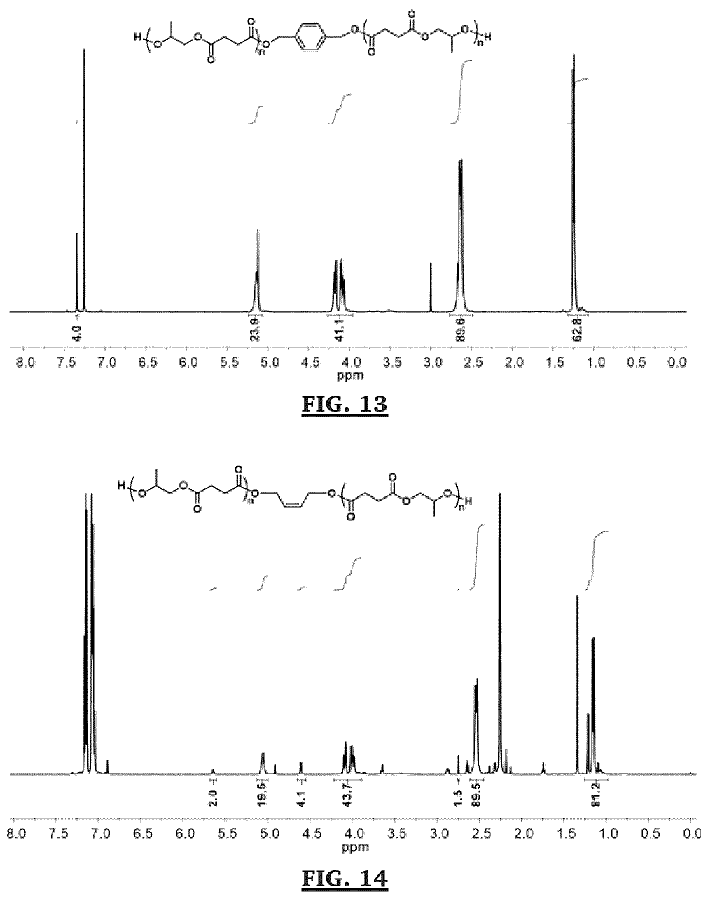

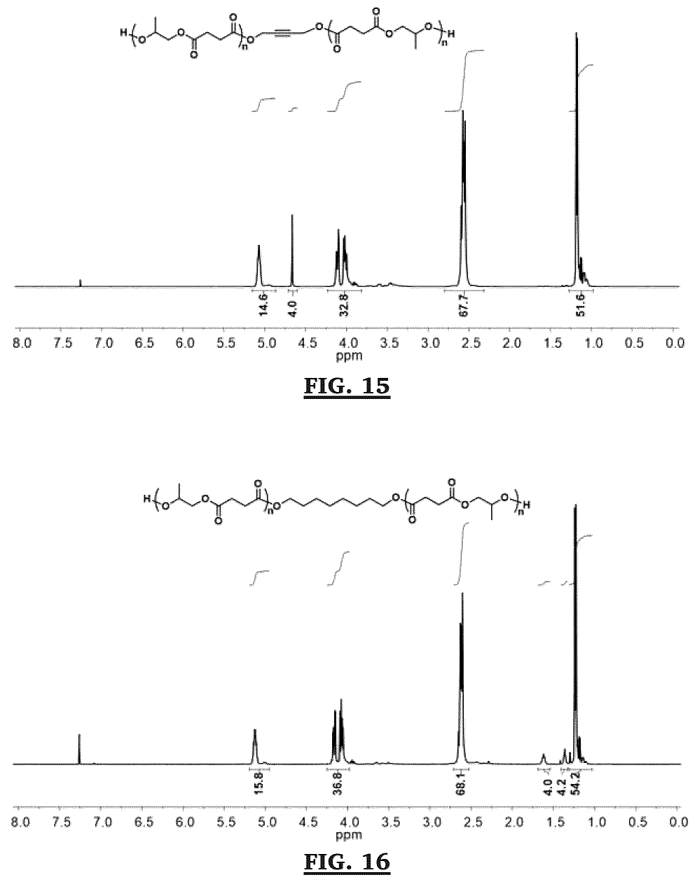

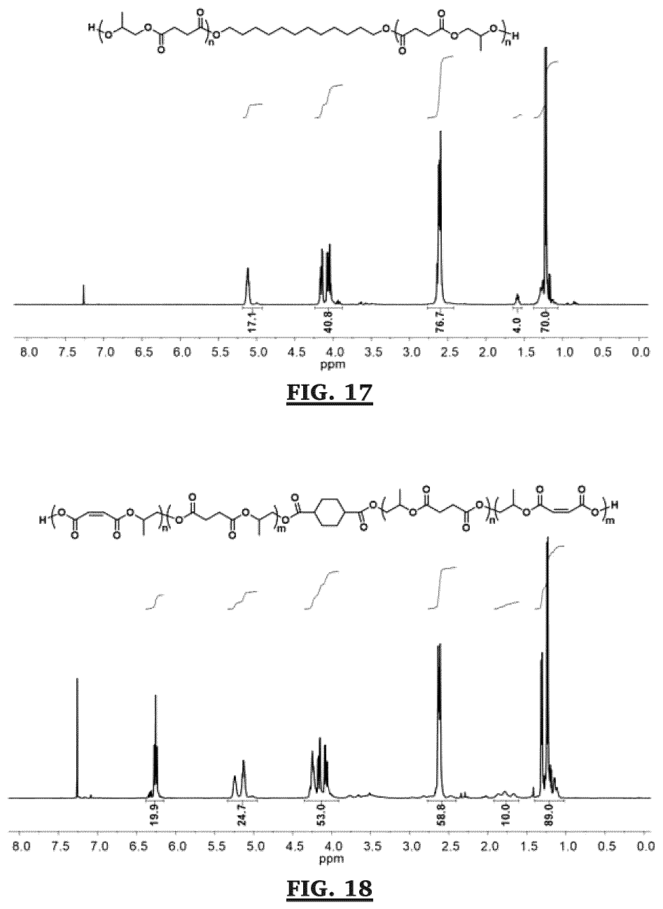

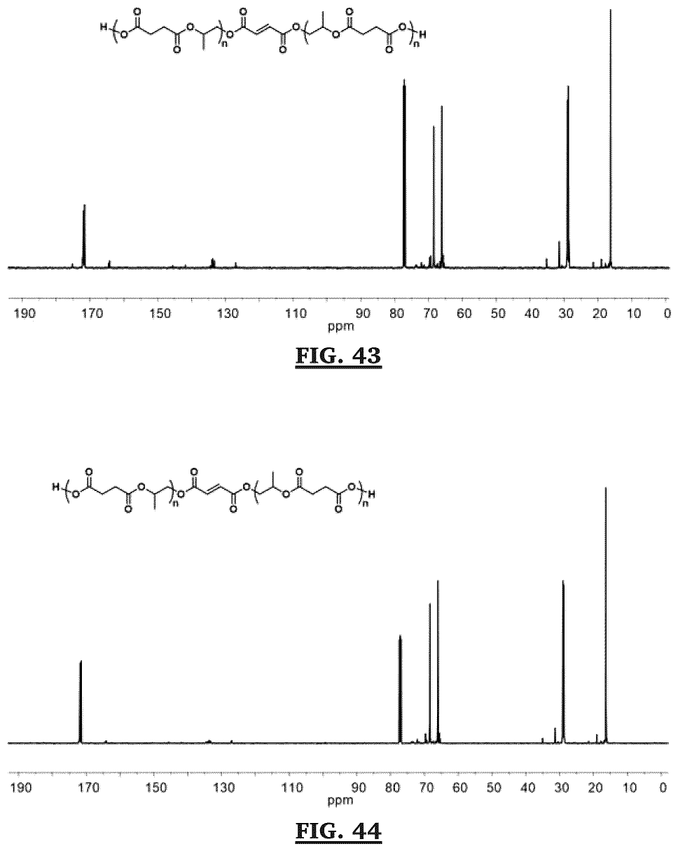

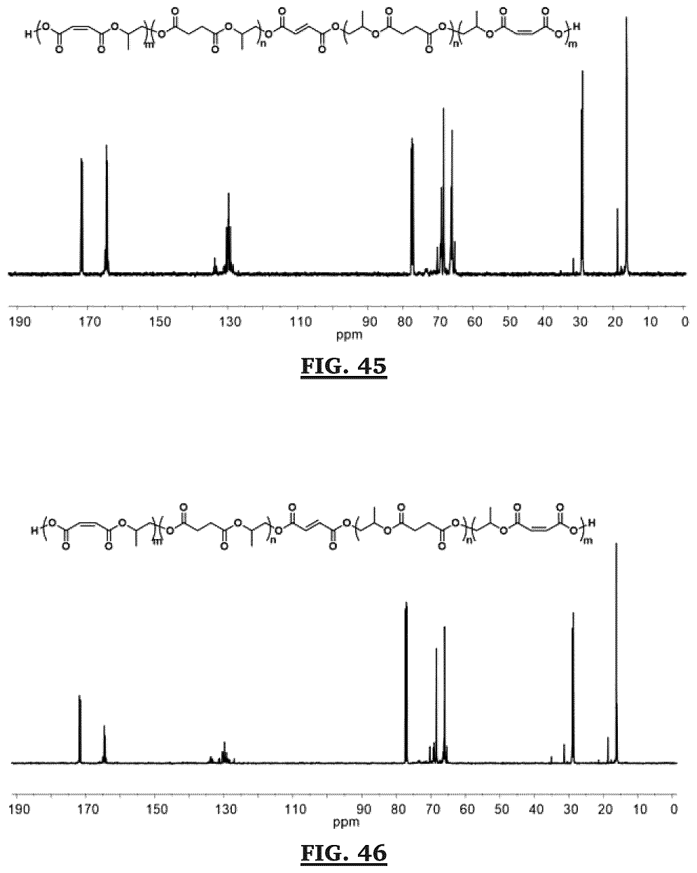

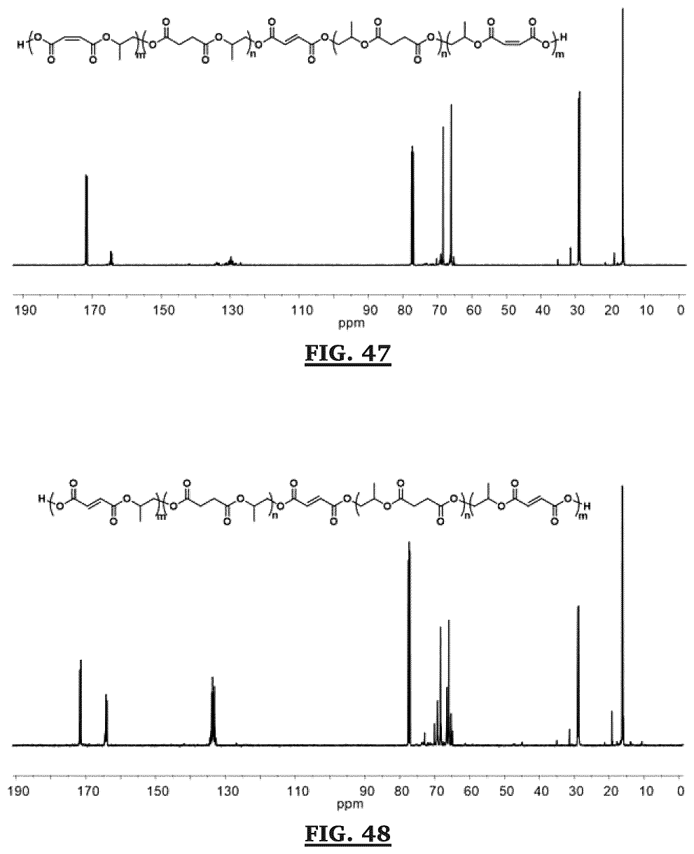

As will be apparent and can be seen in scheme 1, the bifunctional initiators will initiate the ring opening polymerization of the cyclic anhydride and propylene oxide in two directions to form a B block intermediate polymer having two reactive ends capable continuing ring opening polymerization. In some embodiments, the cyclic anhydride is succinic anhydride as shown in Scheme 1, above, and B block intermediate polymer formed in the first reaction has the formula:

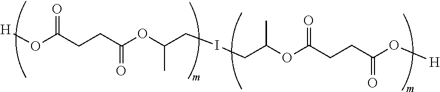

where I is the residue of the initiator used, and each m is a number propylene succinate repeating units. In one or more embodiments, each m is an integer from about 1 to about 70, preferably between 10 and 50, and more preferably between 10 and 30. In some embodiments, each m is an integer from about 1 to about 65, in other embodiments, from about 1 to about 50, in other embodiments, from about 1 to about 40, in other embodiments, from about 1 to about 30, in other embodiments, from about 1 to about 20, in other embodiments, from about 5 to about 70, in other embodiments, from about 15 to about 70, in other embodiments, from about 25 to about 70, in other embodiments, from about 35 to about 70, and in other embodiments, from about 50 to about 70. In some embodiments, each m is an integer from between 10 and 40. In some embodiments, each in is an integer from 10 and 25. In some embodiments, each m is an integer from 10 and 20. In various embodiments, I can be the residue of any of the initiators described above and m can be as described above. As will be apparent, in embodiments where a tri functional or tetra functional initiator is used, the resulting polymer may be linear and may have more than two BA arms extending from the residue of the initiator. In some embodiments, the B block intermediate polymer may be as shown in FIGS. 2-4, 11-17, and 42-47.

In a second reaction, poly(propylene maleate) polymer blocks are added to the ends of the B block intermediate polymer by essentially the same ring opening copolymerization reaction used to form the B block but using maleic anhydride as the cyclic anhydride and the terminal carboxyl groups on the ends of the B block to initiate the reaction. (See, Scheme 1, above). So, in this reaction a second quantity of propylene oxide and maleic anhydride are added to the reaction vessel containing the B block intermediate polymer and the ring opening copolymerization reaction allowed to continue but with a different cyclic anhydride, namely maleic anhydride. In various embodiments, the reaction conditions for the second reaction will be as set forth above with respect to the first reaction, but that need not be the case and the scope of the present invention includes embodiments where the reaction conditions for the first and second reactions are different. For example, the reaction vessel is preferably again heated in the second reaction as set forth above for the first reaction. Preferably, the catalyst and reaction solvent present in the reaction vessel from the first reaction are again used for the second reaction without supplementation, although that need not be the case. Depending upon the type and quantity of catalyst used, it may be necessary to add additional catalyst in the second reaction, but this is not ordinarily required. Similarly, it is not ordinarily necessary to add additional reaction solvent to the vessel for the second reaction, but additional quantities of reaction solvent(s) may be added if deemed necessary or advisable. In these embodiments, the additional quantities of catalyst and/or reaction solvents added for the second reaction are preferably the same catalyst and/or reaction solvent(s) that were used in the first reaction, but again that need not be the case. However, as it is would be extraordinarily difficult to remove the catalyst and/or reaction solvent(s) used in the first reaction without stopping the first reaction, whatever catalysts and/or solvents to be added for the second reaction should be compatible with the catalysts and/or solvents that were used for the first reaction.

In various embodiments, the catalyst for the second reaction will be MgEt₂ or Mg(BHT)₂(THF)₂, but Mg(BHT)₂(THF)₂ is preferred. Mg(BHT)₂(THF)₂. In one or more embodiments, the reaction solvent for the second reaction any of the solvent(s) set forth above with respect to the first reaction. In one or more embodiments, the reaction solvent for the second reaction will be toluene, hexane, heptane CH₂Cl₂, CCl₃, CCl₄, or a combination thereof. In some embodiments, the reaction solvent for the second reaction is toluene.

The molar ratio of maleic anhydride to propylene oxide added to the reaction vessel for the second reaction is preferably about 1:1. In some embodiments, however, a slight excess of propylene oxide can be used to increase the conversion of the maleic anhydride.

As can be seen in Scheme 1, both ends of the B block intermediate polymer have terminal carboxyl groups capable of initiating additional ring opening polymerization of the maleic anhydride and propylene oxide to form propylene maleate repeating units. The second reaction is allowed to proceed until substantially all (>99%) of the maleic anhydride has reacted. The polymer mixture is then quenched according to known methods and precipitated into a non-solvent to produce an ABA triblock copolymer intermediate having two poly(propylene maleate) A blocks. In some embodiments, the second reaction is quenched in chloroform and precipitated twice from hexanes. In the embodiments shown in Scheme 1, the selected anhydride is succinic anhydride, and the resulting ABA triblock copolymer intermediate is a poly(propylene maleate-b-propylene succinate-b-propylene maleate) ABA triblock copolymer haying the formula:

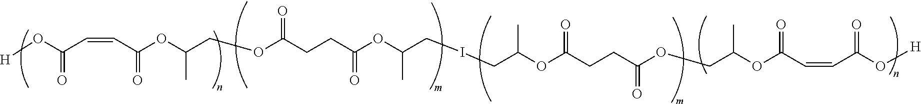

where each n is an integer from about 1 to about 20, each in is an integer from about 2 to about 70, and I is the residue of an initiator having at least two reactive hydroxyl, thiol or carboxylic acid groups, as set forth above. In some embodiments, I is the residue of an initiator selected from fumaric acid (FmA), succinic acid, 1,4-cyclohexanedicarboxylic acid (CHDA), cyclohexane dimethanol (CHDM), benzene dimethanol (BDM), cis-butane-2-diol (cis-BD), butyn-2-diol (2BD), 1,4-butanediol, 1,5-pentanediol, 1,6-hexanediol (HD), 1,8-octanediol, 1,10-decanediol, 1,12-dodecandiol (DD), and combinations thereof.

In some embodiments, each n is an integer from about 1 to about 18, preferably an integer from about 1 to about 10, and more preferably an integer from about 1 to about 5 In some embodiments, each n is an integer from about 1 to about 15, in other embodiments, from about 3 to about 20, in other embodiments, from about 5 to about 20, in other embodiments, from about 8 to about 20, in other embodiments, from about 10 to about 20, in other embodiments, from about 12 to about 20, in other embodiments, from about 15 to about 20, and in other embodiments, from about 18 to about 20. In some embodiments, each n is 3. In some embodiments, each n is 5.

In some embodiments, each m is an integer from about 1 to about 70, preferably between 10 and 50, and more preferably between 10 and 30. In some embodiments, each m is an integer from about 1 to about 65, in other embodiments, from about 1 to about 50, in other embodiments, from about 1 to about 40, in other embodiments, from about 1 to about 30, in other embodiments, from about 1 to about 20, in other embodiments, from about 5 to about 70, in other embodiments, from about 15 to about 70, in other embodiments, from about 25 to about 70, in other embodiments, from about 35 to about 70, and in other embodiments, from about 50 to about 70. In some embodiments, each m is an integer from between 10 and 40. In some embodiments, each m is an integer from 10 and 25. In some embodiments, each m is an integer from 10 and 20. In some embodiments, the ABA triblock copolymer intermediate may be as shown in FIGS. 5-7, 18-24, 45-47.

Finally, in a third reaction, the ABA triblock copolymer intermediate described above is isomerized with an organic base to form the corresponding fumarate polymer. In various embodiments, the poly(propylene maleate) A blocks of the ABA triblock copolymer intermediate may be isomerized using the methods set forth in U.S. Pat. No. 10,465,044 and U.S. Published Application Nos. 2019/0359766, 2020/0231760, 2020/0230286, 2021/0371645, 2021/0284791, 2022/0041804, and 20210316038, the disclosures of which are incorporated herein by reference in their entirety. In some embodiments, the poly(propylene maleate) A blocks of the ABA triblock copolymer intermediate may be isomerized as shown in the Examples, below.

In various embodiments, the ABA triblock copolymer intermediate described above is dissolved in a suitable solvent and the organic base added to the solution. The solvent used to dissolve the ABA triblock copolymer intermediate is not particularly limited. Suitable solvents for this purpose are not particularly limited provided that the reaction proceeds and may include, without limitation, chloroform, dichloromethane, or a combination thereof. In some embodiments, the solvent used to dissolve the ABA triblock copolymer intermediate will be chloroform, dichloromethane, or a combination thereof. In some embodiments, the solvent will be chloroform.

Next, a quantity of an organic base is added to the ABA triblock copolymer intermediate solution, and it is heated to reflux temperature under an inert atmosphere to refluxed until the ABA triblock copolymer intermediate is completely isomerized to produce the ABA triblock copolymer of the present invention. In one or more embodiments, the organic base used to isomerize the ABA triblock copolymer intermediate will be diethylamine (HNEt₂), trimethylamine, pyridine, or a combination thereof. In some of these embodiments, the organic base will be diethylamine (HNEt₂).

In one or more embodiments, the solution is heated it to a reflux temperature under an inert atmosphere for from about 1 to about 48 hours (or until substantially all of ABA triblock copolymer intermediate has isomerized) to produce the poly(propylene fumarate-co-succinate) copolymer of the present invention. In some embodiments, the solution is refluxed for from about 1 hours to about 36 hours, in other embodiments, from about 1 hours to about 30 hours, in other embodiments, from about 1 hours to about 24 hours, in other embodiments, from about 6 hours to about 48 hours, in other embodiments, from about 12 hours to about 48 hours, in other embodiments, from about 18 hours to about 48 hours, in other embodiments, from about 24 hours to about 48 hours, and in other embodiments, from about 36 hours to about 48 hours to produce the ABA triblock copolymer of the present invention. In the embodiment shown in Scheme 1 above, the ABA triblock copolymer intermediate is dissolved in chloroform, combined with diethylamine and refluxed under an inert atmosphere at a temperature of 65° C. for 18 hours.

While the isomerization of the A blocks of the ABA triblock copolymer intermediate does result in sonic other changes to the polymer, it should be understood that most general characteristics of the ABA triblock copolymer of the present invention, such as the approximate M̅ₙ̅, Ðₘ, and T_{g} ranges, are determined in the initial ROCOP reaction and do not change during the isomerization reaction.

In the embodiments, shown in Scheme 1, above, the polypropylene maleate-b-propylene succinate-b-propylene maleate) ABA triblock copolymer is isomerized to form a corresponding poly(propylene fumarate-b-propylene succinate-b-propylene fumarate) ABA triblock copolymer having the formula:

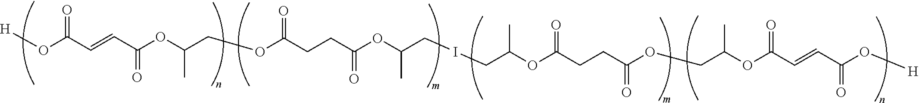

where each n, m, and I are as set forth above. In one or more of these embodiments, the mole ratio of maleic anhydride to succinic anhydride is from about 0.025 to about 15, preferably from about 0.05 to about 10, and more preferably from about 0.1 to about 2.

Once isomerization is complete, the ABA triblock copolymer may be recovered and purified using conventional methods known to those of skill in the art for this purpose. In some embodiments, the organic layer is washed with an aqueous monosodium phosphate solution and the polymer was recovered after drying under vacuum overnight (45° C., 10 mTorr). One of ordinary skill in the art will be able to recover and purify the ABA triblock copolymer produced without undue experimentation.

In one or more embodiments, the present invention is directed to a method for making a poly(propylene fumarate-b-propylene succinate-b-propylene fumarate) ABA triblock copolymer as described above comprising the steps of: reacting succinic anhydride, a first quantity of propylene oxide, an initiator selected from the group consisting of selected from the group consisting of fumaric acid (FmA), succinic acid, 1,4-cyclohexanedicarboxylic acid (CHDA), cyclohexane dimethanol (CHDM), benzene dimethanol (BDM), cis-butane-2-diol (cis-BD), butyl-2-diol (BYD), 1,4-butanediol, 1,5-pentanediol, 1,6-hexanediol (HD), 1,8-octanediol, 1,10-decanediol, 1,12-dodecandiol (DD), or a combination thereof and Mg(BHT)₂(THF)₂ catalyst to form a poly(propylene succinate) polymer B block having a reactive first and second end; reacting the poly(propylene succinate) polymer B block with maleic anhydride, a second quantity of propylene oxide, and a catalyst to form a first and second poly(propylene maleate) polymer A blocks covalently bonded to the first and second ends of the poly(propylene succinate) B polymer block to form a poly(propylene maleate-b-propylene succinate-b-propylene maleate) ABA triblock copolymer intermediate; and isomerizing the poly(propylene maleate-b-propylene succinate-b-propylene maleate) ABA block copolymer to form a poly(propylene fumarate-b-propylene succinate-b-propylene fumarate) ABA triblock copolymer.

In a third aspect, the present invention is directed to a 3D printable polymer resin comprising the ABA triblock copolymer described above. In one or more embodiments, the 3D printable polymer resin of the present invention comprises an ABA triblock copolymer, as set forth above, having two crosslinkable poly(propylene fumarate) A blocks and at least one multi-thiol crosslinker having at least two reactive thiol groups. In one or more of these embodiments, the 3D printable polymer resin of the present invention will comprise a poly(propylene fumarate-b-propylene succinate-b-propylene fumarate) ABA triblock copolymer and at least one multi-thiol crosslinker having at least two reactive thiol groups. In various embodiments, the multi-thiol crosslinker will have from 2 to 5 reactive thiol groups. In some embodiments, the multi-thiol crosslinker will have from 2 reactive thiol groups. In other embodiments, the multi-thiol crosslinker will have from 3 reactive thiol groups. In some embodiments, the 3D printable polymer resin may contain two or more different multi-thiol crosslinkers. Suitable multi-thiol crosslinkers may include, without limitation, ethylene glycol bis-mercaptoacetate, 3,6-dioxa-1,8-octanedithiol, pentaerythritol tetrakis (3-mercaptopropionate), trirnethylolpropane tris(3-mercaptopropionate), 2,2′-thiodiethanethiol, ethyleneglycol dithiol, tetra(ethylene glycol) dithiol, hexa(ethylene glycol) dithiol, poly(ethylene glycol) dithiol, 1,6-hexanedithiol, 1,8-oxtanedithiol, 1,9-nonanedithiol, 1,11-undecanedithol, 1,16-hexandecanedithiol, and combinations thereof.

In various embodiments, the 3D printable polymer resin will also include an organic solvent for the ABA triblock copolymer to manage the viscosity of the polymer for 3D printing, as well as a photoinitiator to facilitate crosslinking the polymer during the printing process. The choice of organic solvent is not particularly limited provided, of course, that it does not react with or damage the ABA triblock copolymer or crosslinker being used. One of ordinary skill in the art will be able to select a suitable organic solvent without undue experimentation. Suitable solvents may include, without limitation, ethyl acetate, THF, acetone, DMSO, chloroform, methanol, ethanol, diethyl fumarate (DEF) and combinations thereof.

As set forth above, the 3D printable polymer resin will also include one or more photoinitiator to facilitate crosslinking the polymer during the 3D printing process. The photoinitiator is not particularly limited but must be capable of generating radicles at the wavelengths of light used by the 3D-printing device (ordinarily 254-450 nm) being used, be soluble in the resin being used, and be compatible with the both the 3D printed PPF matrix and its component parts at the concentrations to be used. As will be appreciated by those of skill in the art, the choice of photoinitiator is often dictated by the requirements of the 3D printer being used. Suitable photoinitators may include, without limitation, phenylbis(2,4,6-trimethylbenzoyl)phosphine oxide (BAPO), IRGACURE™ 819/BAPO (BASF, Florham Park, NJ), IRGACURE™ M 784 (BASF, Florham Park, NJ), IRGACURE™ 2959 (BASF, Florham Park, NJ), and combinations thereof.

In some embodiments, the 3D printable polymer resin of the present invention will have a ratio of fumarate groups in the ABA triblock copolymer to reactive thiol groups on the multi-thiol crosslinker of from about 50 to about 1, in other embodiments, from about 30 to about 1, in other embodiments, from about 20 to about 1, in other embodiments, from about 10 to about 1, in other embodiments, from about 5 to about 1, and in other embodiments, from about 2 to about 1.

In some embodiments, the 3D printable polymer resin of the present invention may also include additives commonly used in 3D printable resins including, but not limited to, such things as dyes, light attenuating agents, radical scavengers, dispersants, emulsifiers, and other additives. The dyes that may be used in the 3-D printable resin of embodiments of the present invention are not particularly limited and may be any dye conventionally used in 3D printing, provided that it does not quench the radicals necessary for crosslinking. The light attenuating agents that may be used in the 3-D printable resin of embodiments of the present invention are not particularly limited and may include, without limitation, oxybenzone (2-Hydroxy-4-methoxybenzophenone) (Sigma-Aldrich). The emulsifiers that may be used in the 3-D printable resin of embodiments of the present invention are not particularly limited and may include, without limitation, sucrose, threhalose, or any sugar molecule. In various embodiments, the 3-D printable resin of embodiments of the present invention may include one or more other additives to support and/or promote tissue growth. These additives are not particularly limited provided that they do not quench the radicals needed for crosslinking of the 3-D printable resin. In various embodiments, the 3-D printable resin may contain additives such as, decellularized tissue, collagen, ceramics, BIOGLASS™, hydroxyapatite, β-tricalcium phosphate, and combinations thereof.

In yet another aspect, the present invention is directed to a method for making the 3D printable polymer resin described above. To make the resin, the ABA triblock co-polymer described above is first dissolved in a suitable solvent until the resulting solution has a complex viscosity of from about 0.001 Pa·sec to about 10 Pa·sec, as measured by shear rheology. The suitable solvent may be as described above, and may include, without limitation, ethyl acetate, THF, acetone, DMSO, chloroform, methanol, ethanol, diethyl fumarate (DEF) and combinations thereof. The multi-thiol crosslinker or crosslinkers and photoinitiator are then added to form the resin. Any desired, additives (i.e., dyes, light attenuating agents, radical scavengers, dispersants, emulsifiers, and other additives) may be added to the resin at any point before the resin is crosslinking during printing. The final resin must have a complex viscosity within the specifications of the specific 3D printer being used. Accordingly, it may be necessary in some embodiments to add additional solvent to obtain the recommended viscosity for the particular 3D printer being used.

In yet another aspect, the present invention is directed to the 3D printed polymer structures formed using the 3D printable ABA block copolymers and polymer resins described above. In various embodiments, the 3D printable polymer resins of the present invention may be printed using conventional additive manufacturing (3D printing) techniques, such as stereolithography, continuous digital light processing (cDLP) continuous liquid interface production (CLIP), or computed axial lithography (CAL), techniques and photocrosslinked to form 3D printed structures having virtually any shape. As will be understood by those of ordinary skill in the art, the light used by the 3D printer acting with the photoinitiators in the 3D printable resin described above, catalyzes thiolene bonding between the alkene bonds of the PPF residues in the A blocks of the ABA block copolymers and the thiol functional groups of the multi-thiol functionalized crosslinkers to crosslink and harden the resin into the desired 3D printed shape.

The size and shape of the 3D printed polymer structures of the present invention is only limited by the requirements and limitations of the 3D printers and related 3D modeling software being used. Any suitable light-based 3D printer may be used. Suitable 3-D printers may include, without limitation, Carbon3D printers (CARBON3D™, Redwood City, CA), PERFACTORY™ P3 3D printer (EnvisionTEC, Dearborn, MI), Micro HR 279 printer EnvisionTEC (Dearborn, MI, USA), photocentric stereolithographic or photochemical 3D printers. As will be apparent, these 3D printed polymer structures will comprise the ABA triblock co-polymers described above crosslinked with one or more of the multi-thiol crosslinkers described above. In one or more of these embodiments, the 3D printed polymer structure will comprise the residue of at least one multi-thiol crosslinker has from 2 to 5 reactive thiol groups. In various embodiments, the mechanical properties of the 3D printed polymer structures may be tuned by varying the type and amount of crosslinker used in the resin to be printed.

In various embodiments, the 3D printed polymer structures may be formed by first generating a set of instructions for 3-D printing a desired structure and sending those instructions to a suitable 3-D printer. In some of these embodiments, the set of instructions may comprise a computer assisted design (CAD) file generated using suitable computer software that are readable by the 3D printer to be used. In some embodiments, the design files may be created using SolidWorks software (Dassault Systems SolidWorks Corp., Waltham, MA). In some embodiments, the CAD models were sliced digitally into layers using the Perfactory software suite prior to manufacturing. The Perfactory P3 is an inverted system that projects upward through a transparent glass plate into a reservoir containing the resin. In one or more embodiments, the CAD or other computer file containing instructions for printing the star PPF printed structure may be generated as set forth in U.S. Pat. Nos. 6,849,223, 7,702,380, 7,747,305, 8,781,557, 9,208,558, 9,275,191, 9,292,920, 9,330,206, 9,626,756, 9,672,302, 9,672,617, and 9,688,023, the disclosures of which are incorporated herein by reference in their entirety.

As set forth above, because the ABA triblock copolymers of the present invention contain a more flexible and less stiff B block, they are less viscous than comparable PPF polymers of comparable size. Advantageously, the ABA triblock copolymers of the present invention require less solvent to achieve printing viscosity than to resins made from comparable PPF polymers. Other advantageous physical properties of the ABA triblock copolymers and resins of the present invention are outlined in the experimental section to follow.

### Experimental

To assess the feasibility of synthesizing triblock copolymers from sequential injections of different anhydride monomers, a copolymer containing a degree of polymerization (DP) 20 poly(propylene succinate) (PPSu) core with DP5 poly(propylene fumarate) (PPF) blocks was generated as shown in Scheme 1, below. 3D printed constructs were prepared through CLIP using thiol-ene chemistry, and the mechanical and degradation properties of 3D printed products were examined. Saturated succinic anhydride (SA) was chosen as a core unit monomer due to its faster ROCOP reactivity compared to other anhydrides, ability to copolymerize with propylene oxide, degradability under hydrolytic conditions, and readily metabolizing of degradation products.

In a first step, the PPSu core (DP20) was prepared by the ROCOP of succinic anhydride (SA) and propylene oxide (PO) using fumaric acid (FmA) as a bifunctional initiator and Mg(BHT)₂(THF)₂ as a catalyst at 80° C. Upon full consumption of succinic anhydride, as the second step, the PPM blocks (DP5) were added in both directions by the sequential injection of maleic anhydride (MA) and propylene oxide (PO) to synthesize triblock poly(propylene maleate-b-propylene succinate-b-propylene maleate) (PPMPS-5-20-5). The PPM blocks were isomerized using HNEt₂ to form poly(propylene fumarate) (PPF), to form the poly(propylene fumarate-b-propylene succinate-b-propylene fumarate) (PPFPS-5-20-5). In some embodiments, the PPFPS may be synthesized as shown in Scheme 1, above.

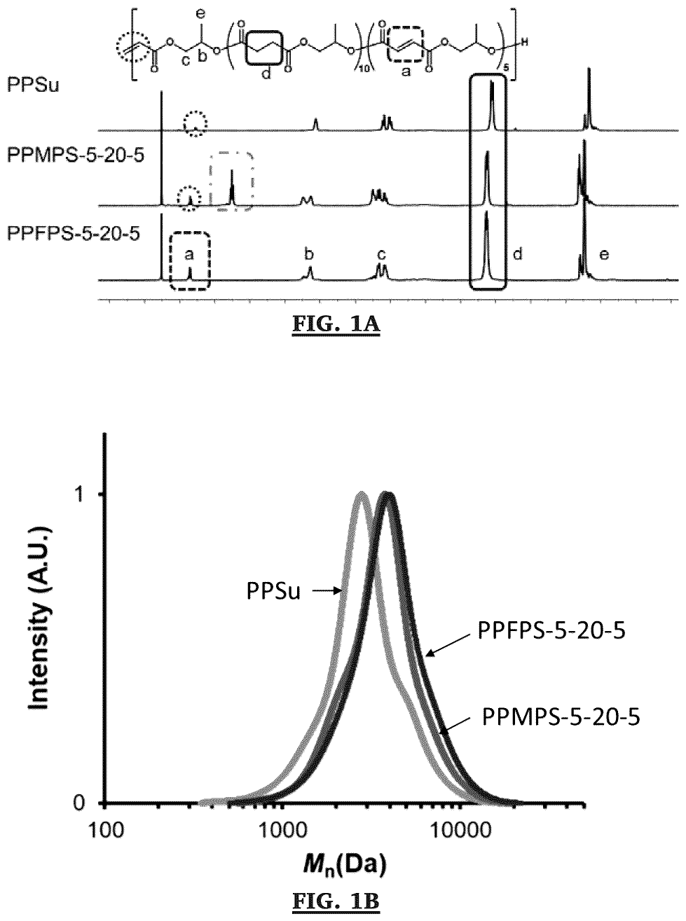

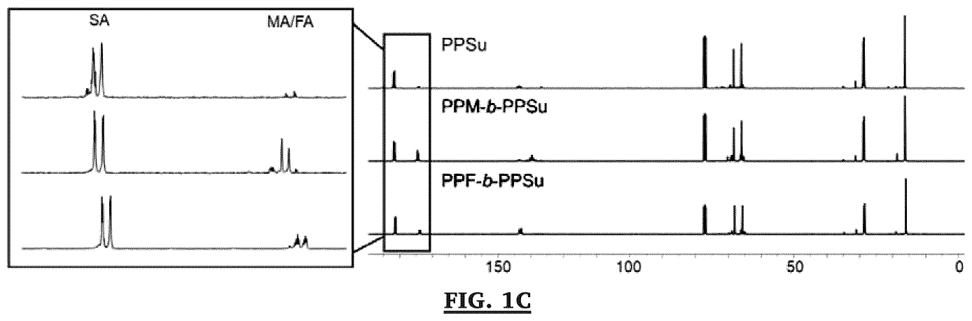

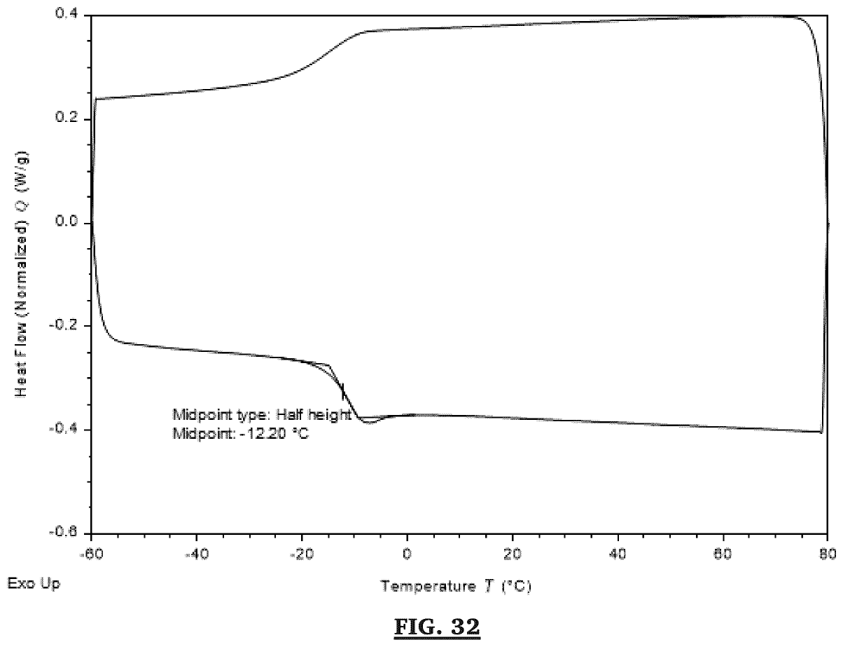

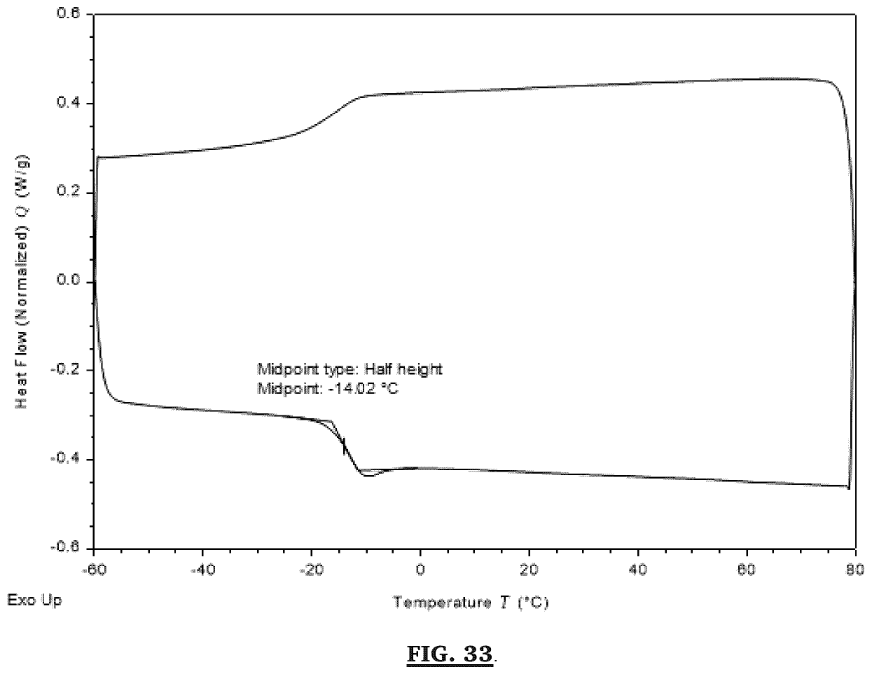

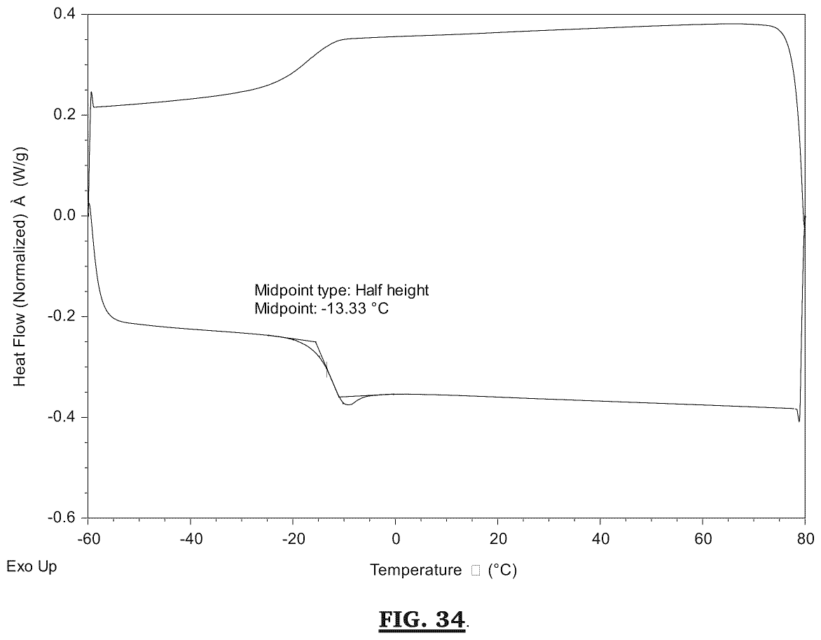

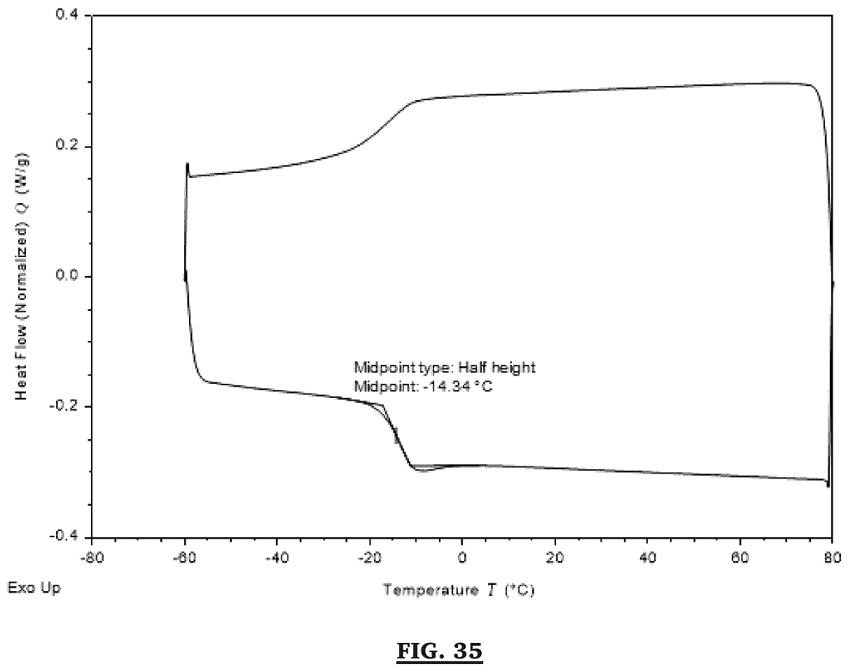

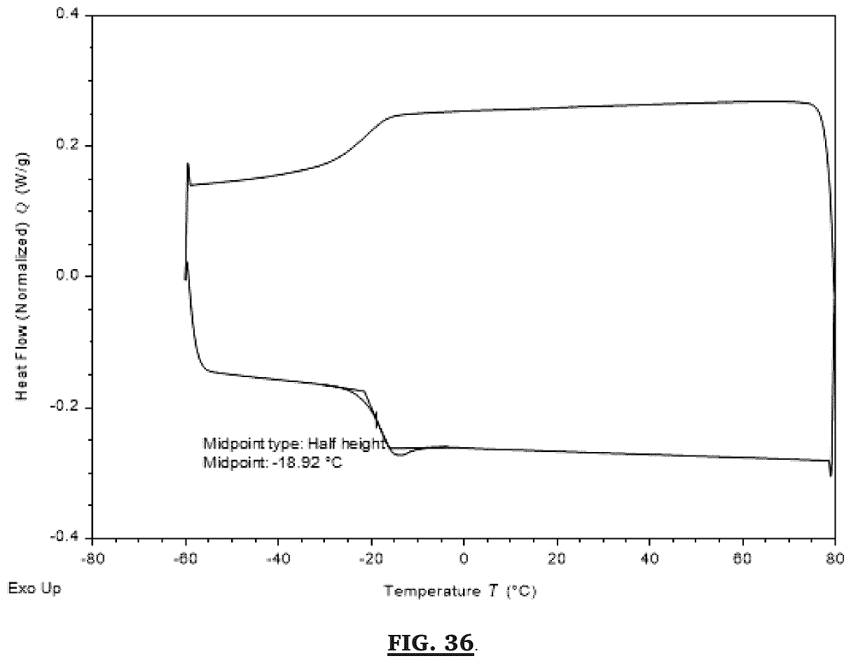

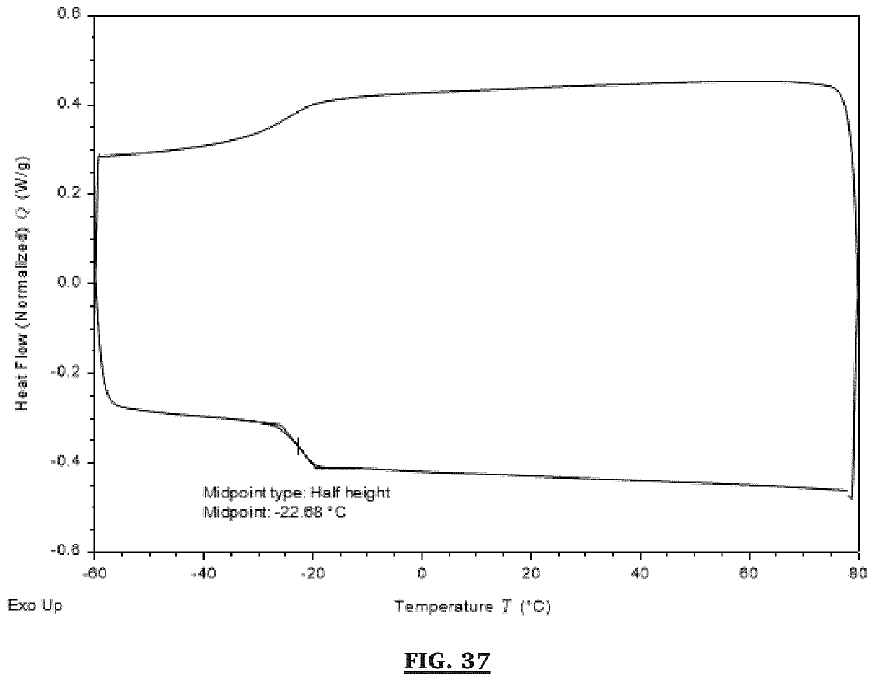

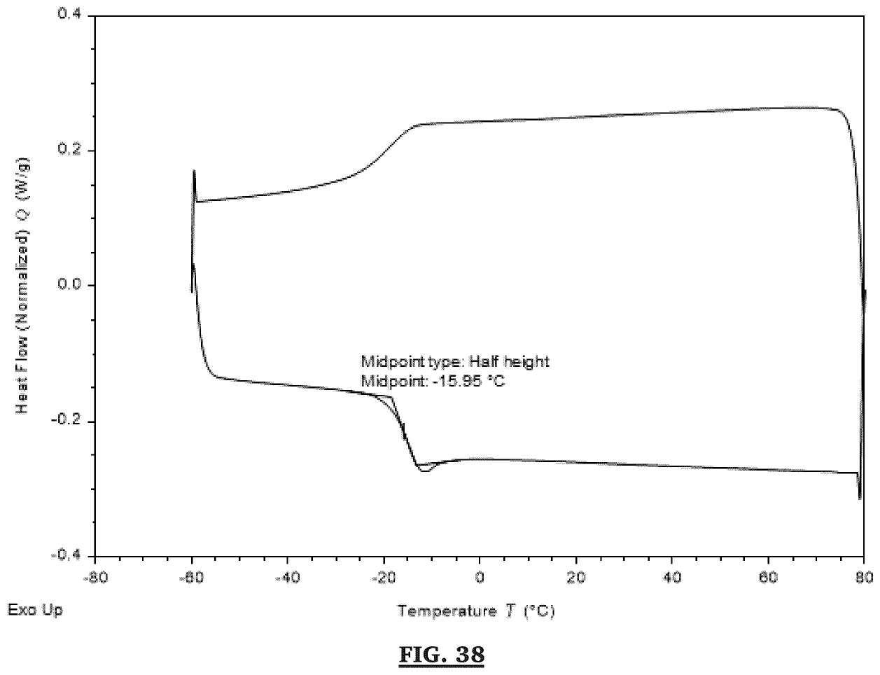

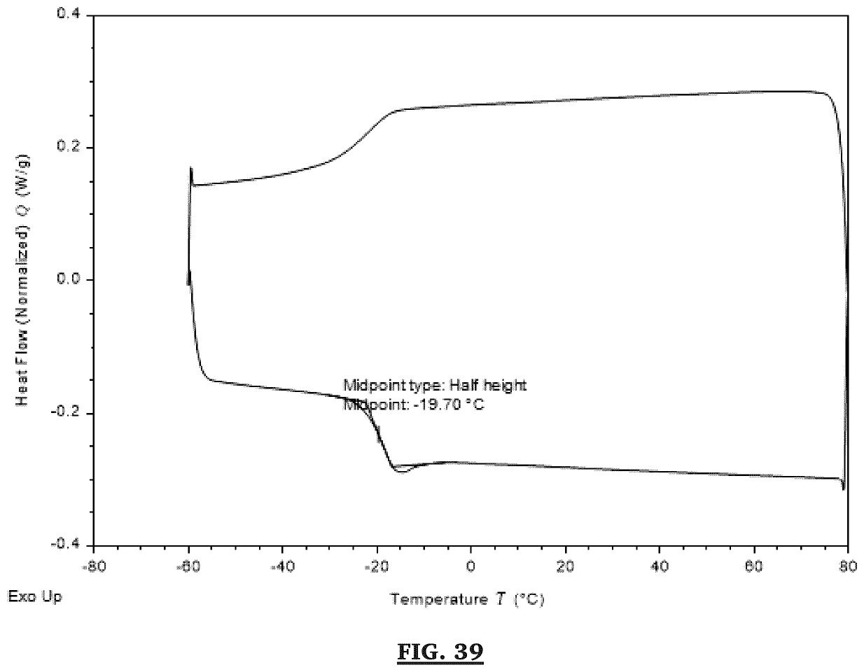

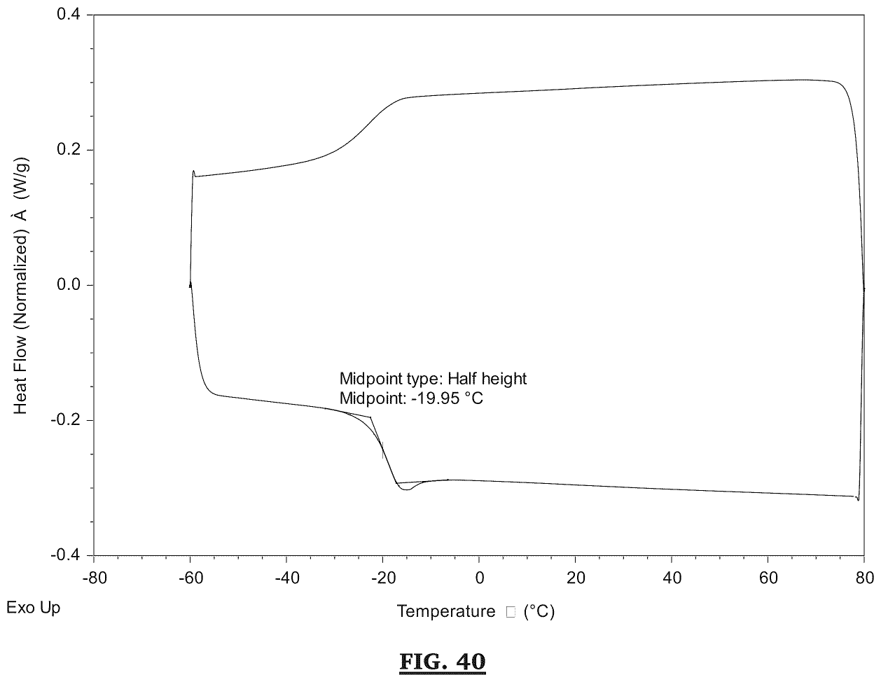

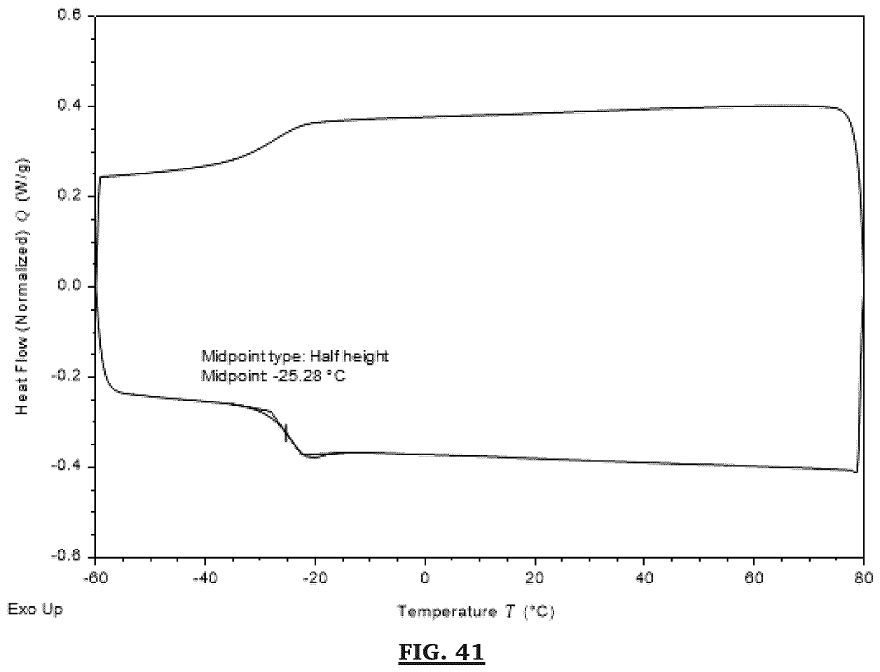

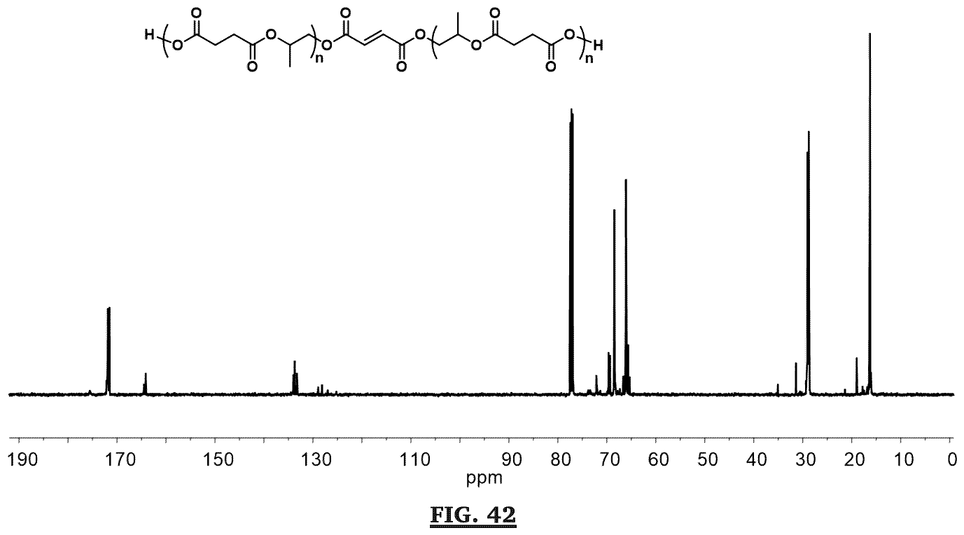

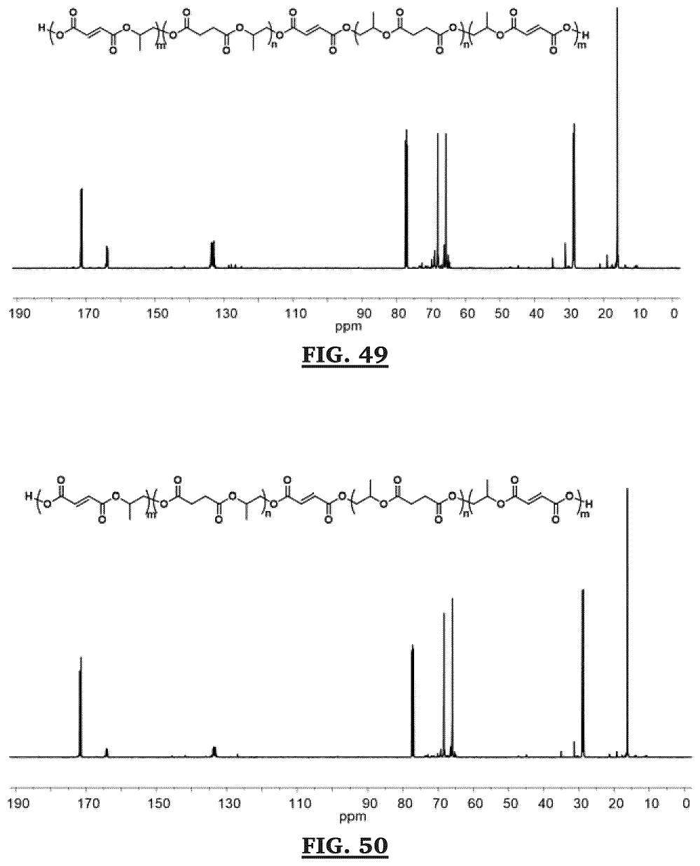

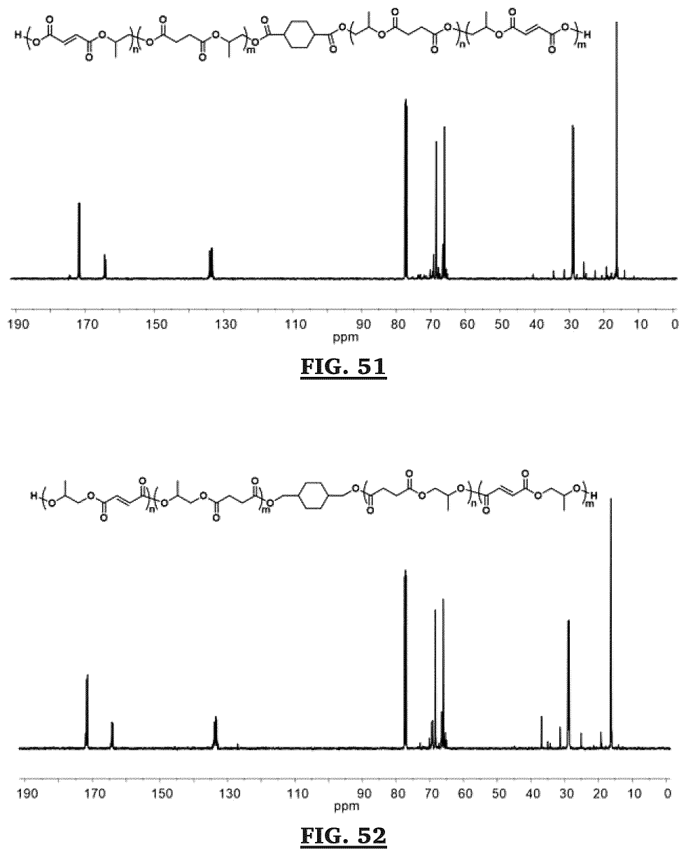

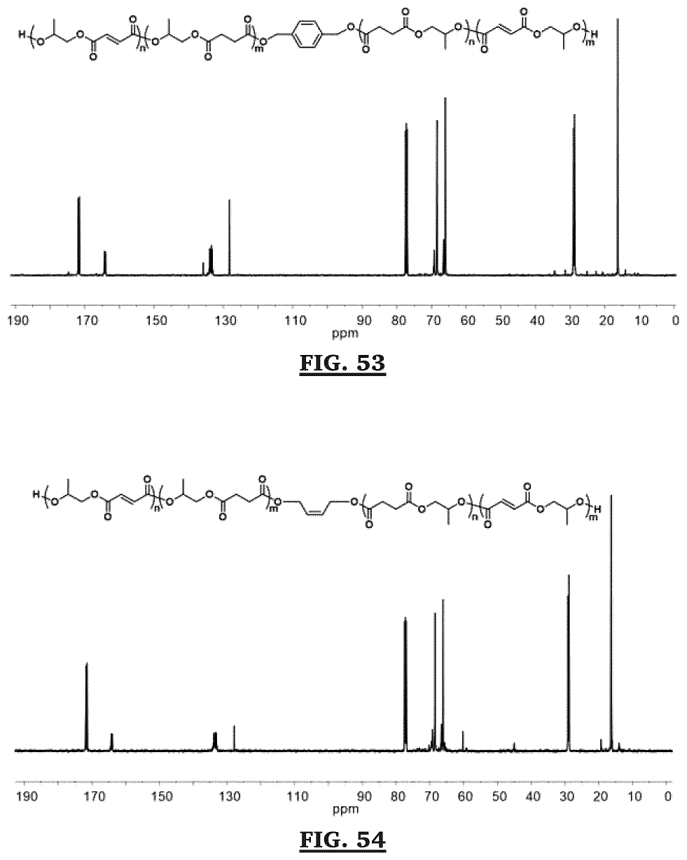

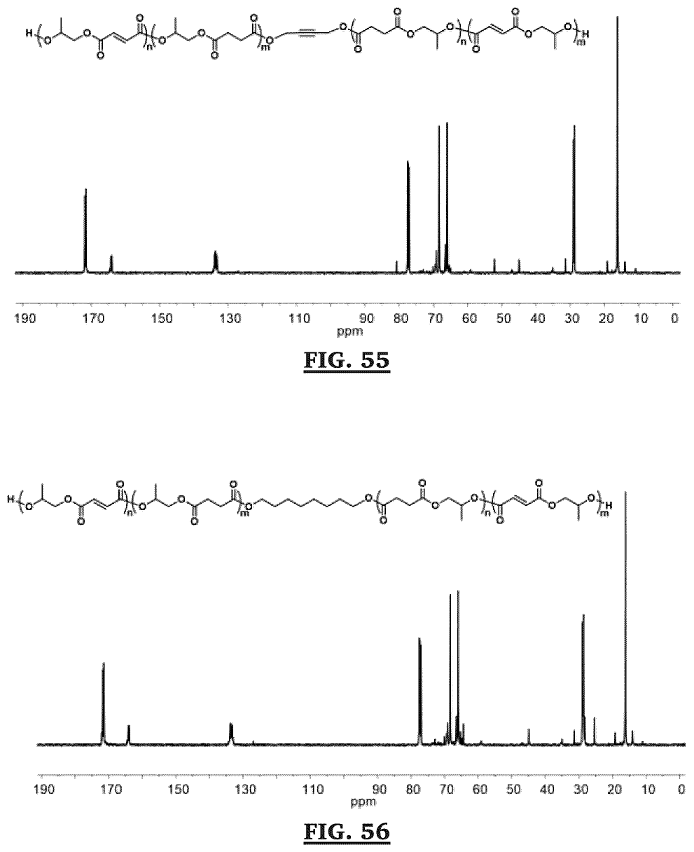

As can be seen in FIGS. 1A-C ¹H NMR spectrum (500 MHz, 303 K, CDCl₃) (FIG. 1A, see also, FIGS. 2-31), SEC (FIG. 1B; see, also FIG. 32-41), and ¹³C NMR spectrum (500 MHz, 303 K, CDCl₃) (FIG. 1C; see also, FIGS. 42-57) were taken of fumaric acid initiated PPSu₂₀ (PPSu), PPMₛ-b-PPSu₂₀-PPM₅ (PPMPS-5-20-5), and PPF₅-b-PPSu₂₀-PPF₅ (PPFPS-5-20-5). The ¹H NMR spectroscopic analysis of PPSu showed proton resonance at δ=2.6 and 6.8 ppm, which corresponds to methylene protons of succinate and alkene protons of fumarate initiator, respectively. After the second step, proton resonance at δ=6.3 ppm. which is attributed to the alkene protons of the maleate unit appeared, The cis-proton resonance disappeared, and trans-proton resonance (δ=6.8 ppm.) became bigger by isomerization of PPMPS to form PPFPS (FIG. 1A). The DP of PPSu and PPMPS was calculated by the ratios of integration from methylene protons from succinate and alkene protons from maleate with alkene protons from the fumarate initiator. Molecular weight distributions of the copolymer of different steps are measured by SEC (FIG. 1B, see also, FIGS. 32-41). The SEC results show that the molecular weight of polymer chains was increased with the addition of maleic anhydride and propylene oxide, while the Molecular Mass distributions remain similar after isomerization.

To confirm the block nature of the triblock copolymer, ¹³C NMR spectroscopy was conducted (FIG. 1C). The magnification of the carbonyl carbon resonance shows distinct resonances from succinate units, the fumaric acid initiator, and maleate units after the addition of PPM segments, which confirms the block nature of the triblock copolymer. After isomerization, the distinct resonance is not changed which indicates that the block nature remained intact during the isomerization.

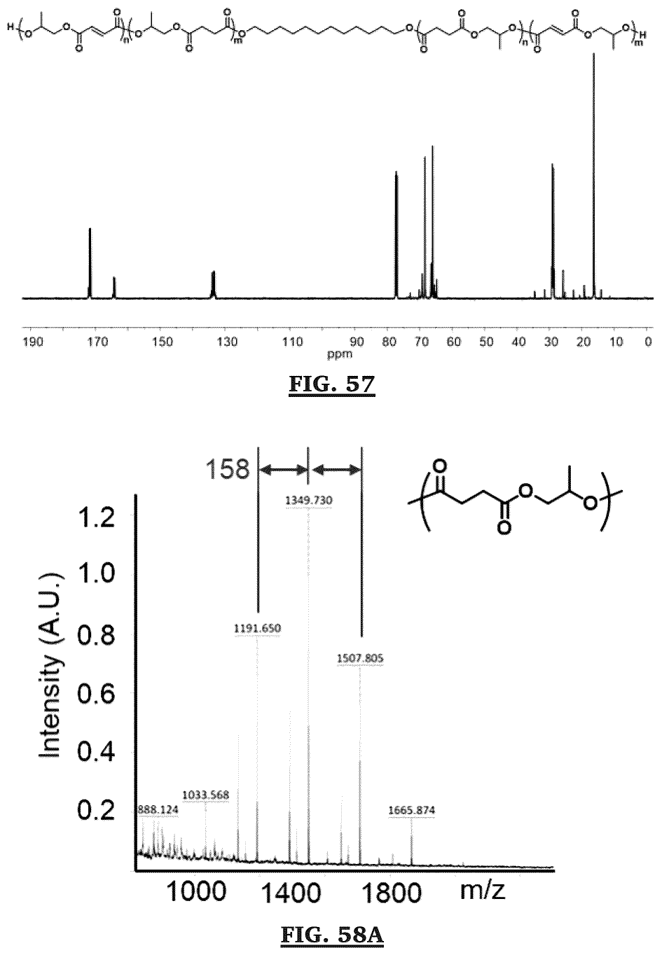

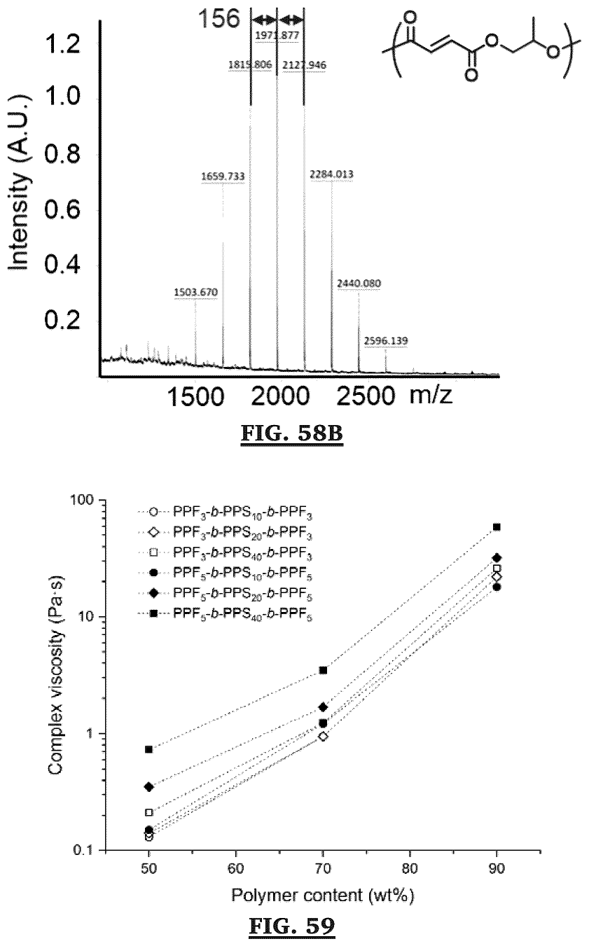

Additionally, the repeat units of the polymer chain of each step were analyzed by MALDI-ToF MS spectroscopy (FIG. 58A-B). FIGS. 58A-B show a MALDI-ToF MS plot of fumaric acid initiated PPSu of DP 10 indicating propylene succinate (M.W 158 Da) is a repeating unit (FIG. 58A) and a MALDI-ToF MS plot of fumaric acid initiated PPM₃-b-PPSu₁₀-b-PPM₃ (PPMPS-3-10-3) indicating propylene maleate (M.W 156 Da) is a repeating unit (FIG. 58B). The molecular weight of the repeat unit of the first step (PPSu) is 158 Da and that of the second step (PPMPS-5-10-5) is 156 Da, which corresponds to the molecular weight of propylene succinate and propylene maleate, respectively. The results were consistent with the expectation that the repeating unit of the polymer chain is changed from propylene succinate to propylene maleate after the addition of maleic anhydride and propylene oxide at the second step, which indicates a propylene maleate unit at each end of the triblock copolymer.

In addition, to better understand the properties of the triblock-copolymers, a series of triblock copolymers were synthesized with a DP 10, 20, and 40 for the propylene succinate core unit and DP 3 and 5 for the propylene maleate unit chain ends. The properties of these PPF-b-PPSu-b-PPF triblock copolymers including their initiators, target DPs, and PPF and PPSu ratios are reported on Table 1, below. The NMR spectra for ABA triblock copolymers listed on Table 1 are attached as FIGS. 8-10 and 25-31 and ¹³C NMR spectra for ABA triblock copolymers listed on Table 1 are attached as FIGS. 48-57. In addition, the thermal properties of these triblock copolymers were analyzed by differential scanning calorimetry (DSC). DSC thermograms for ABA triblock copolymers listed on Table 1 are attached as FIGS. 32-41. The glass transition temperatures (T_{g}) and degradation temperatures (T_{d}) were determined and are also reported on Table 1, below. See also, FIGS. 32-41.

TABLE 1
Properties of PPF-b-PPSu-b-PPF triblock copolymers synthesized using
Mg(BHT)₂(THF)₂ as catalyst with various initiators, target DPs, and PPF and PPSu ratios.

| | | | Conversion | | Composition | | SEC^{b} | | | |
|---|---|---|---|---|---|---|---|---|---|---|
| | | Ratio | (mol %)^{a} | | (mol %)^{a} | | Mₙ | | T_{g} | T_{d} |
| Polymer | Initiator | MA:SA:I | MA | SA | FA | SA | (kDa) | Ð_{M} | (° C.) | (° C.) |
| PPF₃-b-PPSu₁₀-b-PPF₃ | FmA | 6:10:1 | >99 | >99 | 34 | 66 | 3.1 | 1.32 | −15.2 | 337 |
| PPF₅-b-PPSu₁₀-b-PPF₅ | FmA | 10:10:1 | >99 | >99 | 49 | 51 | 3.2 | 1.22 | −12.0 | 333 |
| PPF₃-b-PPSu₂₀-b-PPF₃ | FmA | 6:20:1 | >99 | >99 | 23 | 77 | 3.9 | 1.49 | −11.2 | 341 |
| PPF₅-b-PPSu₂₀-b-PPF₅ | FmA | 10:20:1 | >99 | >99 | 33 | 67 | 3.4 | 1.27 | −12.3 | 343 |
| PPF₃-b-PPSu₄₀-b-PPF₃ | FmA | 6:40:1 | >99 | >99 | 13 | 87 | 3.6 | 1.41 | −17.7 | 347 |
| PPF₅-b-PPSu₄₀-b-PPF₅ | FmA | 10:40:1 | >99 | >99 | 18 | 82 | 4.8 | 1.66 | −10.7 | 339 |
| PPF₅-b-PPSu₂₀-b-PPF₅ | CHDA | 10:20:1 | >99 | >99 | 31 | 69 | 5.0 | 1.50 | −14.3 | 334 |
| PPF₅-b-PPSu₂₀-b-PPF₅ | CHDM | 10:20:1 | >99 | >99 | 34 | 66 | 4.1 | 1.61 | −18.9 | 342 |
| PPF₅-b-PPSu₂₀-b-PPF₅ | BDM | 10:20:1 | >99 | >99 | 29 | 71 | 4.5 | 1.28 | −23.0 | 345 |
| PPF₅-b-PPSu₂₀-b-PPF₅ | cBD | 10:20:1 | >99 | 98 | 28 | 72 | 4.9 | 1.32 | −15.8 | 355 |
| PPF₅-b-PPSu₂₀-b-PPF₅ | BYD | 10:20:1 | >99 | 88 | 28 | 72 | 3.9 | 1.29 | −20.2 | 341 |
| PPF₅-b-PPSu₂₀-b-PPF₅ | HDO | 10:20:1 | >99 | 95 | 27 | 73 | 3.5 | 1.42 | −19.9 | 338 |
| PPF₅-b-PPSu₂₀-b-PPF₅ | DD | 10:20:1 | >99 | >99 | 31 | 69 | 5.4 | 1.38 | −25.0 | 358 |

^{a}Determined by ¹H NMR spectroscopy;
^{b}Determined from SEC in THF eluent against poly(styrene) standards.

As can be seen in Table 1, conversions for both anhydrides were near quantitative (>99%) and the compositions were congruent with the expected DP of each block by ¹H NMR spectroscopy. Using differential scanning calorimetry (DSC), the glass transition temperatures (T_{g}) of all triblock copolymers (≤−10° C.), were lower than the T_{g} of DP 10 PPF (˜−4° C.), indicating lower viscosities of higher :DP triblock copolymers compared to PPF (See, Table 1; FIGS. 32-41) To synthesize enough material for 3D printing, the copolymer syntheses were scaled to 100 g. The feasibility of PPFPS triblock copolymer synthesis with bifunctional initiator was demonstrated by using various diol and diacid initiators for PPFPS-5-20-5 as a model polymer (Table 1, Scheme 1). SEC analysis was then performed, which demonstrated copolymers in the expected molecular mass range as well as relatively low molecular mass distributions (D_{M}<1.42) in all copolymers except those initiated by cyclic acids and alcohols. More importantly, T_{g}s are lower than that of fumaric acid initiated triblock copolymer and below −41° C., which indicates low viscosities of the copolymers. Finally, thermogravimetric analysis (TGA) was performed to assess the decomposition temperatures of the copolymers. The thermal stability of these copolymers was shown by decomposition temperatures of around 340° C.

As set forth above the versatility of the various potential initiators is an important advantage of the present invention. In some embodiments, because a relatively high proportion of the low molecular weight ABA triblock copolymer is the initiator residue, the initiator can significantly impact the copolymer's properties, as well as the 3D printed product. In some embodiments, orthogonal reactions, such as azide-alkyne click reaction in the case of butynediol, may be utilized to enable the post-polymerization modification of the ABA triblock copolymer to endow additional functionality before or after 3D printing. In cases where fumaric acid (FmA) is the initiator, the initiator residue will contain alkene group capable of crosslinking in the same way as the PPF A blocks discussed below. To further study the effect of the initiators, copolymers were synthesized up to 100 g scale with a FmA initiator.

Further, to determine an appropriate composition for CLIP processable resin formulations, complex viscosity was measured at various polymer compositions in ethyl acetate (EA) solvent. (See FIG. 59) There is no clear limitation of the viscosity of 3D printing resin, but it is typically believed that 10 Pa·s is the upper limit to circumvent capillary forces delamination during 3D printing at high viscosity. In the vat 3D printing process, active diluents or inert solvents are used to reduce the viscosity of the polymer formulations. Here, EA was used as an inert solvent because of the good solubility for PPF, ease of removal and relatively low toxicity compared to other solvents. Furthermore, while the low boiling point of EA might lead to resin formulation changes during the printing process, the rapid nature of thiol-ene chemistry allowed for prints to be completed before significant solvent would evaporate. As the amount of polymer in resin composition and DP of polymer increases, the viscosity of the resin increases and copolymers with propylene fumarate units of DP 5 have higher viscosities than those with DP 3 propylene fumarate unit. However, the viscosity is lower than 10 Pa·s in a wide range of polymer contents, so the 3D printing would be possible with more than 70 wt. % of polymer contents in resin formulations for most of the triblock copolymers. Thus, 70 wt. % of polymer content in resin formulation were chosen for further study because the viscosities were below the theoretical viscosity limit and low enough to get a product with a suitable resolution.

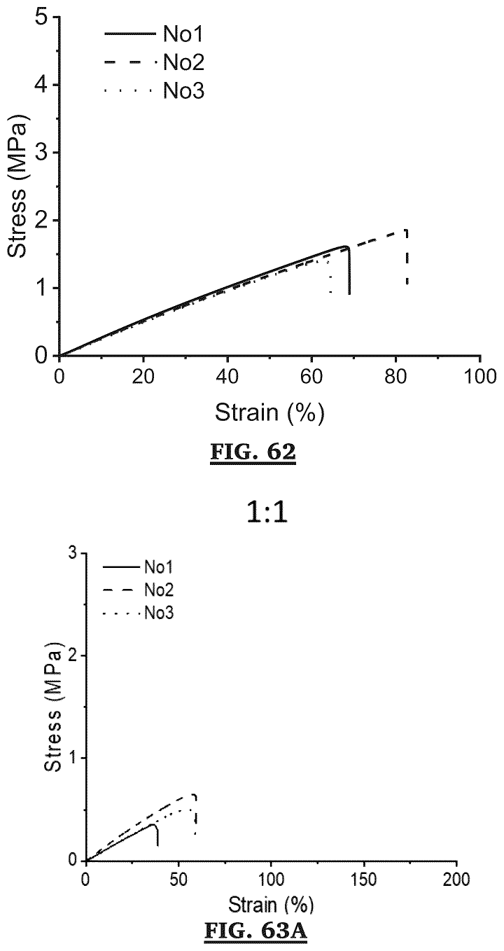

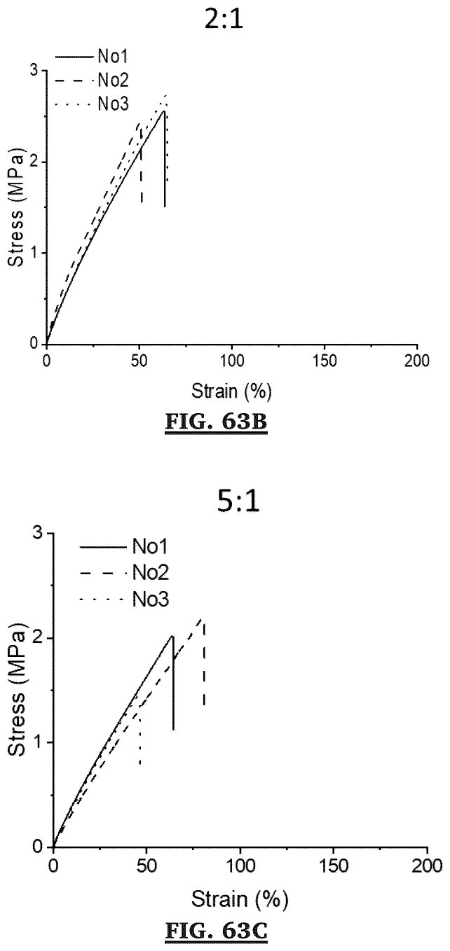

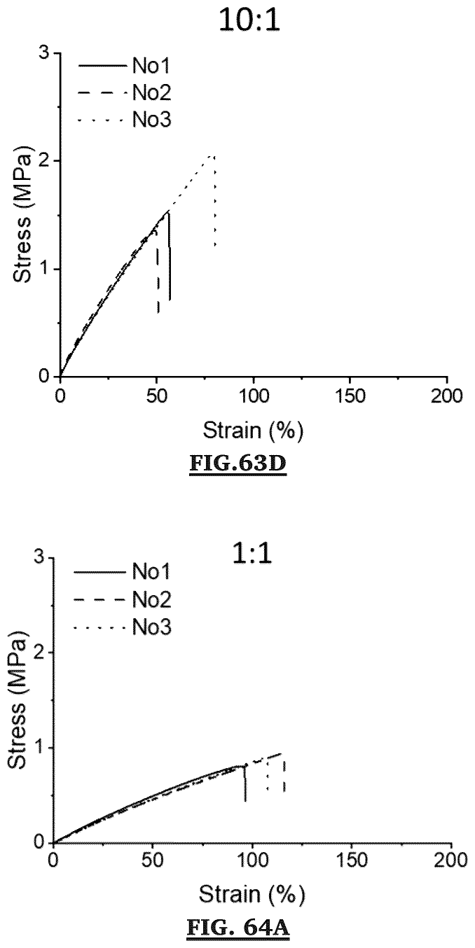

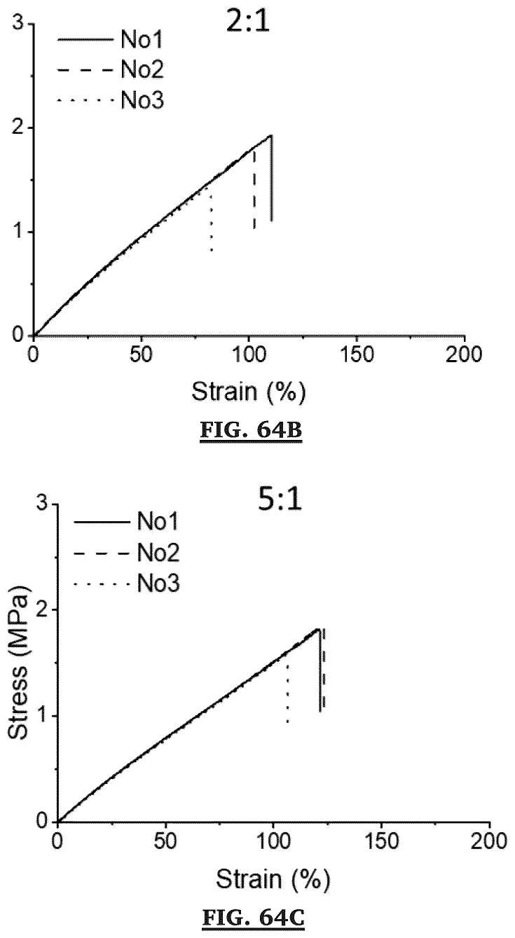

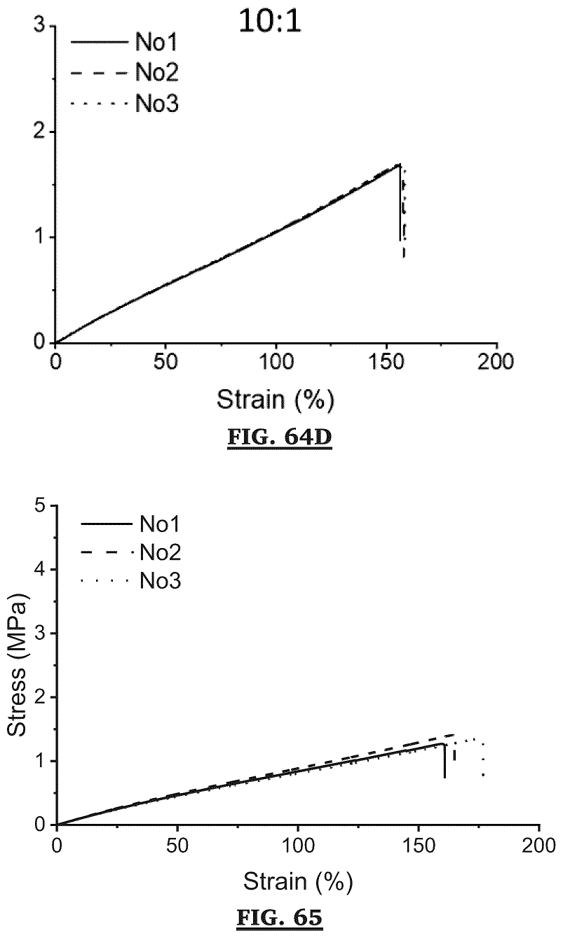

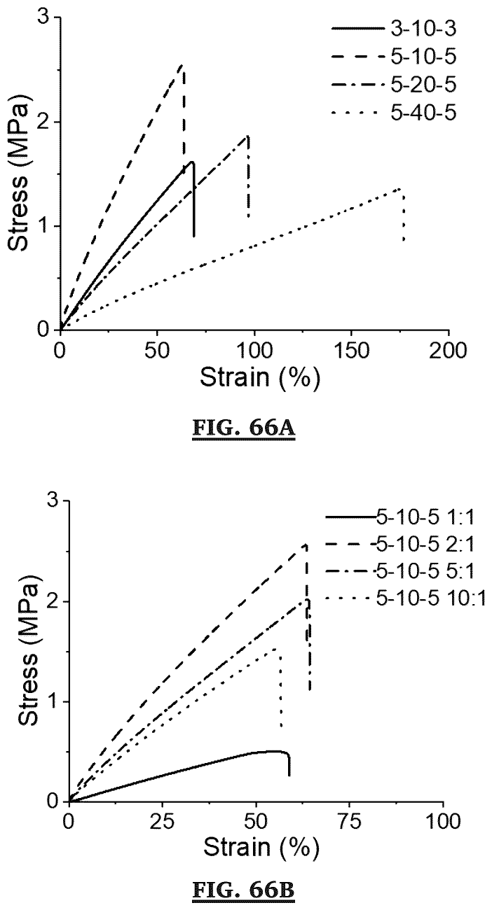

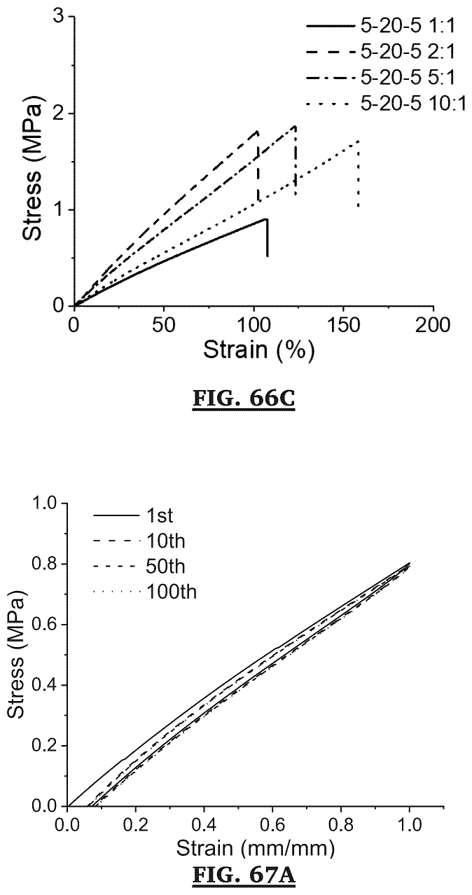

The 3D printing of tensile bars, solid discs, and rectangular bars with triblock copolymers was successfully conducted using a Carbon model 2 printer (FIG. 61). Following washing and post-curing, the solvent was removed from the 3D printed product under vacuum at 40° C. for 2 days which resulted in the isotropic shrinkage of the products (FIG. 62). The mechanical properties of the printed products were measured by uniaxial tensile testing (see FIGS. 62, 63A-D, 64A-D and 65), and the effects of polymer composition and PPF alkene to thiol ratio on mechanical properties were examined (FIGS. 66A-C and Table 2). The stress-strain curves for the ABA triblock copolymers on Table 2 are attached as FIGS. 62, 63A-D, 64A-D and 65. The Young's modulus (E₀) and the elongation at break (ε_{break}) of PPFPS-5-10-5 at PPF to thiol ratio of 2:1 were 5.97±1.23 MPa and 59%, respectively. These values are changed to 2.10±0.02 MPa, 98%, and 1.00±0.04 MPa, 167% for PPFPS-5-20-5 and PPFPS-5-40-5, respectively. The decrease of E₀ and the increase of ε_{break} are attributed to the increasing of crosslinking density and the trend can be seen in FIG. 66A. The effect of PPF to thiol ratio was measured with PPFPS-5-10-5 and PPFPS-5-20-5 (FIG. 66B-C and Table 2). For both polymers, 2:1 of PPF to thiol ratio showed the highest E₀ and deviation from this ratio resulted in lower E₀ values, while the 1:1 ratio presented the lowest E₀ among the formulations. However, the ε_{break} values trended with the polymer composition 60% for PPFPS-5-10-5, ˜120% for PPFPS-5-20-5). This indicates that the 2:1 ratio has higher crosslinking density along with PPF units in the polymer chain among the printed ratios which induced higher crosslinking density throughout the polymer network. Overall, the mechanical properties of the 3D printed product can be modulated by DP of succinate unit and the PPF to PPSu ratio in the polymer compositions, as well as the PPF to thiol ratio in resin formulations.

TABLE 2
Summary of mechanical properties of 3D printed tensile
bars of PPF-b-PPSu-b-PPF triblock copolymers in various
PPF to PPSu ratios in polymer compositions and PPF
to thiol ratios in resin formulations.

| Polymer | PPF:Thiol | E₀(MPa) | UTS(MPa) | ε_{break}(%) |
|---|---|---|---|---|
| 3-10-3 | 2:1 | 2.64 ± 0.11 | 1.62 ± 0.23 | 71 ± 10 |
| 5-10-5 | 1:1 | 1.18 ± 0.17 | 0.50 ± 0.15 | 49 ± 11 |
| 5-10-5 | 2:1 | 5.97 ± 1.23 | 2.69 ± 0.11 | 59 ± 8 |
| 5-10-5 | 5:1 | 3.55 ± 0.38 | 1.89 ± 0.39 | 63 ± 17 |
| 5-10-5 | 10:1 | 3.11 ± 0.19 | 1.65 ± 0.38 | 61 ± 16 |
| 5-20-5 | 1:1 | 1.04 ± 0.06 | 0.88 ± 0.07 | 106 ± 10 |
| 5-20-5 | 2:1 | 2.10 ± 0.02 | 1.72 ± 0.26 | 98 ± 15 |
| 5-20-5 | 5:1 | 1.70 ± 0.01 | 1.75 ± 0.15 | 117 ± 9 |
| 5-20-5 | 10:1 | 1.20 ± 0.01 | 1.69 ± 0.02 | 156 ± 2 |
| 5-40-5 | 2:1 | 1.00 ± 0.04 | 1.34 ± 0.07 | 167 ± 8 |

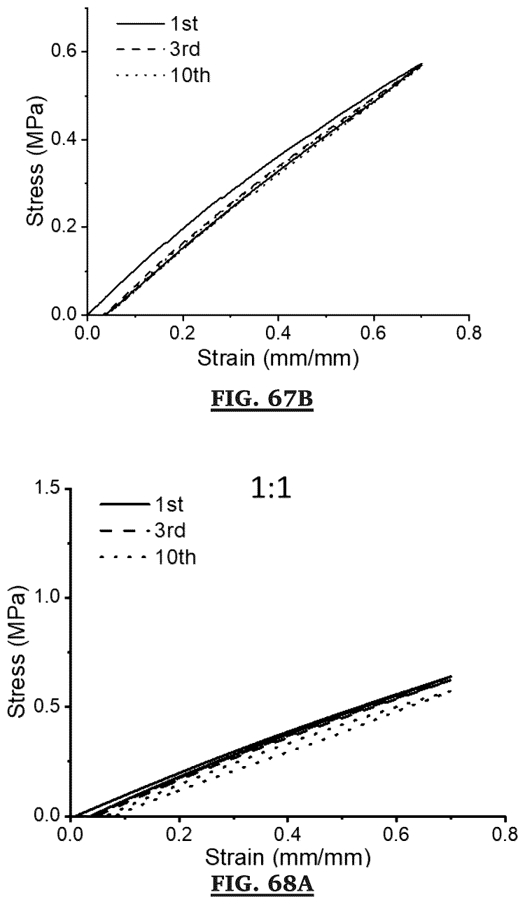

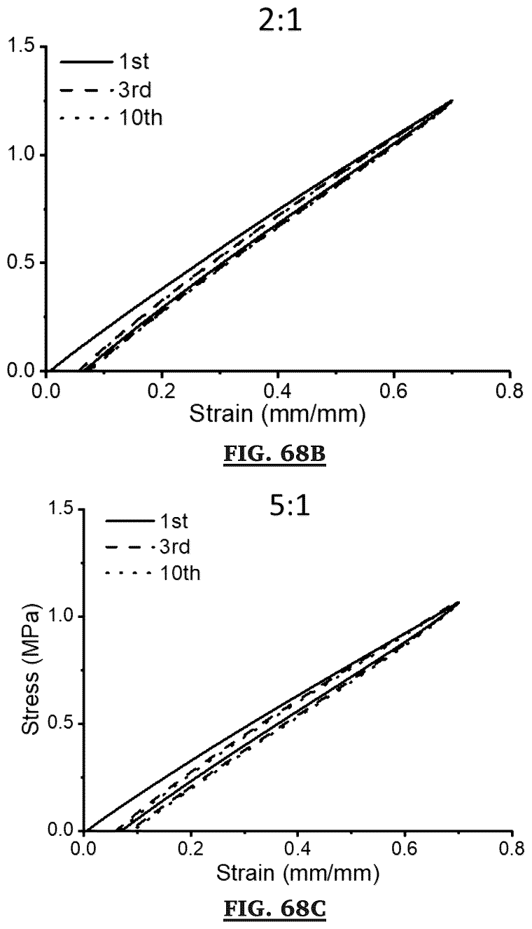

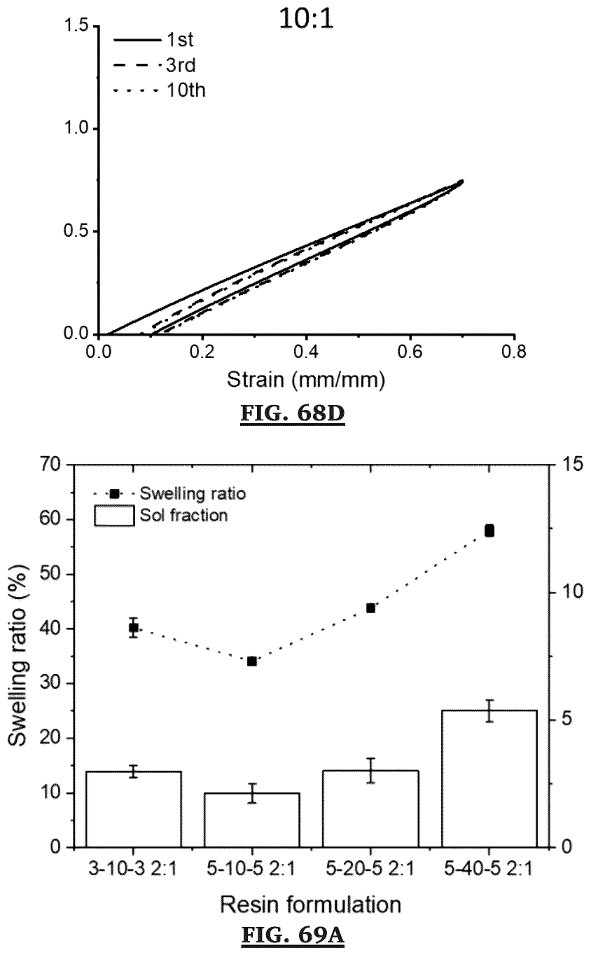

The elasticity of the triblock PPFPS was demonstrated by a cyclic test of PPFPS-5-40-5 at ambient temperature and 37° C. for 100 cycles and 10 cycles, respectively (FIG. 67A-B, see also FIGS. 68A-D). After a small hysteresis at the first cycle, the stress-strain curves are nearly identical up to 100 cycles at ambient temperature and up to 10 cycles at physiological temperature (37° C.). These results show the mechanical resilience of the product.

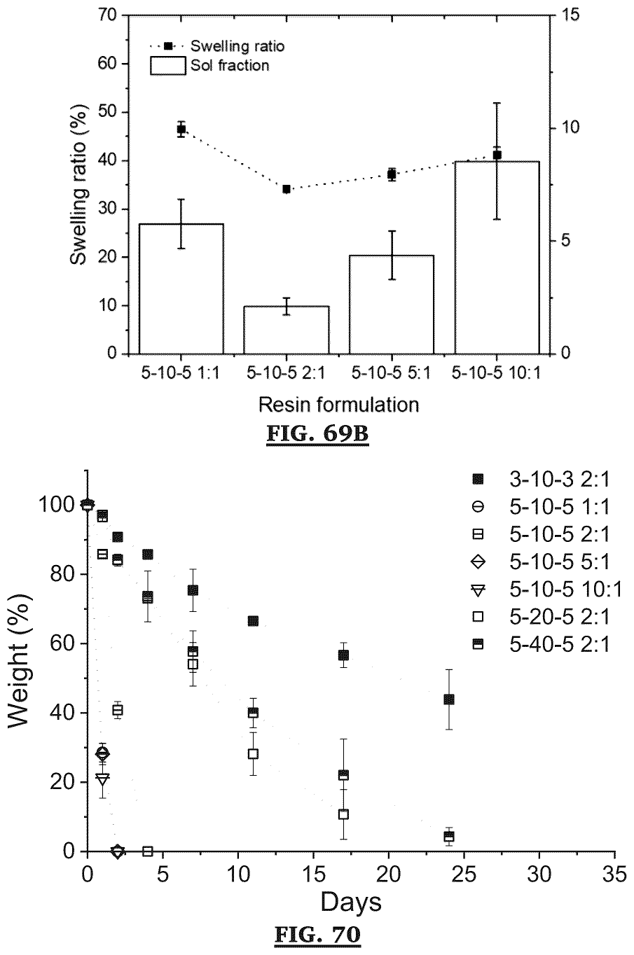

To better understand the crosslinking nature of the 3D printed structure, a swelling test of the disc with various polymer compositions and resin formulations was conducted in ethyl acetate (EA). The PPFPS-5-10-5 has the lowest swelling ratio, and the swelling ratio increases as the DP of the succinate unit is increased (FIG. 69A). This indicates that as the DP of the succinate unit is increasing, the crosslinking density increases, which is consistent with the tensile test results. A similar trend was shown for the sol fraction. This is because the higher fraction of uncrosslinkable succinate unit in the resin composition led to lower interchain crosslinking, which induced a higher fraction of solubilized, unreacted resin in the 3D printed product. The effect of PPF to thiol ratio in resin formulation on the swelling ratio and the sol fraction was measured with PPFPS-5-10-5 (FIG. 69). It shows a similar swelling ratio throughout the PPF to thiol ratio from 1:1 to 10:1, which indicates similar crosslink density along the PPF to thiol ratios. Conversely, the 2:1 alkene to thiol ratio shows the lowest sol fraction while the 10:1 alkene to thiol ratio displays the highest sol fraction. Thus, it can be determined that the 2:1 PPF to thiol ratio has the highest interchain crosslinking among the ratios and the imbalance of PPF to thiol ratio led to the lower interchain crosslinking. Interestingly, 1:1 has a higher sol fraction than the 2:1 formulation, which indicates that a maximum interchain crosslinking would occur at the PPF to thiol ratio around 2:1.

Accelerated in vitro degradation experiments were performed to determine the degradation rate of the 3D printed discs in a 0.25 N KOH aqueous solution at a physiological temperature (FIG. 70). PPFPS-5-10-5 fully degraded within 5 days and the degradation rate gets lower as the DP of the succinate unit increases. The degradation of a 2:1 ratio of PPF vs thiol is faster than other ratios. These trends might be the result of the increased hydrophobicity of the succinate unit compared to the fumarate unit and the interchain crosslinking density due to the PPF to thiol ratio, both of which slow the penetration of water into the construct. Importantly, the 3D printed discs fully degraded in an aqueous solution, which is a promising property for biopolymers. The 3D printed PPF, and thiols showed good cell viability in a previous study, however, the cell viability test and an in vivo degradation are yet to be determined in future study. Overall, these results demonstrate that the degradation rate can be tailored by DP of succinate unit in polymer composition and PPF to thiol ratio in resin formulation.

In conclusion, the novel 3D printable, fully biodegradable elastomeric ABA triblock copolymer of the present invention were synthesized through ROCOP of anhydrides and PO with various alcohol and acid initiators. The architecture and the composition of the polymers were confirmed by ¹H NMR, ¹³C NMR spectroscopy, SEC, and MALDI-ToF MS analysis. The E₀ (1-6 MPa), ultimate tensile strength (UTS) (0.5-2.7 MPa), ε_{break} (49-167%), and degradation rate are modulated by the DP of succinate unit, polymer block composition, and PPF to thiol ratio in resin formulation. The 3D printed constructs show good mechanical resilience with low hysteresis under uniaxial extension up to 100 cycles and fully degraded in basic conditions. The ability to tune the mechanical and degradative properties using established chemistry highlight the ability to translate the PPF system into numerous biological applications as well as soft robotics, sensors, and drug-delivery vehicles.

### EXAMPLES

The following examples are offered to more fully illustrate the invention but are not to be construed as limiting the scope thereof. Further, while some of examples may include conclusions about the way the invention may function, the inventor does not intend to be bound by those conclusions but put them forth only as possible explanations. Moreover, unless noted by use of past tense, presentation of an example does not imply that an experiment or procedure was, or was not, conducted, or that results were, or were not actually obtained. Efforts have been made to ensure accuracy with respect to numbers used (e.g., amounts, temperature), but some experimental errors and deviations may be present. Unless indicated otherwise, parts are parts by weight, molecular weight is weight average molecular weight, temperature is in degrees Centigrade, and pressure is at or near atmospheric.

### Materials and Methods

All materials were purchased from Millipore-Sigma and used as received unless otherwise noted. All solvents were purchased from Fisher Scientific (HPLC grade), distilled over calcium hydride, and degassed three freeze-pump-thaw cycles prior to use. Mg(BHT)₂(THF)₂ was synthesized using a modified literature procedure. In short, to the solution of 5.3 g of BHT in 16 mL of tetrahydrofuran (THF), 17.1 mL of Mg-n-Bu-sec-Bu (0.7 M in hexane) solution was added dropwise in an iced bath. After 2 hours at room temperature, a vacuum drying of residuals resulted in a white solid. Cis-2-butene diol (cBD) and 1,4-benzenediol (BDM) were distilled over calcium hydride under vacuum and degassed with three freeze-pump-thaw cycles. Fumaric acid (FmA), cyclohexanedicarboxylic acid (CHDA), 1,4-cyclohexane dimethanol (CHUM), 1,4-butynediol (BYD), 1,6-hexanediol (HDO), and 1,10-decanediol (DD) were dried in vacuo over P₂O₅, for a week. Succinic anhydride (SA) was recrystallized from THF and dried in vacuo over P₂O₅ for a week.

¹H and ¹³C nuclear magnetic resonance (NMR) spectra were recorded using a Bruker AVANCE NEO 500 MHz NMR. The chemical shifts were recorded in parts per million (ppm) relative to the reference resonance of chloroform solvent at δ=7.26 and 77.16 ppm for each of the ¹H and ¹³C NMR spectra, respectively.

Molecular masses and molecular mass distributions (Ð_{M}) were determined by size exclusion chromatography (SEC) using an HLC-8420 GPC (Tosoh Bioscience) on TSKgel GMHHR-M column with refractive index (RI) detector. Molecular masses were calculated using a calibration curve determined against poly(styrene) standards with THF as the eluent flowing at 0.5 mL min⁻¹ and a sample concentration of 5.0 mg mL⁻¹.

Matrix-assisted laser desorption/ionization time-of-flight (MALDI-ToF) mass spectra (MS) were recorded on a Bruker Autoflex Speed LRF MALDI-ToF system equipped with an Nd:YAG laser emitting at 355 nm in positive ion mode. All samples were dissolved. in THF at a concentration of 10 mg mL⁻¹. Trans-2-[3-(4-tert-butylphenyl)-2-methyl-2-propenylidene] malononitrile (DRIB) (20 mg mL⁻¹) served as a matrix and sodium trifluoroacetate (NaTFA) (10 mg mL⁻¹) as a cationizing agent were prepared in TI-IF solvent and were mixed in the ratio of 10:1. Matrix and sample solutions were applied onto the MALDI-ToF target plate by the sandwich method. FlexAnalysis software was used to analyze MALDI-ToF data.

### Experimental Examples

### Example 1

General Synthesis of the cis-copolymer [poly(propylene maleate-b-propylene succinate-h-propylene maleate)].

Under an inert atmosphere, equal molar quantities of SA and PO (71.5 mmol), and an initiator (3.6 mmol) are added to a toluene solution (about 20 ml) containing a Mg(BHT)₂(THF)₂ catalyst (0.72 mmol). The solution is then heated to 80° C. in a preheated aluminum block and the aliquots are removed from the solution to check the conversion. After the conversion of SA reached 99%, the mixture is cooled down to room temperature, and equal molar quantities of MA and PO are added. The reaction was then again heated to 80° C. to resume polymerization with the poly(propylene maleate) A blocks. When the conversion of MA is >99% (but <100%), the mixture was quenched with chloroform (˜4 mL) and precipitated twice from hexanes. The copolymer is recovered after drying under vacuum overnight (45° C., 10 mTorr). ¹H NMR (300 MHz, 298 K, CDCl₃): δ (ppm)=6.40-6.16 (m, 25.7H, C═OCHCHC═O), 5.34-5.05 (m, 12.5H, CH₂CHCH₃O), 4.80-4.74 (m, 2H, CCH₂), 4.37-3.89 (m, 27.8H, OCH₂CHCH₃), 2.77-2.54 (m, 3.5H, C═OCH₂CH₂C═O), 2.54-2.49 (m, 0.8H, CHC), 1.40-1.08 (m, 42.9, CHCH₃).

### Example 2

Synthesis of cis-copolymer [poly(propylene maleate-b-propylene succinate-b-propylene maleate)](PPMPS-5-10-5) with Fumaric Acid Initiator.

Under the inert atmosphere, 7.15 g (71.5 mmol) of succinic anhydride, 5.0 (71.5 mmol) of propylene oxide, and 0.84 g (7.2 mmol) of fumaric acid as an initiator were added to the 20 mL of toluene solution with 0.44 g (0.72 mmol) of Mg(BHT)₂(THF)₂ as a catalyst. The solution was heated to 80° C. in a preheated aluminum block and the aliquots were removed from the solution to check the conversion. After the conversion of succinic anhydride is over 99%, the mixture was cooled down to room temperature, added 7.05 g (71.5 mmol) of maleic anhydride, 5.0 mL (71.5 mmol) of propylene oxide, and heated to 80° C. When the conversion of maleic anhydride was reached to >99%, the mixture was quenched with 4 mL of chloroform and precipitated over an excess amount of hexane twice. The copolymer (22.2 g; 95% yield) was recovered after drying under vacuum overnight (45° C., 10 mtorr). ¹H NMR (500 MHz, 298 K, CDCl₃): δ (ppm)=6.83-6.69 (m, 2.00H, C═OCHCHC═O), 6.36-6.06 (m, 20.76H, C═OCHCHC═O), 5.32-4.86 (m, 20.92H, CH₂CHCH₃O), 4.34-3.84 (m, 47.73H, OCH₂CHCH₃), 2.74-2.35 (m, 42.28H, C═OCH₂CH₂C═O), 1.43-0.97 (m, 74.75, CHCH₃). (See, Table 1; FIGS. 5, 32, 45)

### Example 3

Synthesis of cis-copolymer [poly(propylene maleate-b-propylene succinate-b-propylene maleate)] (PPMPS-5-20-5) with Fumaric Acid Initiator.

PPMPS-5-20-5 copolymer was synthesized following the procedure shown in Example 1, except that 0.42 g (3.6 mmol) of fumaric acid, 3.52 g (35.8 mmol) of maleic anhydride and 2.5 mL (35.8 mmol) of propylene oxide were used instead of 0.84 g of fumaric acid, 7.05 g of maleic anhydride, and 5.0 mL of propylene oxide. The copolymer (16.3 g; 93% yield) was recovered after drying under vacuum overnight (45° C., 10 mtorr). ¹H NMR (500 MHz, 298 K, CDCl₃): δ (ppm)=6.92-6.79 (m, 2.00H, C═OCHCHC═O), 6.47-6.15 (m, 12.74H, C═OCHCHC═O), 5.34-4.96 (m, 15.47H, CH₂CHCH₃O), 4.43-3.91 (m, 33.58H, OCH₂CHCH₃), 2.82-2.41 (m, 38.14H, C═OCH₂CH₂C═), 1.41-1.06 (m, 53.65H, CHCH₃). (See, Table 1; FIGS. 6, 33, 46)

### Example 4

Synthesis of cis-copolymer [poly(Propylene maleate-b-propylene succinate-b-propylene maleate)] (PPMPS-5-40-5) with Fumaric Acid Initiator.

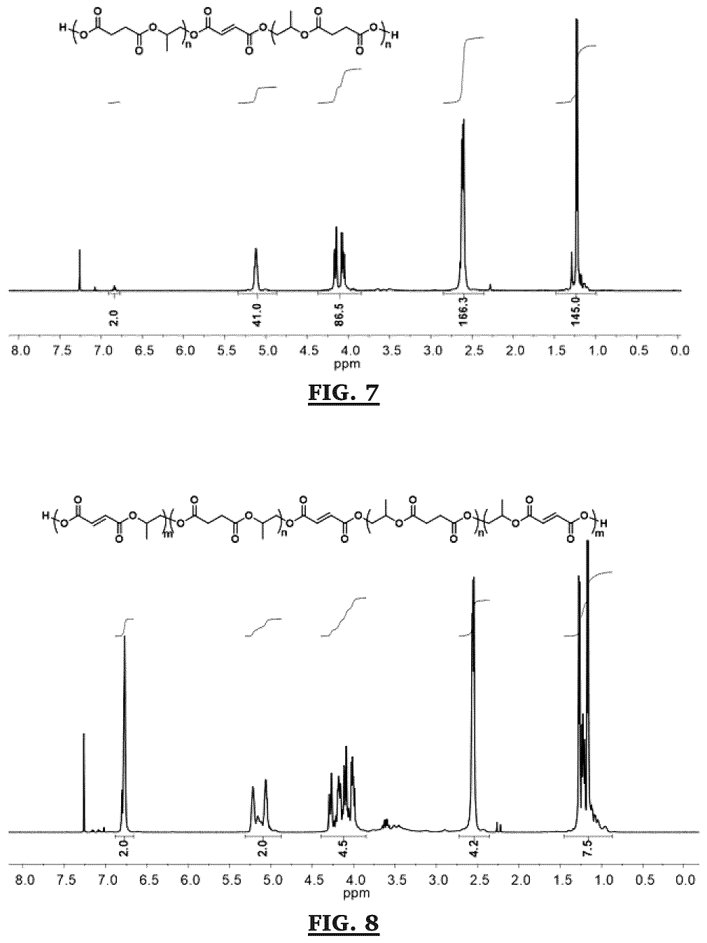

PPMPS-5-40-5 copolymer was synthesized following the procedure shown in Example 1, except that 0.21 g (1.8 mmol) of fumaric acid 1.76 g (17.9 mmol) of maleic anhydride and 1.3 mL (17.9 mmol) of propylene oxide were used instead of 0.84 g of fumaric acid, 7.05 g of maleic anhydride, and 5.0 mL of propylene oxide. The copolymer (13.8 g; 96% yield) was recovered after drying under vacuum overnight (45° C., 10 mtorr). ¹NMR (500 MHz, 298 K, CDCl₃): δ (ppm)=6.84-6.74 (m, 2.00H, C═OCHCHC═O), 6.42-6.06 (m, 21.17H, C═OCHCHC═O), 5.32-4.86 (m, 50.95H, CH₂CHCH₃O), 4.36-3.85 (m, 107.29H, OCH₂CHCH₃), 2.80-2.36 (m, 162.86H, C═OCH₂CH₂C═O), 1.44-0.95 (m, 174.18, CHCH₃). (See, Table 1; FIGS. 7, 34, 47)

### Example 5

Synthesis of cis-copolymer [poly(propylene maleate-b-propylene succinate-b-propylene maleate)-] (PPMPS-3-10-3) with Fumaric Acid Initiator.

PPMPS-3-10-3 copolymer was synthesized following the procedure shown in Example 1, using 4.29 g (42.9 mmol) of maleic anhydride and 3.0 mL (42.9 mmol) of propylene oxide. The copolymer (17.0 g; 90% yield) was recovered after drying under vacuum overnight (45° C., 10 mtorr). ¹H NMR (500 MHz, 298 K, CDCl₃); δ (ppm)=6.91-6.79 (m, 2.00H, C═OCHCHC═O), 6.49-6.13 (m, 12.74H, C═OCHCHC═O), 5.39-4.93 (m, 15.47H, CH₂CHCH₃O), 4.45-3.89 (m, 33.58H, OCH₂CHCH₃), 2.82-2.42 (m, 38.14H, C═OCH₂CH₂C═O), 1.51-1.01 (m, 53.65, CHCH₃). (See Table 1)

### Example 6

Synthesis of cis-copolymer [poly(propylene maleate-b-propylene succinate-b-propylene maleate)] (PPMPS-3-20-3) with Fumaric Acid Initiator.

PPMPS-3-20-3 copolymer was synthesized following the procedure shown in Example 5, except that 0.42 g (3.6 mmol) of fumaric acid, 2.11 g (21.5 mmol) of maleic anhydride and 1.5 mL (21.5 mmol) of propylene oxide were used instead of 0.84 g of fumaric acid, 4.29 g of maleic anhydride, and 3.0 mL of propylene oxide. The copolymer (14.6 g; 97% yield) was recovered after drying under vacuum overnight (45° C., 10 mtorr). ¹H NMR (500 MHz, 298 K, CDCl₃): δ (ppm)=6.84-6.69 (m, 2.00H, C═OCHCHC═O), 6.37-6.03 (m, 12.51H, C═OCHCHC═O), 5.32-4.80 (m, 27.44H, CH₂CHCH₃O), 4.37-3.75 (m, 58.42H, OCH₂CHCH₃), 2.79-2.30 (m, 79.66H, C═OCH₂CH₂C═O), 1.47-0.81 (m, 94.50, CHCH₃). (See Table 1)

### Example 7

Synthesis of cis-copolymer [poly(propylene maleate-b-propylene succinate-b-propylene maleate)] (PPMPS-3-40-3) with Fumaric Acid Initiator.

PPMPS-3-40-3 copolymer was synthesized following the procedure shown in Example 4, except that 0.21 g (1.8 mmol) of fumaric acid, 1.06 g (10.8 mmol) of maleic anhydride and 0.8 mL (10.8 mmol) of propylene oxide were used instead of 0.84 g of fumaric acid, 4.29 g of maleic anhydride, and 3.0 mL of propylene oxide. The copolymer (12.2 g; 92% yield) was recovered after drying under vacuum overnight (45° C., 10 mtorr). NMR (500 MHz, 298 K, CDCl₃): δ (ppm)=6.86-6.72 (m, 2.00H, C═OCHCHC═O), 6.37-6.07 (m, 24.09H, C═OCHCHC═O), 5.34-4.84 (m, 52.78H, CH₂CHCH₃O), 4.38-3.81 (m, 111.56H, OCH₂CHCH₃), 2.78-2.35 (m, 161.80H, C═OCH₂CH₂C═O), 1.47-0.89 (m, 189.52, CHCH₃), (See Table 1)

### Example 8

Synthesis of cis-copolymer [poly(propylene maleate-b-propylene succinate-b-propylene maleate)] (PPMPS-5-20-5) with 1,4-cyclohexanedicarboxylic Acid (CHDA) Initiator.

PPMPS-5-20-5 copolymer was synthesized following the procedure shown in Example 2, except that 0. g (3.6 mmol) of 1,4-cyclohexanedicarboxylic acid was used instead of 0.42 g of fumaric acid. The copolymer (16.7 g; 95% yield) was recovered after drying under vacuum overnight (45° C. 10 mtorr). ¹H NMR (500 MHz, 298 K, CDCl₃): δ (ppm)=6.39-6.15 (m, 19.94H, C═OCHCHC═O), 5.34-4.95 (m, 25.72H, CH₂CHCH₃O), 4.35-3.89 (m, 52.97H, OCH₂CHCH₃), 2.77-2.42 (m, 58.83H, C═OCH₂CH₂C═O), 1.93-1.61 (m, 10.00H, CH₂CHCH₂CH₂HCH₂), 1.47-0.89 (m, 189.52, CHCH₃). (See Table 1; FIGS. 18)

### Example 9

Synthesis of cis-copolymer [poly(propylene maleate-b-propylene succinate-b-propylene maleate)] (PPMPS-5-20-5) with cyclohexane-1,4-dimethanol (CHDA) Initiator.

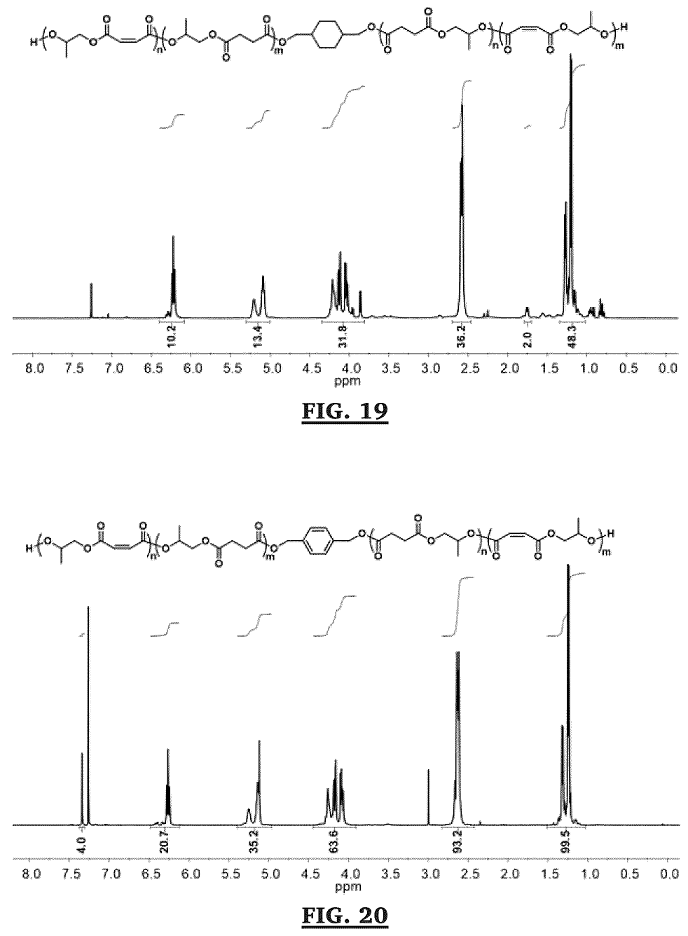

PPMPS-5-20-5 copolymer was synthesized following the procedure shown in Example 2, except that 0. g (3.6 mmol) of cyclohexane-1,4-dimethanol was used instead of 0.42 g of fumaric acid. The copolymer (17.2 g; 98% yield) was recovered after drying under vacuum overnight (45° C., 10 mtorr). ¹H NMR (500 MHz, 298 K, CDCl₃): δ (ppm)=6.36-6.08 (m, 19.24H, C═OCHCHC═O), 5.31-4.92 (m, 25.93H, CH₂CHCH₃O), 4.35-3.91 (m, 56.21H, OCH₂CH₂CH₃), 3.91-3.80 (d, 4.00H, OCH₂CH), 2.70-2.47 (m, 68.66H, C═OCH₂CH₂C═O), 1.79-1.73 (m, 3.34H, CH₂CH(CH₂)₂), 1.35-1.01 (m, 91.64H, CHCH₃). (See Table 1; FIG. 19)

### Example 10

Synthesis of cis-copolymer [poly(Propylene maleate-b-propylene succinate-b-propylene maleate)] (PPMPS-5-20-5) with benzene-1,4-dimethanol (BDM) Initiator.

PP MPS-5-20-5 copolymer was synthesized following the procedure shown in Example 2, except that 0. g (3.6 mmol) of benzene-1,4-dimethanol was used instead of 0.42 g of fumaric acid. The copolymer (16.4 g; 93% yield) was recovered after drying under vacuum overnight (45° C., 10 mtorr). ¹H NMR (500 MHz, 298 K, CDCl₃): δ (ppm)=7.40-7.31 (s, 4.00H, CCHCHC), 6.49-6.12 (m, 20.71H, C═OCHCHC═O), 5.39-4.96 (m, 35.20H, CH₂CHCH₃O), 4.44-3.90 (m, 63.63H, OCH₂CHCH₃), 2.83-2.43 (m, 92.18H, C═OCH₂CH₂C═O), 1.51-1.03 (m, 99.52H, CHCH₃), (See Table 1; FIG. 20)

### Example 11

Synthesis of cis-copolymer [poly(Propylene maleate-b-propylene succinate-b-propylene maleate))] (PPMPS-5-20-5) with cis-butene-1,4-diol (cBD) Initiator.

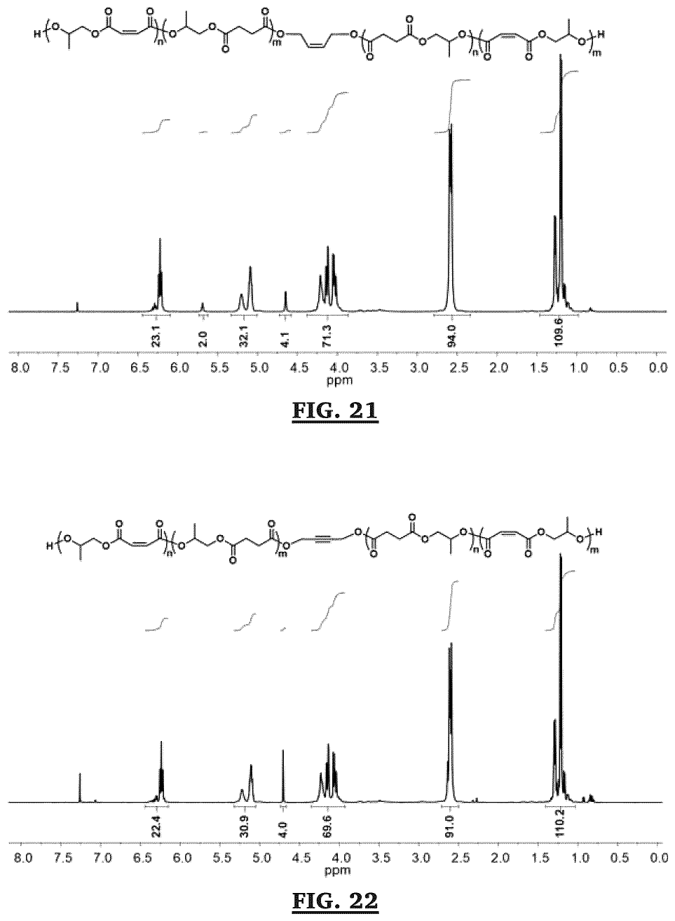

PPMPS-5-20-5 copolymer was synthesized following the procedure shown in Example 2, except that 0. g (3.6 mmol) of cis-butene-1,4-diol was used instead of 0.42 g of fumaric acid. The copolymer (16.8 g; 96% yield) was recovered after drying under vacuum overnight (45° C., 10 mtorr). ¹H NMR (500 MHz, 298 K, CDCl₃): δ (ppm)=6.40-6.10 (m, 23.04H, C═OCHCHC═O), 5.74-5.62 (m, 2.00H, CH₂CHCHCH₂), 5.33-5.00 (m, 32.10H, CH₂CHCH₃O), 4.71-4.58 (d, 4.06H, OCH₂CH), 4.38-3.87 (m, 71.28H, OCH₂CHCH₃), 2.79-2.33 (m, 94.00H, C═OCH₂CH₂C═O), 1.47-0.98 (m, 109.64H, CHCH₃), (See Table 1; FIG. 21)

### Example 12

Synthesis of cis-copolymer [poly(propyiene maleate-b-propylene succinate-b-propylene maleate)] (PPMPS-5-20-5) with 1,4-butynediol (BYD) Initiator.

PPMPS-5-20-5 copolymer was synthesized following the procedure shown in Example 2, except that 0. g (3.6 mmol) of 1,4-butynediol was used instead of 0.42 g of fumaric acid. The copolymer (16.4 g; 94% yield) was recovered after drying under vacuum overnight (45° C., 10 mtorr). ¹HNMR (500 MHz, 298 K, CDCl₃): δ (ppm)=6.45-6.16 (m, 22.42H, C═OCHCHC═O), 5.33-5.05 (m, 30.88H, CH₂CHCH₃O), 4.74-4.67 (d, 4.00H, OCH₂C), 4.36-3.93 (m, 69.63H, OCH₂CHCH₃), 2.71-2.51 (m, 91.04H, C═OCH₂CH₂C═O), 1.41-10.4 (m, 110.24H, CHCH₃). (See Table 1; FIG. 22)

### Example 13

Synthesis of cis-copolymer [poly(propylene maleate-b-propylene succinate-b-propylene maleate)] (PPMPS-5-20-5) with 1,6-hexanediol (HDO) Initiator.

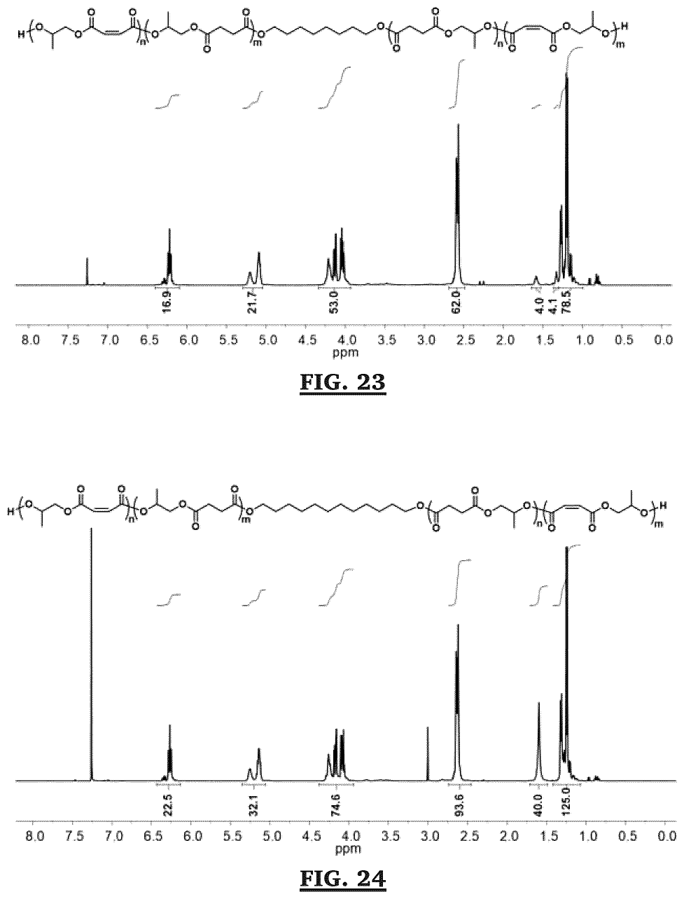

PPMPS-5-20-5 copolymer was synthesized following the procedure shown in Example 2, except that 0. g (3.6 mmol) of 1,6-hexanediol was used instead of 0.42 g of fumaric acid. The copolymer (15.6 g; 89% yield) was recovered after drying under vacuum overnight (45° C., 10 mtorr). ¹H NMR (500 MHz, 298 K, CDCl₃): δ (ppm)=6.40-6.10 (m, 16.90H, C═OCHCHC═O), 5.29-5.03 (m, 21.84H, CH₂CHCH₃O), 4.33-3.93 (m, 53.03H, OCH₂CHCH₃), 2.70-2.50 (m, 62.04H, C═OCH₂CH₂C═O), 1.64-1.53 (m, 4.00H, OCH₂CH₂), 1.41-1.04 (m, 110.24H, CHCH₃, CH₂(CH₂)₆CH₂). (See Table 1; FIG. 23)

### Example 14

Synthesis of cis-copolymer [poly(propylene maleate-b-propylene succinate-b-propylene maleate)] (PPMPS-5-20-5) with 1,10-decanediol (DD) Initiator.

PPMPS-5-20-5 copolymer was synthesized following the procedure shown in Example 2, except that 0.63 g (3.6 mmol) of 1,10-decanediol was used instead of 0.42 g of fumaric acid. The copolymer (16.0 g; 91% yield) was recovered after drying under vacuum overnight (45° C., 10 mtorr). ¹H NMR (500 MHz, 298 K, CDCl₃): δ (ppm)=6.41-6.15 (m, 22.52H, C═OCHCHC═O), 5.35-5.06 (m, 32.07H, CH₂CHCH₃O), 4.36-3.94 (m, 74.60H, OCH₂CHCH₃), 2.74-2.47 (m, 93.54H, C═OCH₂CH₂C═O), 1.74-1.50 (m, 40.00H, CH₂(CH₂)₁₀CH₂), 1.42-1.07 (m, 125.02H, CHCH₃). (See Table 1; FIG. 24,)

### Example 15

General Procedure for Isomerization of the cis-copolymer [poly(propylene maleate-b-propylene succinate-b-propylene maleate)] to the trans-copolymer [poly(propylene fumarate-b-propylene succinate-b-propylene fumarate)]

Diethylamine (HNEt₂) is added to a solution of the poly(propylene maleate-b-propylene succinate-b-propylene maleate) to be isomerized in chloroform, and the mixture is refluxed for 18 h under nitrogen. Following complete isomerization as determined by NMR, the organic layer was washed with an aqueous monosodium phosphate solution (1.0 M, pH 6) and the polymer was recovered after drying under vacuum overnight (45° C., 10 mTorr), ¹H NMR (300 MHz, 298 K, CDCl₃): δ (ppm)=6.97-6.78 (m, 19.6H, C═OCHCHC═O), 5.39-5.05 (m, 11.6H, CH₂CHCH₃O), 4.82 (d, 2.0H, CCH₂O), 4.45-4.00 (m, 24.8H, C═OCH₂CH₂C═O), 2.58-2.49 (s, 1.2H, CHC), 1.40-1.03 (m, 40.0, CHCH₃).

### Example 16

Synthesis of trans-copolymer [poly(propylene fumarate-b-propylene succinate-b-propylene fumarate)] (PPFPS-5-10-5) with Fumaric Acid Initiator.

To a solution of the PPMPS-5-10-5 (10.0 g) of Example 2 that was dissolved in 20 mL of chloroform, diethylamine (0.7 mL, 6.7 mmol) was added and refluxed for 18 h under nitrogen atmosphere at 65° C. The organic layer was washed with an aqueous potassium phosphate solution (1.0 M, pH 6) and the polymer (9.9 g, 99% yield) was recovered after drying under vacuum overnight (45° C., 10 mtorr). ¹H NMR (500 MHz, 298 K, CDCl₃): δ (ppm)=6.89-6.66 (m, 2.00H, C═OCHCHC═O), 5.32-4.88 (m, 2.02H, CH₂CHCH₃O), 4.41-3.86 (m, 4.48H, OCH₂CH) 2.72-2.35 (m, 4.20H, C═OCH₂CH₂C═O), 1.46-0.87 (m, 7.46, CHCH₃). (See Table 1; FIGS. 8, 32, 48)

### Example 17

Synthesis of trans-copolymer [poly(propylene fumarate-b-propylene succinate-b-propylene fumarate)] (PPFPS-5-20-5) with Fumaric Acid Initiator.

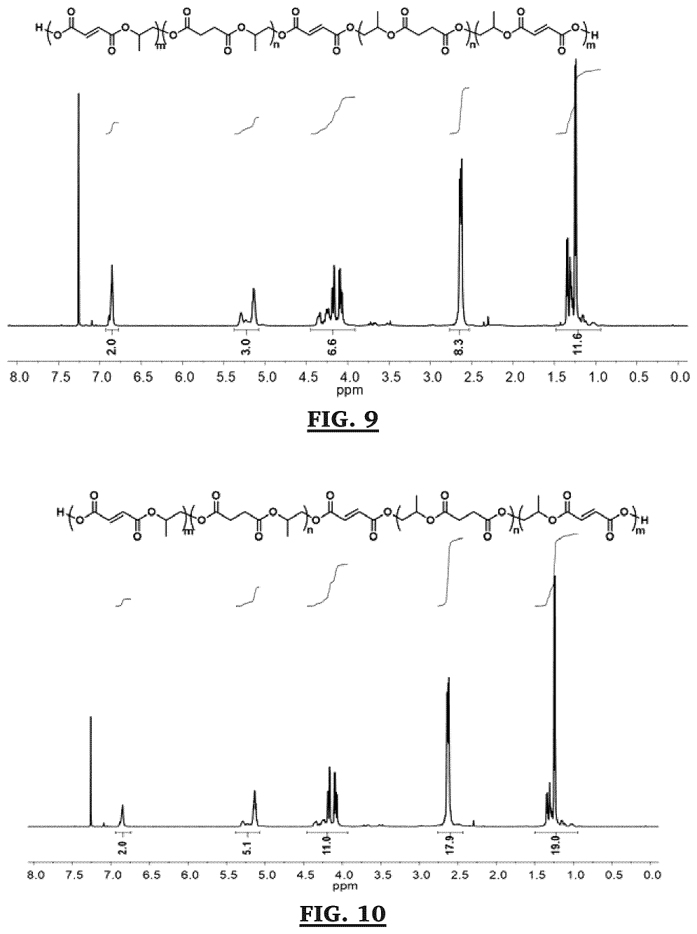

PPFPS-5-20-5 copolymer was synthesized following the procedure shown in Example 2, except that PPMPS-5-20-5 of Example 3 was used instead of the PPMPS-5-10-5 of Example 2. The copolymer (9.7 g; 97% yield) was recovered after drying under vacuum overnight (45° C., 10 mtorr). ¹H NMR (500 MHz, 298 K, CDCl₃): δ (ppm)=6.93-6.78 (m, 2.00H, C═OCHCHC═O), 5.36-4.90 (m, 7.74H, CH₂CHCH₃O), 4.40-3.88 (m, 16.45H, OCH₂CH) 2.84-2.37 (m, 31.15H, C═OCH₂CH₂C═O), 1.39-1.01 (m, 27.57, CHCH₃). (See Table 1; FIGS. 9, 33, 49)

### Example 18

Synthesis of trans-copolymer [poly(propylene fumarate-b-propylene succinate-b-propylene fumarate)] (PPFPS-5-40-5) with Fumaric Acid Initiator.

PPFPS-5-40-5 copolymer was synthesized following the procedure shown in Example 16, except that PPMPS-5-40-5 of Example 4 was used instead of PPMPS-5-10-5 of Example 2. The copolymer (9.5 g; 95% yield) was recovered after drying under vacuum overnight (45° C., 10 mtorr). ¹H NMR (500 MHz, 298 K, CDCl₃): δ (ppm)=6.94-6.75 (m, 2.00H, C═OCHCHC═O), 5.38-4.93 (m, 5.25H, CH₂CHCH₃O), 4.45-3.87 (m, 11.08H, OCH₂CH) 2.77-2.43 (m, 17.89H, C═OCH₂CH₂C═O), 1.49-0.96 (m, 18.95H, CHCH₃). (See Table 1; FIGS. 10, 34, 50)

### Example 19

Synthesis of trans-copolymer [poly(propylene fumarate-b-propylene succinate-b-propylene fumarate)] (PPFPS-3-10-3) with Fumaric Acid Initiator.

PPFPS-3-10-3 copolymer was synthesized following the procedure shown in Example 16, except that PPMPS-3-10-3 of Example 5 was used instead of PPMPS-5-10-5, The copolymer (9.8 g; 98% yield) was recovered after drying under vacuum overnight (45° C., 10 mtorr). ¹H NMR (500 MHz 298 K, CDCl₃): δ (ppm)=6.95-6.73 (m, 2.00H, C═OCHCHC═O), 5.40-4.91 (m, 2.43H, CH₂CHCH₃O), 4.47-3.89 (m, 5.21H, OCH₂CH) 2.80-2.39 (m, 5.94H, C═OCH₂CH₂C═O), 1.49-1.00 (m, 8.85, CHCH₃). (See Table 1)

### Example 20

Synthesis of trans-copolymer [poly(propylene fumarate-b-propylene succinate-b-propylene fumarate)] (PREPS-3-20-3) with Fumaric Acid Initiator.

PPFPS-3-20-3 copolymer was synthesized following the procedure shown in Example 16, except that PPMPS-3-20-3 of Example 6 was used instead of PPMPS-5-10-5. The copolymer (9.9 g; 99% yield) was recovered after drying under vacuum overnight (45° C., 10 mtorr). ¹H NMR (500 MHz, 298 K, CDCl₃): δ (ppm)=6.94-6.75 (m, 2.00H, C═OCHCHC═O), 5.38-4.94 (m, 4.46H, CH₂CHCH₃O), 4.45-3.89 (m, 9.68H, OCH₂CH) 2.79-2.45 (m, 13.46H, C═OCH₂CH₂C═O), 1.47-1.03 (m, 16.96, CHCH₃). (See Table 1)

### Example 21

Synthesis of trans-copolymer [poly(propylene fumarate-b-propylene succinate-b-propylene fumarate)] (PPFPS-3-40-3) with Fumaric Acid Initiator.

PPFPS-3-40-3 copolymer was synthesized following the procedure shown in Example 16, except that PPMPS-3-40-3 of Example 7 was used instead of PPMPS-5-10-5. The copolymer (9.9 g; 99% yield.) was recovered after drying under vacuum overnight (45° C., 10 mtorr). ¹H NMR (500 MHz, 298 K, CDCl₃): δ (ppm)=6.94-6.76 (m, 2.00H, C═OCHCHC═O), 5.38-4.97 (m, 5.56H, CH₂CHCH₃O), 4.42-3.89 (m, 12.72H, CH₂CH) 2.81-2.47 (m, 19.46H, C═OCH₂CH₂C═O), 1.48-0.94 (m, 23.15, CHCH₃). (See Table 1)

### Example 22

Synthesis of trans-copolymer [poly(propylene fumarate-b-propylene succinate-b-propylene fumarate)] (PPFPS-5-20-5) with cyclohexane-14-dicarboxylic Acid (CHDA) Initiator.

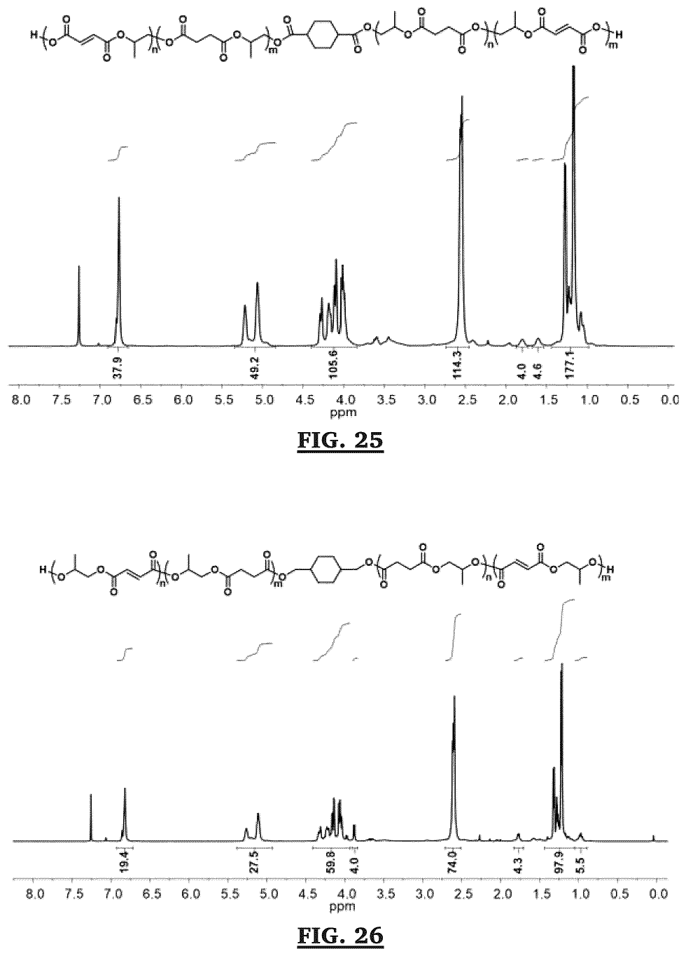

PPFPS-5-20-5 copolymer with cyclohexane-1,4-dicarboxylic acid was synthesized following the procedure shown in Example 16, except that the PPMPS-5-20-5 from Example 8 was used instead of PPMPS-5-10-5 initiated with fumaric acid. The copolymer (9.6 g; 96% yield) was recovered after drying under vacuum overnight (45° C., 10 mtorr). ¹H NMR (500 MHz, 298 K, CDCl₃): δ (ppm)=6.89-6.65 (m, 37.90H, C═OCHCHC═O), 5.40-4.84 (m, 49.24H, CH₂CHCH₃O), 4.40-3.84 (m, 105.64H, OCH₂CHCH₃), 2.73-2.32 (m, 118.10H, C═OCH₂CH₂C═O), 1.83-1.54 (m, 8.62H, CH₂CHCH ₂CH₂HCH₂), 1.45-0.88 (m, 178.87, CHCH₃). (See Table 1; FIGS. 25, 35, 51).

### Example 23

Synthesis of trans-copolymer [poly(propylene fumarate-b-propylene succinate-b-propylene fumarate)-] (PPFPS-5-20-5) with cyclohexane-1,4-dimethanol (CHDM) Initiator.

PPFPS-5-20-5 copolymer with cyclohexane-1,4-dimethanol was synthesized following the procedure shown. in Example 16, except that PPMPS-5-20-5 from Example 9 was used instead of PPMPS-5-10-5 initiated with fumaric acid. The copolymer (9.7 g; 97% yield) was recovered after drying under vacuum overnight (45° C., 10 mtorr). ¹H NMR (500 MHz, 298 K, CDCl₃): δ (ppm)=6.93-6.72 (m, 19.38H, C═OCHCHC═O), 5.39-4.93 (m, 27.53H, CH₂CHCH₃O), 4.41-3.94 (m, 59.79H, OCH₂CHCH₃), 3.91-3.84 (d, 4.00H, OCH₂CH), 2.72-2.43 (m, 75.70H, C═OCH₂CH₂C═O), 1.81-1.73 (m, 3.50H, CH₂CH(CH₂)₂), 1.43-1.06 (m, 91.64H, CHCH₃) 1.06-0.88 (m, 5.83H, CHCH₂CH₂CH). (See Table 1; FIGS. 26, 36, 52).

### Example 24

Synthesis of trans-copolymer [poly-propylene fumarate-b-propylene succinate-b-propylene fumarate)] (PPFPS-5-20-5) with benzene-1,4-dimethanol Initiator.

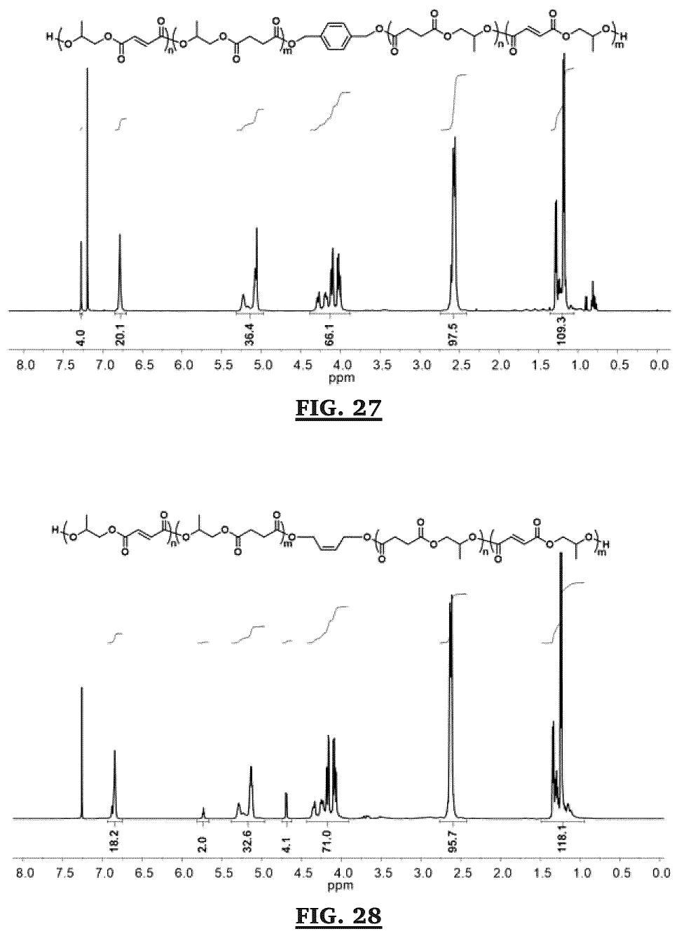

PPFPS-5-20-5 copolymer with benzene-1,4-dimethanol was synthesized following the procedure shown in Example 16, except that PPMPS-5-20-5 from Example 10 was used instead of PPMPS-5-10-5 initiated with fumaric acid. The copolymer (9.3 g; 93% yield) was recovered after drying under vacuum overnight (45° C., 10 mtorr). ¹H NMR (500 MHz, 298 K, CDCl₃): δ (ppm)=7.38-7.30 (s, 4.00H, CCHCHC), 6.85-6.71 (m, 20.09H, C═OCHCHC═O), 5.32-4.97 (m, 36.36H, CH₂CHCH₃O), 4.39-3.88 (m, 66.11H, OCH₂CHCH₃), 2.74-2.38 (m, 97.63H, C═OCH₂CH₂C═O), 1.36-1.05 (m, 109.30H, CHCH₃). (See Table 1; FIGS. 27, 37, 53)

### Example 25

Synthesis of trans-copolymer [poly(propylene fumarate-b-propylene succinate-b-propylene fumarate))] (PPFPS-5-20-5) with cis-butene-1,4-diol (cBD) Initiator.

PPFPS-5-20-5 copolymer with cis-butene-1,4-diol was synthesized following the procedure shown in Example 16, except that PPMPS-5-20-5 from Example 1.1 was used instead of PPMPS-5-10-5 initiated with fumaric acid. The copolymer (9.6 g; 96% yield) was recovered after drying under vacuum overnight (45° C., 10 mtorr) ¹H NMR (500 MHz, 298 K, CDCl₃): δ (ppm)=6.94-6.75 (m, 18.21H, C═OCHCHC═O), 5.81-5.66 (m, 2.00H, CH₂CHCHCH₂), 5.38-4.96 (m, 32.56H, CH₂CHCH₃O), 4.75-4.62 (d, 4.12H, OCH₂CH), 4.44-3.91 (m, 71.00H, OCH₂CHCH₃), 2.77-2.43 (m, 95.73H, C═OCH₂CH₂C═O), 1.49-0.95 (m, 118.05H, CHCH₃). (See Table 1; FIGS. 28, 38, 54)

### Example 26

Synthesis of trans-copolymer [poly(propylene fumarate-b-propylene succinate-b-propylene fumarate)] (PPFPS-5-20-5) with 1,4-butynediol (BYD) Initiator.

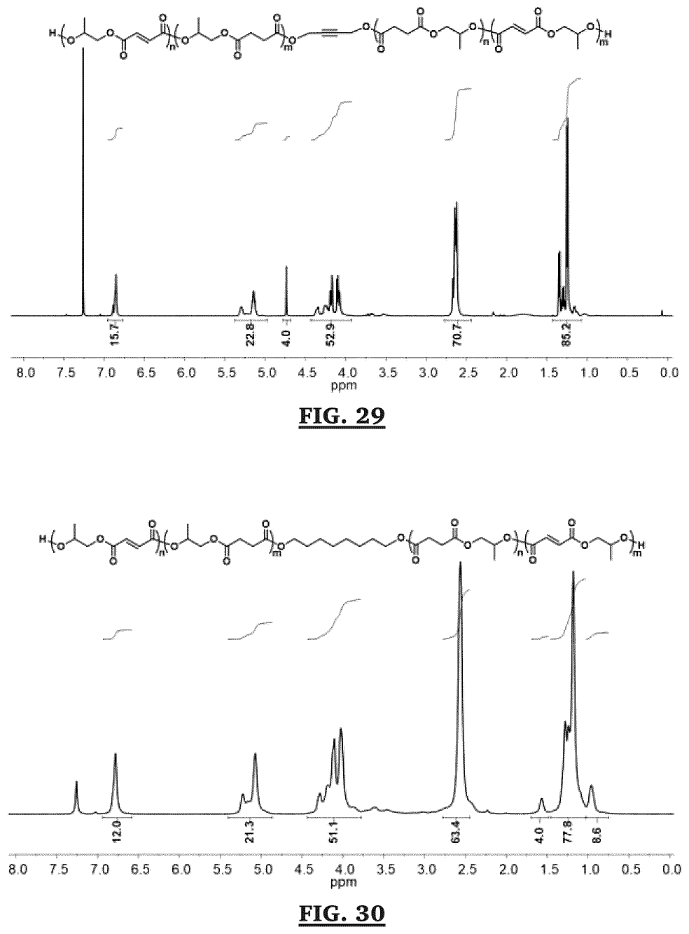

PPFPS-5-20-5 copolymer with 1,4-butynediol was synthesized following the procedure shown in Example 16, except that PPMPS-5-20-5 from Example 12 was used instead of PP11-1:PS-5-10-5 initiated with fumaric acid. The copolymer (9.1 g; 91% yield) was recovered after drying under vacuum overnight (45° C., 10 mtorr). ¹H NMR (500 MHz, 298 K, CDCl₃): δ (ppm)=6.96-6.77 (m, 15.74H, C═OCHCHC═O), 5.38-4.97 (m, 22.81H, CH₂CHCH₃O), 4.78-4.68 (d, 4.00H, OCH₂C), 4.43-3.93 (m, 52.94H, OCH₂CHCH₃), 2.78-2.44 (m, 70.67H, C═OCH₂CH₂C═O), 1.41-1.08 (m, 85.22H, CHCH₃). (See Table 1; FIGS. 29, 39, 55)

### Example 27

Synthesis of trans-copolymer [poly(propylene fumarate-b-propylene succinate-b-propylene fumarate)] (PPFPS-5-20-5) with 1,6-hexanediol (HDO) Initiator.

PPFPS-5-20-5 copolymer with 1,6-hexanediol initiator was synthesized. following the procedure shown in Example 16, except that PPMPS-5-20-5 from Example 13 was used instead of PPMPS-5-10-5 initiated with fumaric acid. The copolymer (9.9 g; 99% yield) was recovered after drying under vacuum overnight (45° C., 10 mtorr). ¹H NMR (500 MHz, 298 K, CDCl₃): δ (ppm)=6.94-6.58 (m, 11.99H, C═OCHCHC═O), 5.41-4.87 (m, 21.32H, CH₂CHCH₃O), 4.43-3.78 (m, 51.13H, OCH₂CHCH₃), 2.73-2.31 (m, 66.54H, C═OCH₂CH₂C═O), 1.70-1.49 (m, 4.00H, OCH₂CH₂), 1.47-0.74 (m, 86.41H, CHCH₃, CH₂(CH₂)₆CH₂). (See Table 1; FIGS. 30, 40, 56)

### Example 28

Synthesis of trans-copolymer [poly(propylene fumarate-b-propylene succinate-b-propylene fumarate)] (PPFPS-5-20-5) with 1,6-decanediol (DD) Initiator.

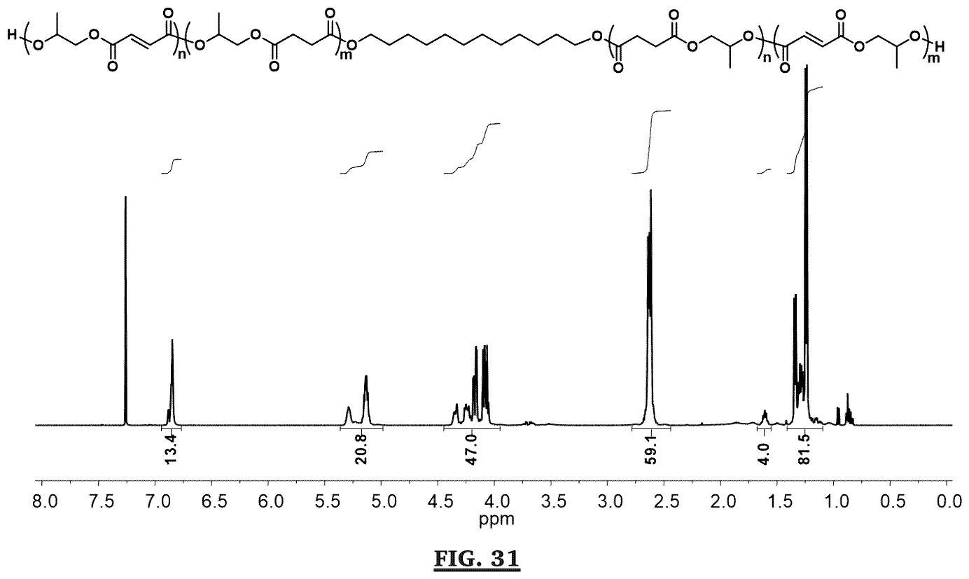

PPFPS-5-20-5 copolymer with 1,6-decanediol was synthesized following the procedure shown in Example 16, except that PPMPS-5-20-5 from Example 14 was used instead of PPMPS-5-10-5 initiated with fumaric acid. The copolymer (9.5 g; 95% yield) was recovered after drying under vacuum overnight (45° C., 10 mtorr). ¹H NMR (500 MHz, 298 K, CDCl₃): δ (ppm)=6.95-6.76 (m, 13.42H, C═OCHCHC═O), 5.36-4.98 (m, 20.79H, CH₂CHCH₃O), 4.41-3.95 (m, 47.01H, OCH₂CHCH₃), 2.79-2.44 (m, 59.10H, C═OCH₂CH₂C═O), 1.67-1.55 (m, 4.00H, OCH₂CH₂), 1.42-1.07 (m, 81.53H, CH₂(CH₂)₈CH₂). (See Table 1; FIGS. 31, 41, 57)

### Example 29

### Rheological Measurements.

The viscosity of the resin formulations was measured at 50-90 wt. % polymer in ethyl acetate (EA) using a Discovery HR-3 (TA instrument, DE, USA). The premixed resin was placed on parallel plates (25 mm diameter) using a 1 mm gap and data were collected via a frequency sweep ranging from 0.1 rad s⁻¹ to 500 rad s⁻¹ at 10% strain while maintaining the temperature at 25° C. and the intercept of the regression curve were chosen as a representative viscosity of the resin formulations. The results are shown in FIG. 59.

### Example 30

### CLIP 3D Printing of Resins.

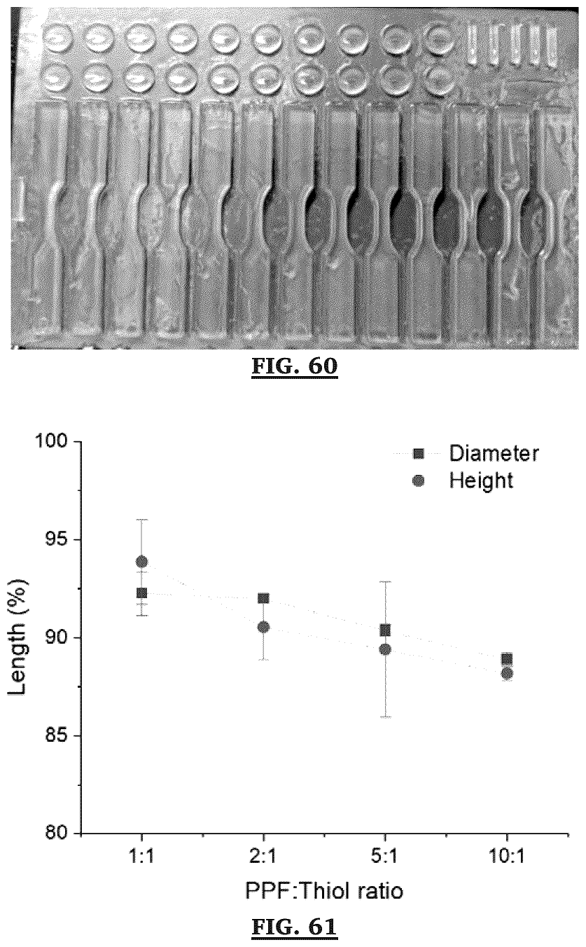

The specimens for tensile testing were fabricated using a Carbon (Redwood, CA) M2 printer (λ=385 nm). The 3D printing resins were prepared according to the predetermined ratio of polymer, ethyl acetate (EA), and trimethylolpropane tris (3-mercaptopropionate) with 0.6 wt. % of phenyl bis(2,4,6-trimethylbenzoyl)phosphine oxide (BAPO) and 0.4 wt. % of oxybenzone (OB). The STL files were obtained from open-source on the internee. For tensile measurements, ASTM D638 Type V tensile bars were printed. (See, FIG. 60) For the swelling test and degradation test, solid discs of 10 mm in diameter and 2 mm in height were printed. (See, FIG. 60) Printed products were washed sequentially with EA and isopropyl alcohol (IPA), submerged in deionized water, and then post-cured in B9 Model Cure UV oven (B9Creations, 70 W, 55 Hz, λ=390-420 nm) for 5 minutes. Post-cured products were dried under vacuum at 40° C. for 2 days for further study. (See, FIGS. 60, 61)

### Example 31

### Mechanical Properties Test.

Uniaxial tensile tests arid cyclic tests were conducted using an Instron 5800 Series Universal Testing System (Instron, Norwood, MA). The force was measured with a 100 N load cell at room temperature. 5 mm min^{31 1} and 10 mm min⁻¹ crosshead speeds were used for tensile test and cyclic test, respectively. The elastic modulus was determined from the slope of the initial linear region. The results are shown in Table 2. See also, FIGS. 62, 63A-D, 64A-D, 65, 66A-C, 67A-B, and 68A-D. The values reported were obtained from the average of three independent measurements.

### Example 32

### Swelling Measurements.

The swelling ratio and sol fraction of 3D-printed specimens was measured using a modified method from the previously reported. (See, Shin, Y. J.; Becker, M. L., Alternating ring-opening copolymerization of epoxides with saturated and unsaturated cyclic anhydrides: reduced viscosity poly(propyiene fumarate) oligomers for use in cDLP 3D printing. Polym Chem-UK 2020, 11 (19), 3313-3321, the disclosure of which is incorporated herein by reference in its entirety). The tensile bars were placed into the 20 mL scintillation vial and immersed in 10 mL of EA. After 24 hours, the samples were weighed (Wₛ) after wiping off the solution on the surface. The mass of dried sample (W_{d}) was measured after 72 hours of drying under a vacuum. The swelling ratio was calculated by the formula:

$$Swelling ratio = \frac{{W}_{s} - {W}_{d}}{{W}_{s}}$$

The results are shown in FIGS. 69A-B.

### Example 33

### Accelerated Degradation Test.

Accelerated degradation experiment was performed for 3D printed solid discs (D=10 mm, H=2 mm) in 0.25N KOH aqueous solution at 37° C. Discs were submerged in 10 mL of solution in scintillated vials and the weight of the discs was measured at 1, 2, 4, 7, 11, 14, and 24 d. The KOH solution was replaced every day for the first 7 days and every 2 days after that. Before weight measurement, the discs were washed with 20 mL deionized water for 3 times and dried under vacuum for 2 days. The results are shown in FIG. 70).

in light of the foregoing, it should be appreciated that the present invention significantly advances the art by providing a polypropylene fumarate-b-propylene succinate-b-propylene fumarate) block co-polymer that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

1. An ABA triblock co-polymer comprising:
a first and second A polymer block comprising poly(propylene fumarate) and
a B polymer block comprising a copolymer of a cyclic anhydride and propylene oxide,
wherein said first and second A polymer blocks are each bonded covalently to an end of said B polymer block to form an ABA block copolymer.

2. The ABA triblock co-polymer of claim 1 wherein said cyclic anhydride is selected from the group consisting of succinic anhydride, glutaric anhydride, (pentandioic anhydride), adipic anhydride, pimelic anhydride, citraconic anhydride, itaconic anhydride, methyl itaconic anhydride, phenyl itaconic anhydride, phthalic anhydride, cyclohexane anhydride, cyclopropane anhydtide, cyclopentane anhydride, cyclohexane anhydride, diglycolic anhydride, and combinations thereof.

3. The ABA triblock co-polymer of claim 1 wherein said B polymer block comprises poly(propylene succinate)

4. The ABA triblock co-polymer of claim 1, wherein the B polymer block further comprises the residue of an initiator having at least two reactive hydroxyl, thiol or carboxylic acid groups.

5. The ABA triblock co-polymer of claim 1, having the formula: 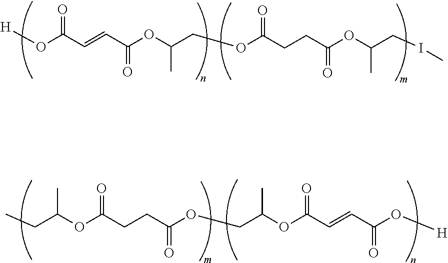
where each n is an integer from about 1 to about 20, each m is an integer from about 2 to about 70, and I is the residue of an initiator having at least two reactive hydroxyl, thiol or carboxylic acid groups.

6. The ABA triblock co-polymer of claim 4 wherein said initiator is selected from the group consisting of fumaric acid (FmA), 1,4-cyclohexanedicarboxylic acid (CHDA), cyclohexane dimethanol (CHDM), benzene dimethanol (BDM), cis-butane-2-diol (cBD), Butyn-2-diol (BYD), 1,4-butanediol, 1,5-pentanediol, 1,6-hexanediol (MO), 1,8-octanediol, 1,10-decanediol (DD), 1,12-dodecandiol, or combinations thereof.

7. The ABA triblock co-polymer of claim 1 wherein the ratio of the degree of polymerization of said first A polymer block to said B polymer block to said second A polymer block is from 1:100:1 to 1:2:1.

8. The ABA triblock co-polymer of claim 1 wherein the ratio of the degree of polymerization of said first A polymer block to said B polymer block to said second A polymer block is 1:5:1.

9. The ABA triblock co-polymer of having from about 5 to about 50 mol % fumarate units.

10. A method for making an ABA triblock copolymer comprising:
a. reacting a cyclic anhydride, a first quantity of propylene oxide, an initiator having at least two reactive hydroxyl, thiol or carboxylic acid groups, and a catalyst to form a B block polymer having a first and second end;
b. reacting said B block polymer with maleic anhydride, a second quantity of propylene oxide, and a catalyst to form a first poly(propylene maleate) polymer block covalently bonded to said first end of said B block polymer and a second poly(propylene maleate) polymer block covalently bonded to said second end of said B block polymer to form an ABA triblock copolymer having two polypropylene maleate) A blocks; and
c. isomerizing said ABA triblock copolymer having two polypropylene maleate) A blocks to form an ABA triblock copolymer having two crosslinkable poly(propylene fumarate) A blocks.

11. The method of claim 10 wherein said cyclic anhydride is selected from the group consisting of succinic anhydride, glutaric anhydride (pentandioic anhydride), adipic anhydride, pimelic anhydride, citraconic anhydride, itaconic anhydride, methyl itaconic anhydride, phenyl itaconic anhydride, phthalic anhydride, cyclohexane anhydride, cyclopropane anhydride, cyclopentane anhydride, cyclohexane anhydride, diglycolic anhydride, and combinations thereof.

12. The method of claim 10 wherein said cyclic anhydride is succinic anhydride.

13. A method for making an ABA triblock copolymer comprising:
a. reacting succinic anhydride, a first quantity of propylene oxide, an initiator having at least two reactive hydroxyl, thiol or carboxylic acid groups and a catalyst to form a poly(propylene succinate) polymer block having a first and second end;
b. reacting said poly(propylene succinate) polymer block with maleic anhydride, a second quantity of propylene oxide, and a catalyst to form a first poly(propylene maleate) polymer block covalently bonded to said first end of said poly(propylene succinate) polymer block and a second poly(propylene maleate) polymer block covalently bonded to said second end of said poly(propylene succinate) polymer block to form a poly(propylene maleate-b-propylene succinate-b-propylene maleate) ABA triblock copolymer; and
c. isomerizing said poly(propylene maleate-b-propylene succinate-b-propylene maleate) ABA block copolymer to form a poly(propylene fumarate-b-propylene succinate-b-propylene fumarate) ABA triblock copolymer.

14. The method of claim 13 wherein the mole ratio of maleic anhydride to succinic anhydride is from about 0.025 to about 15.

15. The method of claim 13 wherein said poly(propylene maleate-b-propylene succinate-b-propylene maleate) ABA block copolymer has the formula: 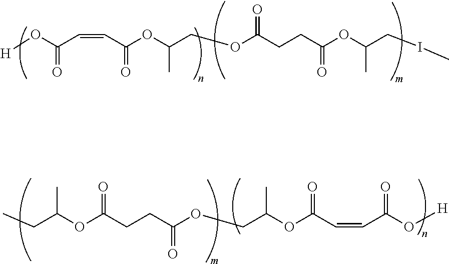
where each n is an integer from about 1 to about 20, each m is an integer from about 2 to about 70, and I is the residue of an initiator having at least two reactive hydroxyl, thiol or carboxylic acid groups.

16. The method of claim 13 wherein said poly(propylene fumarate-b-propylene succinate-b-propylene fumarate) ABA triblock copolymer has the formula: 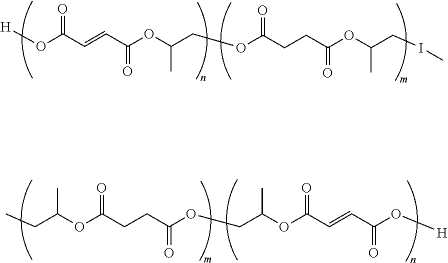
where each n is an integer from about 1 to about 20, each m is an integer from about 2 to about 70, and I is the residue of an initiator having at least two reactive hydroxyl, thiol or carboxylic acid groups.

17. The method of claim 13 wherein said initiator is selected from the group consisting of fumaric acid (FmA), cyclohexane dicarboxylic acid (CHDA), cyclohexane dimethanol (CHDM), benzene dimethanol (BDM), cis-butane-2-diol (cis-BD), butyn-2-diol (2BD), 1,4-butanediol, 1,5-pentanediol, 1,6-hexanediol (HD), 1,8-octanediol, 1,10-decanediol, 1,12-dodecandiol (DD), or combinations thereof.

18. The method of claim 13 wherein said catalyst is Mg(BHT)₂(THF)₂.

19. (canceled)

20. A 3D printable polymer resin comprising:
a poly(propylene fumarate-b-propylene succinate-b-propylene fumarate) ABA triblock copolymer; and
a multi-thiol crosslinker having at least two reactive thiol groups.

21. The 3D printable polymer resin of claim 20 wherein said multi-thiol crosslinker has from 2 to 5 reactive thiol groups.

22. The 3D printable polymer resin of claim 20 further comprising: an organic solvent selected from the group consisting of ethyl acetate, THF, acetone, DMSO, Chloroform, methanol, ethanol, and diethyl fumarate; and a photoinitiator.

23. The 3D printable polymer resin of claim 20 wherein said multi-thiol crosslinker is selected from the group consisting of ethylene glycol bis-mercaptoacetate, 3,6-dioxa-1,8-octanedithiol, pentaerythritol tetrakis(3-mercaptopropinate), trimethylolpropane tris(3-mercaptopropionate), 2,2′-thiodiethanethiol, ethylene glycol dithiol, tetra(ethylene glycol) dithiol, hexa(ethylene glycol) dithiol, poly(ethylene glycol) dithiol, 1,6-hexanedithiol, 1,8-oxtanedithiol, 1,9-nonanedithiol, 1,11-undecanedithol, 1,16-hexandecanedithiol, and combinations thereof.

24. The 3D printable polymer resin of claim 20 wherein the ratio of fumarate groups in said poly(propylene fumarate-b-propylene succinate-b-propylene fumarate) ABA triblock copolymer to reactive thiol groups on said multi-thiol crosslinker is from about 50 to about 0.2.

25. A poly(propylene fumarate-b-propylene succinate-b-propylene fumarate) ABA triblock copolymer prepared using the method of claim 13.

26. A method for making the 3D printable polymer resin of claim 20 comprising:
a. dissolving the ABA triblock co-polymer of claim 1 in a suitable solvent until the resulting solution has a complex viscosity of from about 0.01 to about 10 as measured by solution rheology; and
b. adding a multi-thiol crosslinker having at least two reactive thiol groups.

27. The method for making the 3D printable polymer resin of claim 26 wherein said multi-thiol crosslinker has from two to five reactive thiol groups.

28. A 3D printed polymer structure comprising the 3D printable polymer resin of claim 20.

29. (canceled)

30. (canceled)
